(19) United States
(12) Patent Application Publication
(10) Pub. No.: US 2025/0130707 A1
(43) Pub. Date: Apr. 24, 2025

(54) DEVICES, METHODS, AND GRAPHICAL USER INTERFACES FOR CONTENT APPLICATIONS

(71) Applicant: Apple Inc., Cupertino, CA (US)

(72) Inventors: Matan STAUBER, San Francisco, CA (US); Israel PASTRANA VICENTE, Spring, TX (US); Jonathan R. DASCOLA, San Francisco, CA (US); Stephen O. LEMAY, Palo Alto, CA (US); Ichha ARORA, Rancho Cucamonga, CA (US); Andrew S. KIM, Walnut Creek, CA (US); Gregory T. SCOTT, Soquel, CA (US); Lucio MORENO RUFO, San Jose, CA (US); Fredric R. VINNA, San Francisco, CA (US); Brian K. SHIRAISHI, Belmont, CA (US); So TANAKA, San Pedro, CA (US)

(21) Appl. No.: 19/007,306

(22) Filed: Dec. 31, 2024

Related U.S. Application Data
(63) Continuation of application No. 17/933,020, filed on Sep. 16, 2022.
(60) Provisional application No. 63/261,564, filed on Sep. 23, 2021.

(51) Int. Cl. G06F 3/04847; G06F 3/16; G06T 15/50

(52) U.S. Cl. CPC G06F 3/04847; G06F 3/165; G06T 15/50; G06T 2200/24

(57) ABSTRACT

In some embodiments, an electronic device generates virtual lighting effects while presenting a content item. In some embodiments, an electronic device enhances navigation to a respective playback position of a content item. In some embodiments, an electronic device displays media content in a three-dimensional environment. In some embodiments, an electronic device presents media content in different modes of presentation.

### CROSS-REFERENCE TO RELATED APPLICATIONS

This application is a continuation of U.S. patent application Ser. No. 17/933,020, filed Sep. 16, 2022, and published on Mar. 3, 2023 as U.S. Publication No. 2023-0094522, which claims the benefit of U.S. Provisional Application No. 63/261,564, filed Sep. 23, 2021, the contents of which are incorporated herein by reference in their entireties for all purposes.

### TECHNICAL FIELD

This relates generally to computer systems with a display generation component and one or more input devices that present graphical user interfaces, including but not limited to electronic devices that present graphical user interfaces, via the display generation component, including user interfaces for presenting and browsing content.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects include digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious and error-prone, create a significant cognitive burden on a user, and detract from the experience with the virtual/augmented reality environment. In addition, these methods take longer than necessary, thereby wasting energy. This latter consideration is particularly important in battery-operated devices.

Accordingly, there is a need for computer systems with improved methods and interfaces for providing computer generated experiences to users that make interaction with the computer systems more efficient and intuitive for a user. Such methods and interfaces optionally complement or replace conventional methods for providing computer generated reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems with a display generation component and one or more input devices are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for navigating user interfaces. Such methods and interfaces may complement or replace conventional methods for interacting with a graphical user interface. Such methods and interfaces reduce the number, extent, and/or the nature of the inputs from a user and produce a more efficient human-machine interface.

In some embodiments, an electronic device generates virtual lighting effects while presenting a content item. In some embodiments, an electronic device enhances navigation to a respective playback position of a content item. In some embodiments, an electronic device displays media content in a three-dimensional environment. In some embodiments, an electronic device presents media content in different modes of presentation.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an operating environment of a computer system for providing XR experiences in accordance with some embodiments.

FIG. 2 is a block diagram illustrating a controller of a computer system that is configured to manage and coordinate a XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6A is a flowchart illustrating a glint-assisted gaze tracking pipeline in accordance with some embodiments.

FIG. 6B illustrates an exemplary environment of an electronic device providing a XR experience in accordance with some embodiments.

FIGS. 7A-7E illustrate examples of how an electronic device generates virtual lighting effects while presenting a content item in accordance with some embodiments.

FIGS. 8A-8O is a flowchart illustrating a method of generating virtual lighting effects while presenting a content item in accordance with some embodiments.

FIGS. 9A-9E illustrate exemplary ways of displaying media content in a three-dimensional environment in accordance with some embodiments.

FIGS. 10A-10I is a flowchart illustrating a method of displaying media content in a three-dimensional environment in accordance with some embodiments.

FIGS. 11A-11E illustrate examples of how an electronic device enhances navigation to a respective playback position of a content item in accordance with some embodiments.

FIGS. 12A-12C is a flowchart illustrating a method of enhancing navigation to a respective playback position of a content item in accordance with some embodiments.

FIGS. 13A-13E illustrate exemplary ways of presenting media content in an immersive and non-immersive presentation mode in accordance with some embodiments of the disclosure.

FIGS. 14A-14J is a flowchart illustrating a method of presenting media content in an immersive and non-immersive presentation mode in accordance with some embodiments.

### DESCRIPTION OF EMBODIMENTS

The present disclosure relates to user interfaces for providing a computer generated (CGR) experience to a user, in accordance with some embodiments.

The systems, methods, and GUIs described herein provide improved ways for an electronic device to present content corresponding to physical locations indicated in a navigation user interface element.

In some embodiments, a computer system displays, in a three-dimensional environment, a content application including a content item. In some embodiments, the electronic device applies a virtual lighting effect to the three-dimensional environment while displaying the content application including the content item. In some embodiments, the virtual lighting effect is based on the content item playing via the content application (e.g., including colors included in an image associated with the content item). Presenting the content application user interface with virtual lighting provides an immersive and low-distraction experience for the user while consuming the content item, which additional reduces power usage and improves battery life of the electronic device by enabling the user to use the electronic device more quickly and efficiently.

In some embodiments, a computer system presents, in a three-dimensional environment, media content in different presentation modes, including an expanded presentation mode and a picture-in-picture presentation mode. In some embodiments, the computer system updates a position and/or orientation of the media content in the three-dimensional environment as a user's viewpoint of the three-dimensional environment changes. In some embodiments, whether the computer system updates the position and/or orientation of the media content in the three-dimensional environment is based on the presentation mode associated with the media content when the computer system detected movement of the user's viewpoint in the three-dimensional environment. Changing the pose and/or orientation of the media content as the user's viewpoint of the three-dimensional environment changes provides an efficient way of providing continuous access to media content, regardless of the user's current viewpoint of the three-dimensional environment, which additionally reduces power usage and improves battery life of the electronic device by enabling the user to use the electronic device more quickly and efficiently.

In some embodiments, a computer system enhances navigation to a respective portion of a content item. In some embodiments, while presenting the content item, the electronic device detects that the attention (e.g., gaze) of the user is no longer directed to the content item. In some embodiments, in response to detecting the user's attention directed to the content item after not being directed to the content item, the electronic device presents a selectable option that, when selected, causes the electronic device to navigate to a respective playback position of the content item associated with a playback position of the content item that was playing when the user directed their attention away from the content item. Presenting an option to navigate to the respective playback position of the content item provides an efficient way of navigating the content item, which additionally reduces power usage and improves battery life of the electronic device by enabling the user to use the electronic device more quickly and efficiently and reduces errors in usage which would have to be corrected with further user inputs.

In some embodiments, a computer system presents immersive and non-immersive media content in a three-dimensional environment. In some embodiments, the computer system presents immersive content in an immersive presentation mode and a non-immersive presentation mode. In some embodiments, while the computer system is presenting immersive content in the non-immersive presentation mode, the computer system displays a selectable option that, when selected, causes the computer system to transition presentation of the immersive content from the non-immersive presentation mode to the immersive presentation mode. Providing a selectable option to transition presentation of content from the non-immersive presentation to the immersive presentation mode provides an efficient way of accessing different presentation modes associated with immersive content, which additionally reduces power usage and improves battery life of the electronic device by enabling the user to use the electronic device more quickly and efficiently.

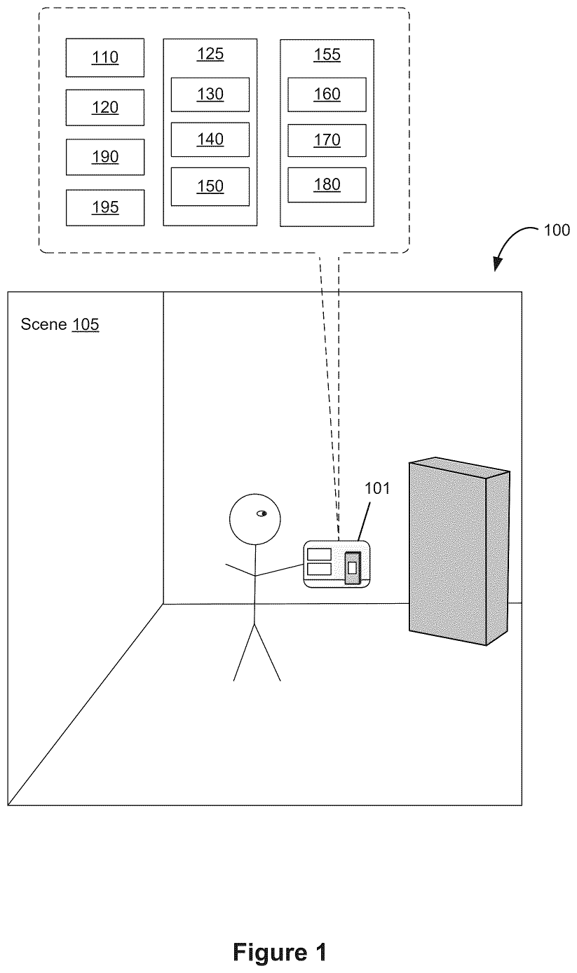

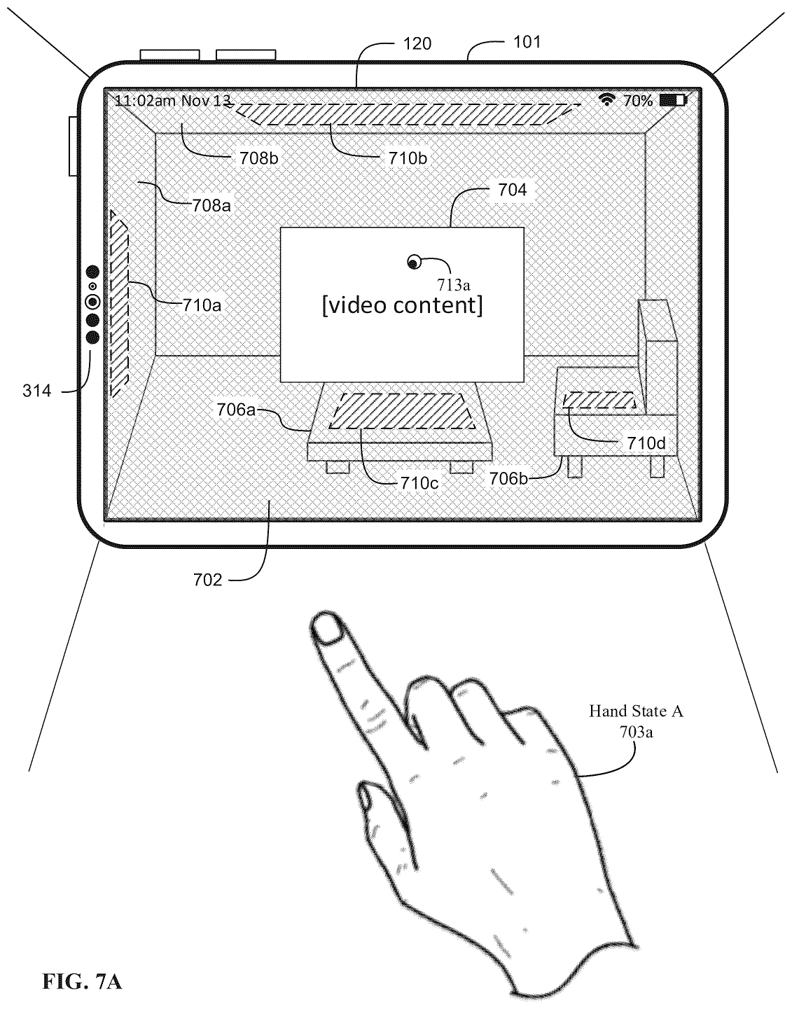

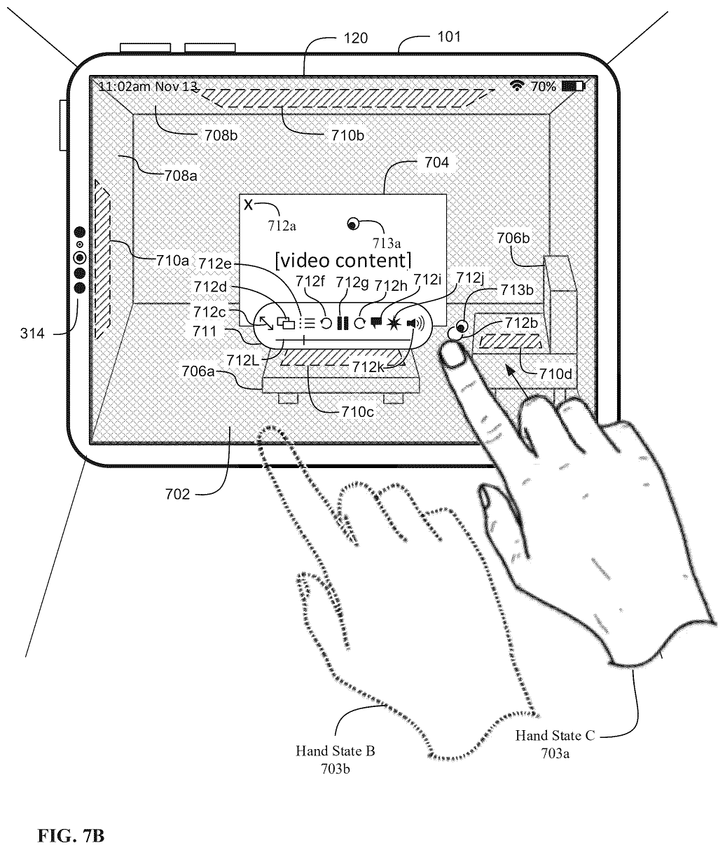

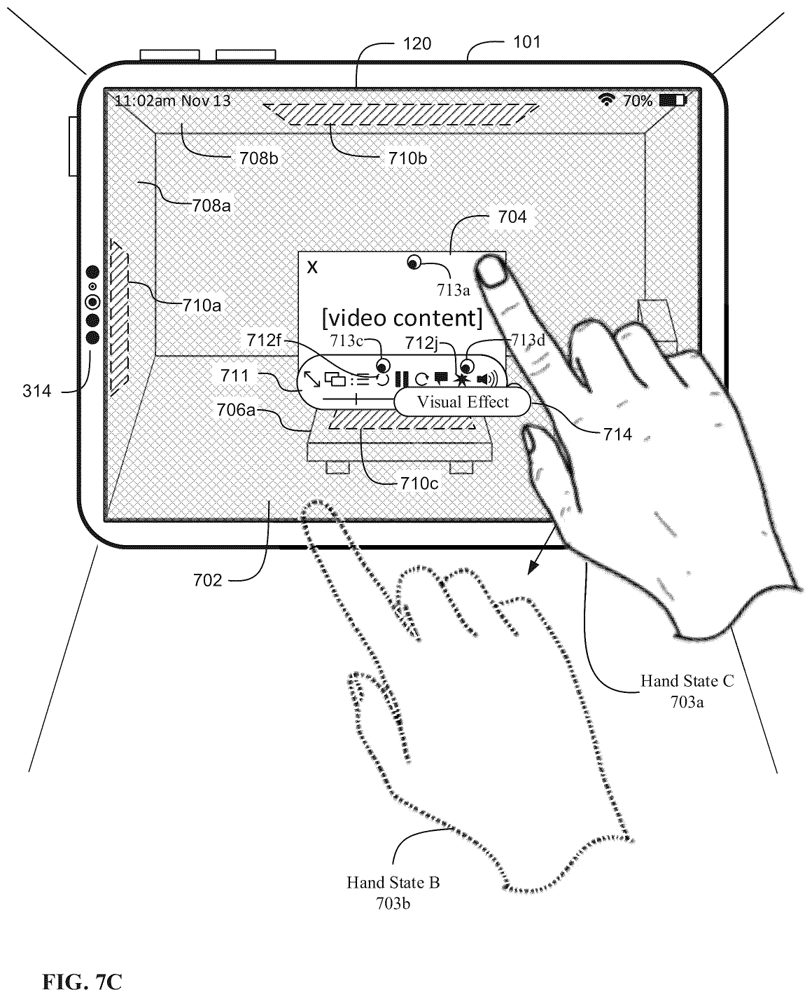

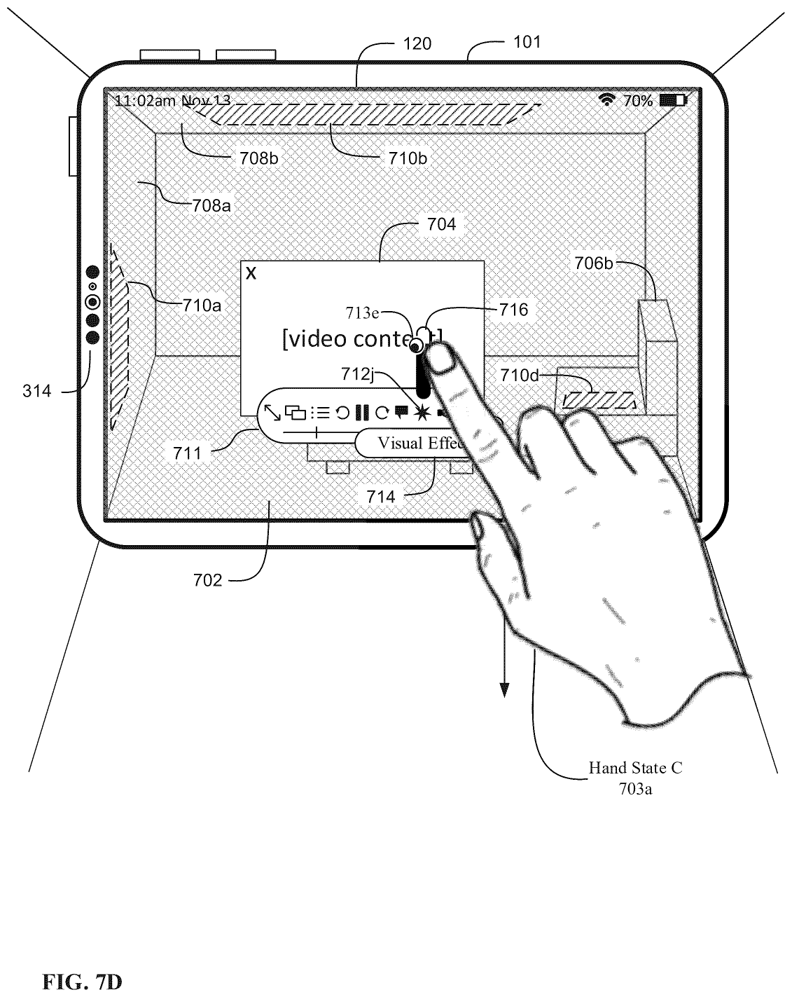

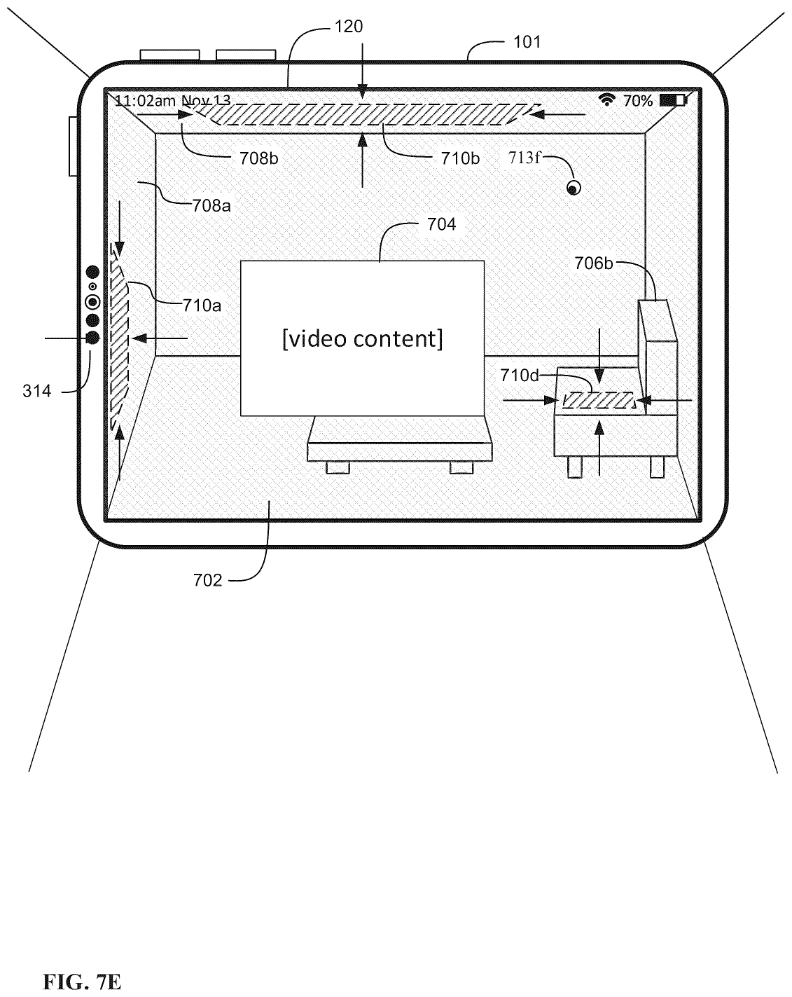

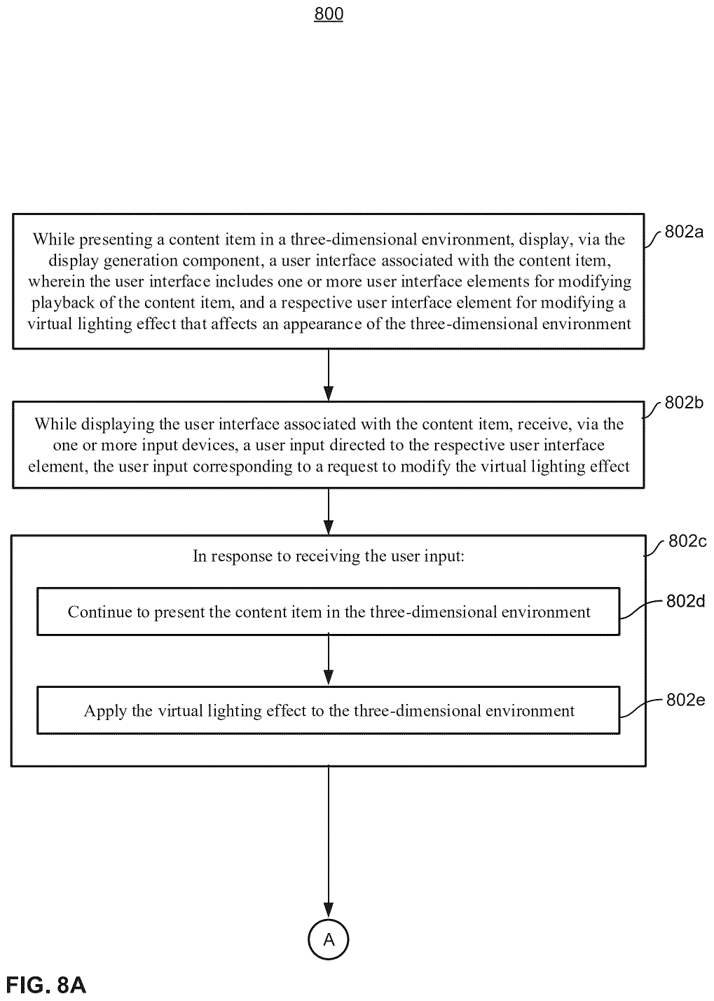

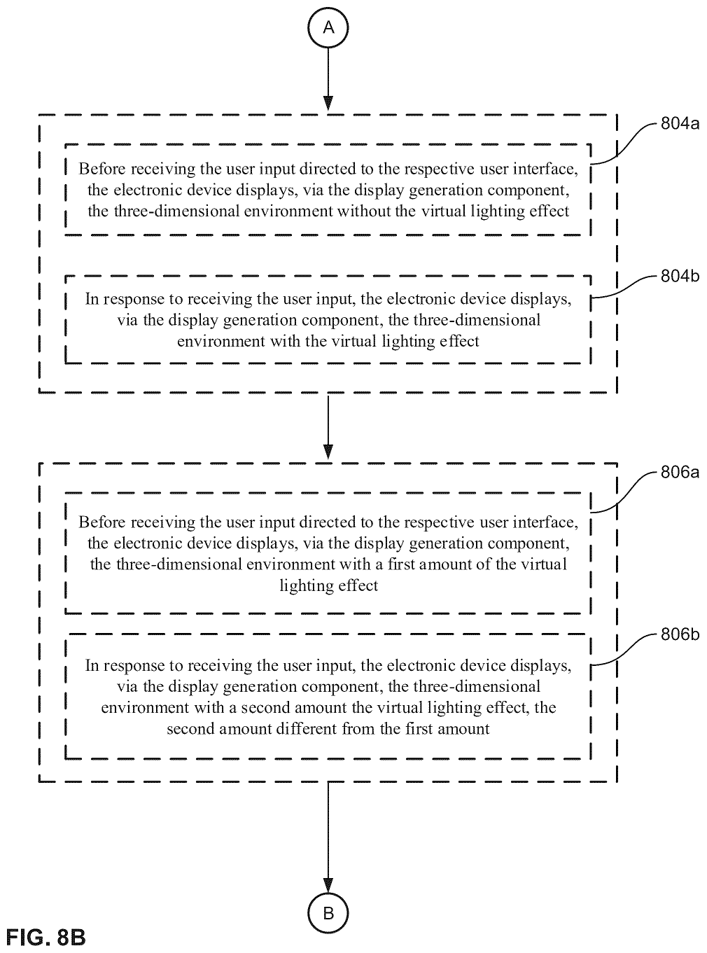

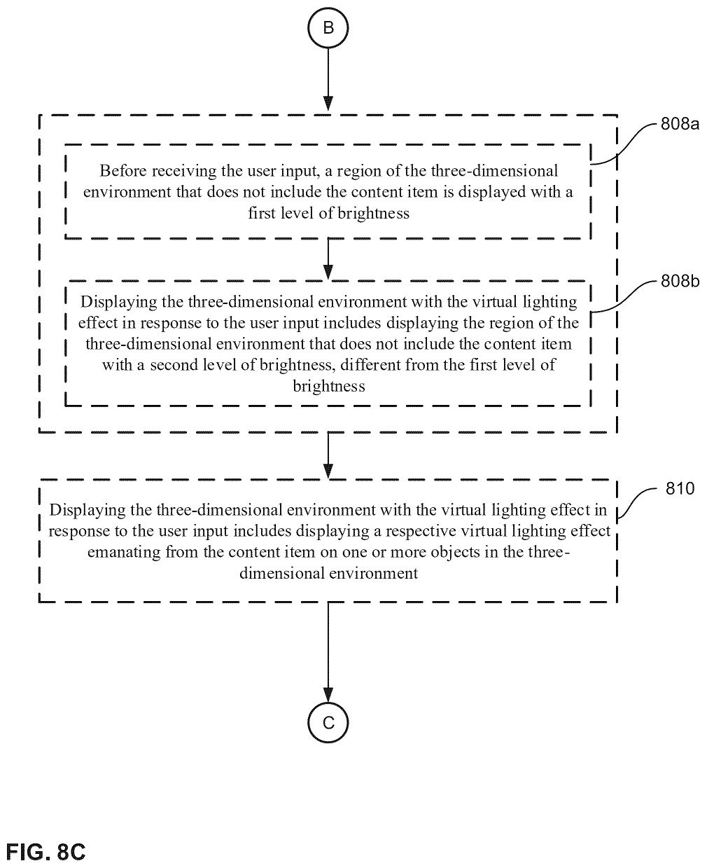

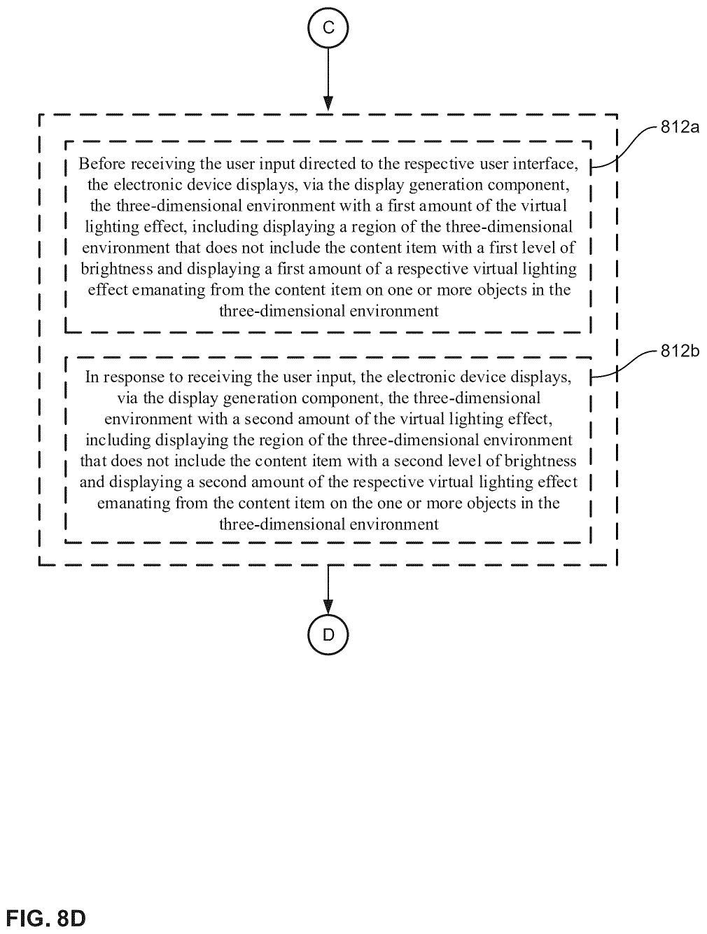

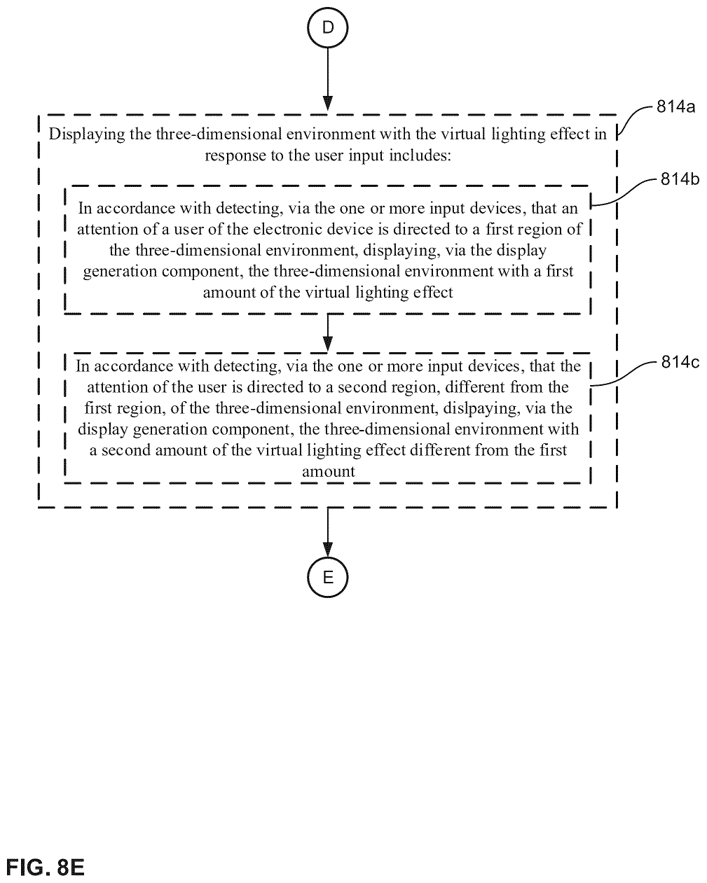

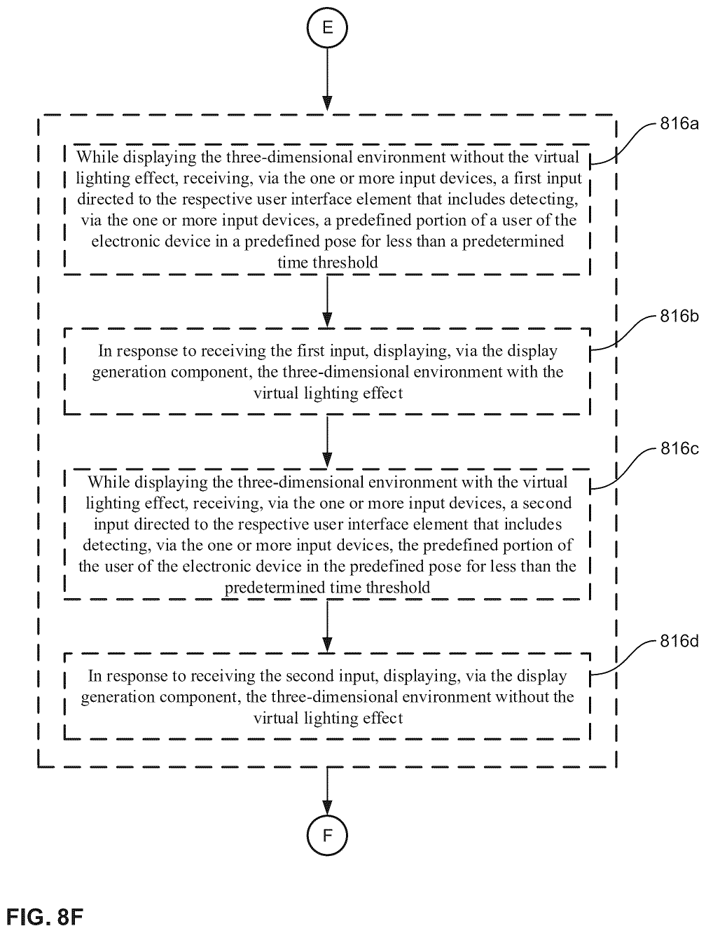

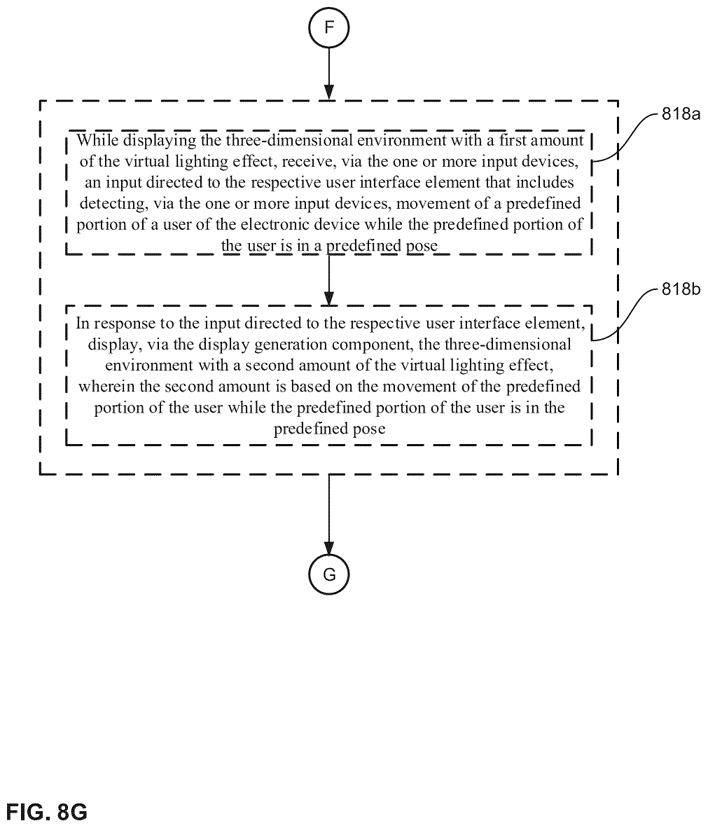

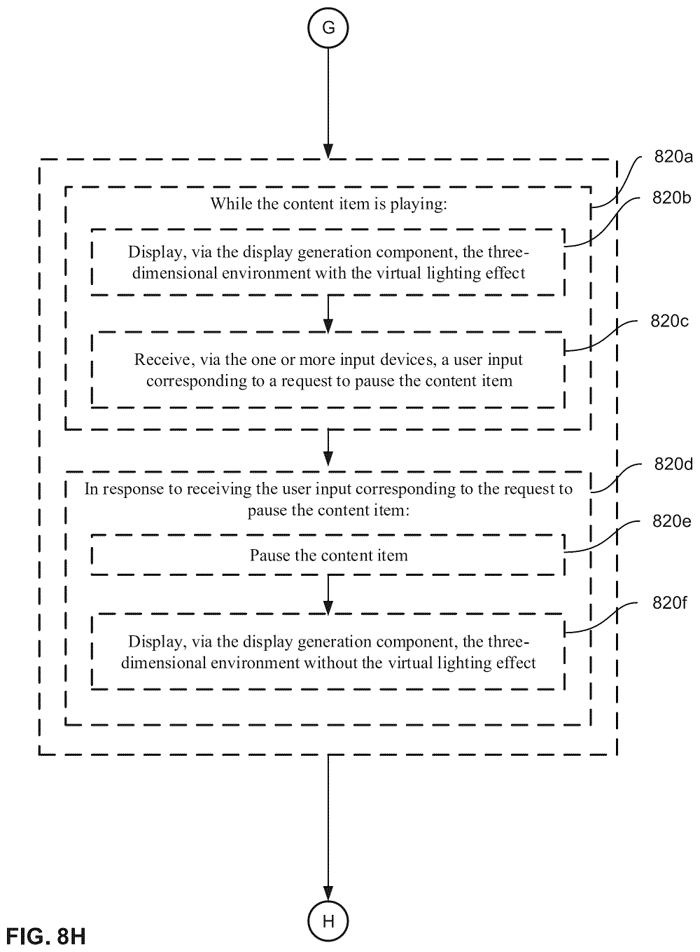

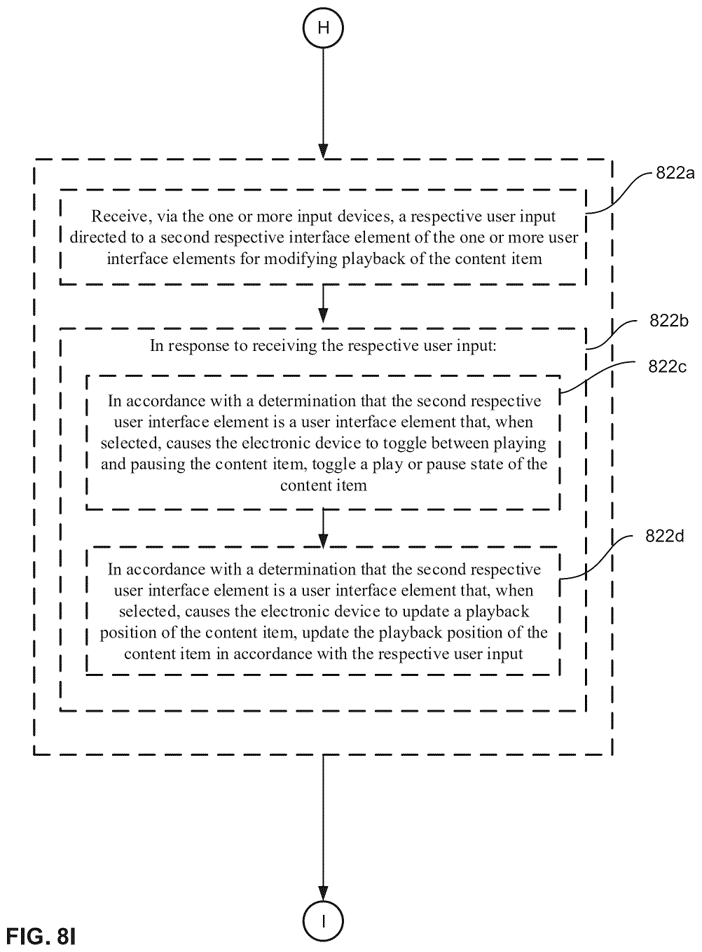

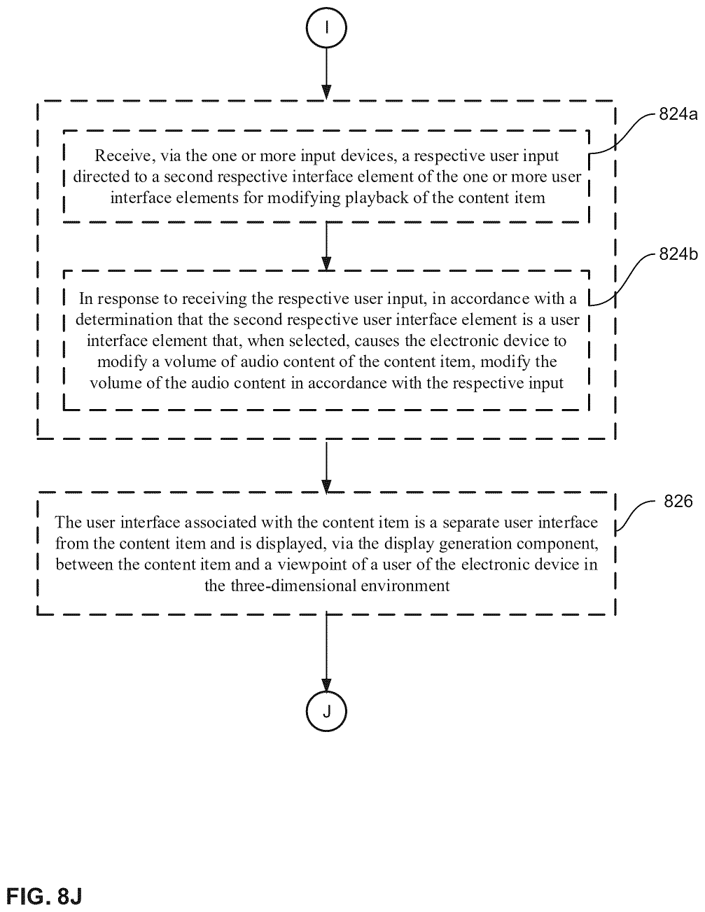

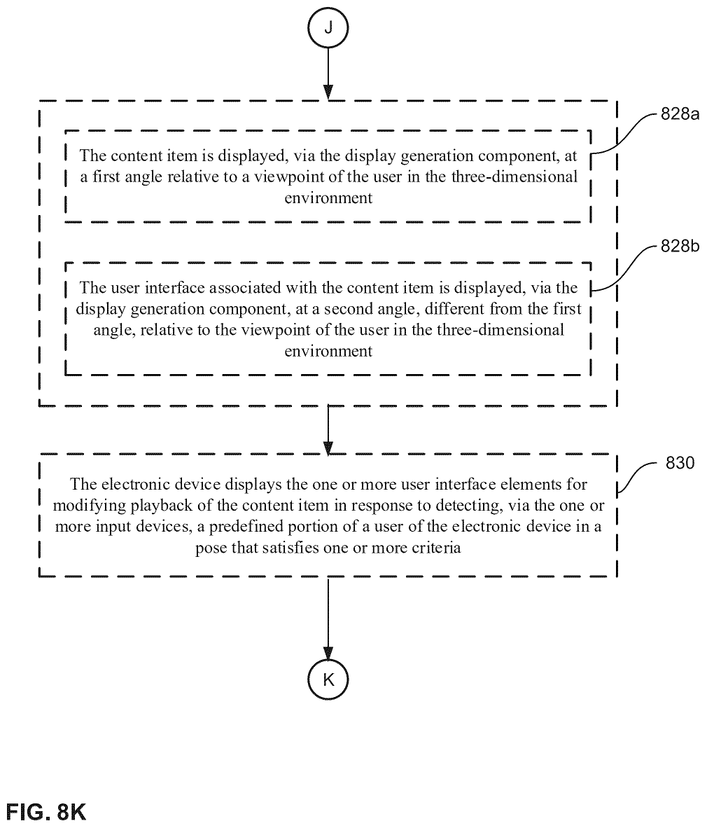

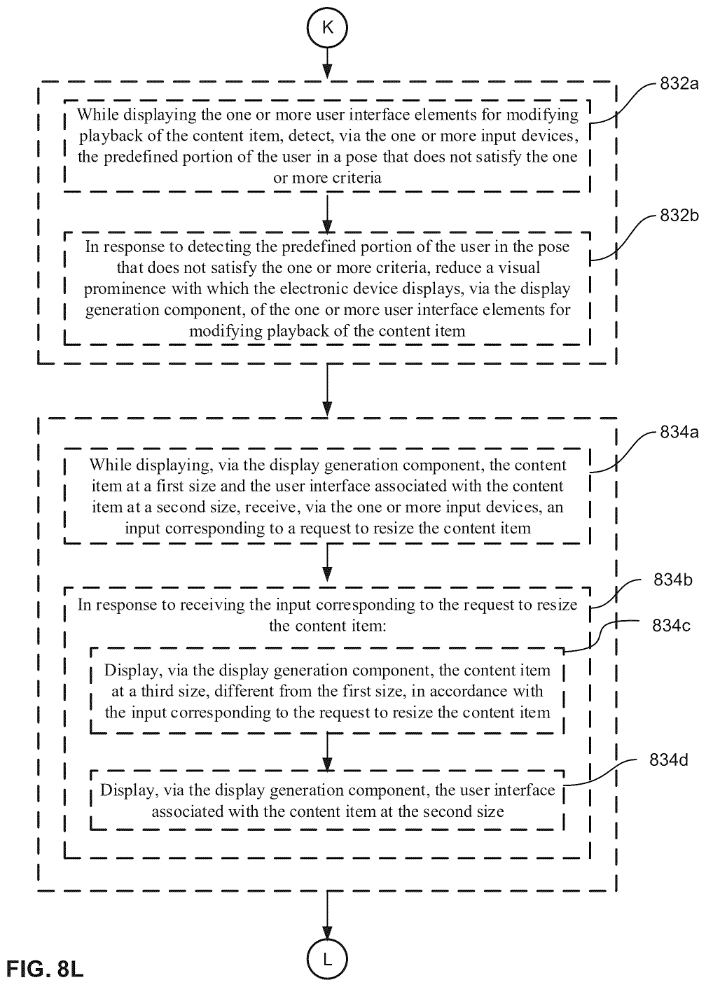

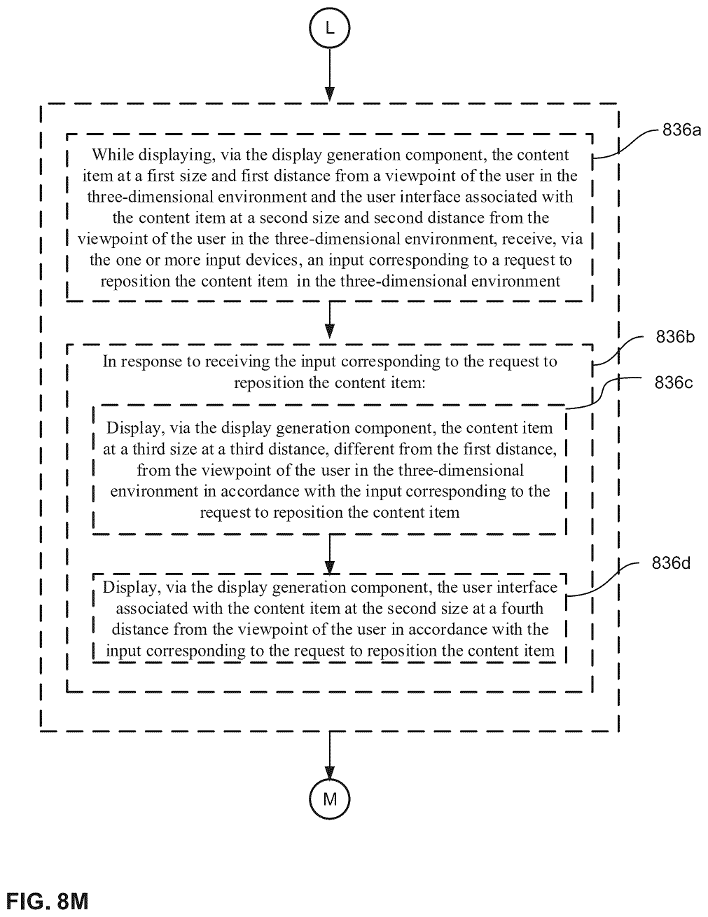

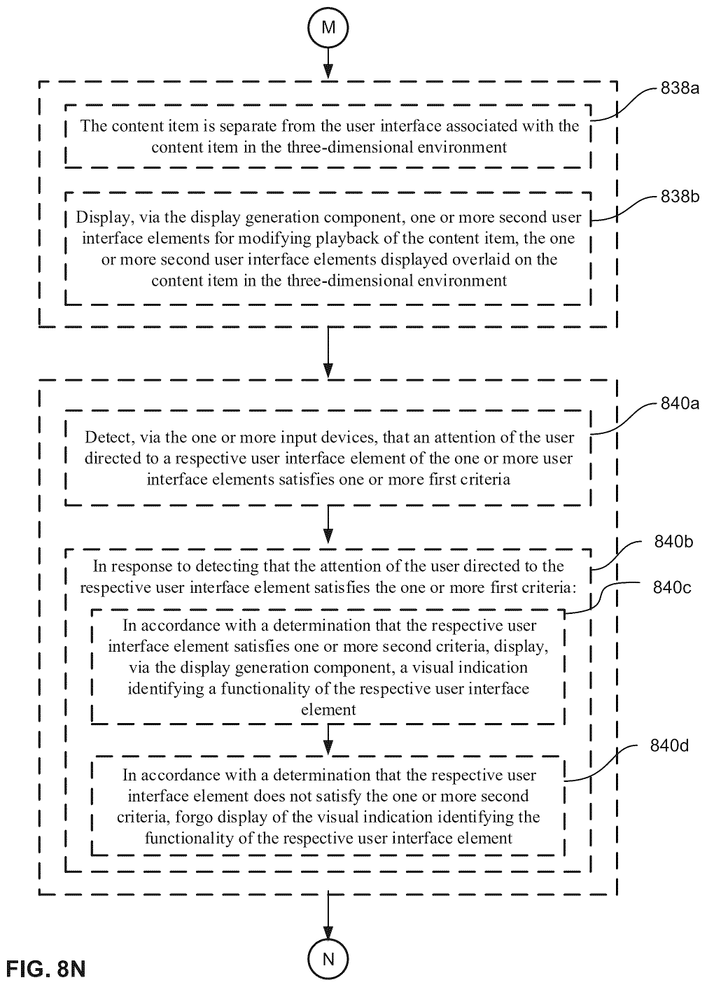

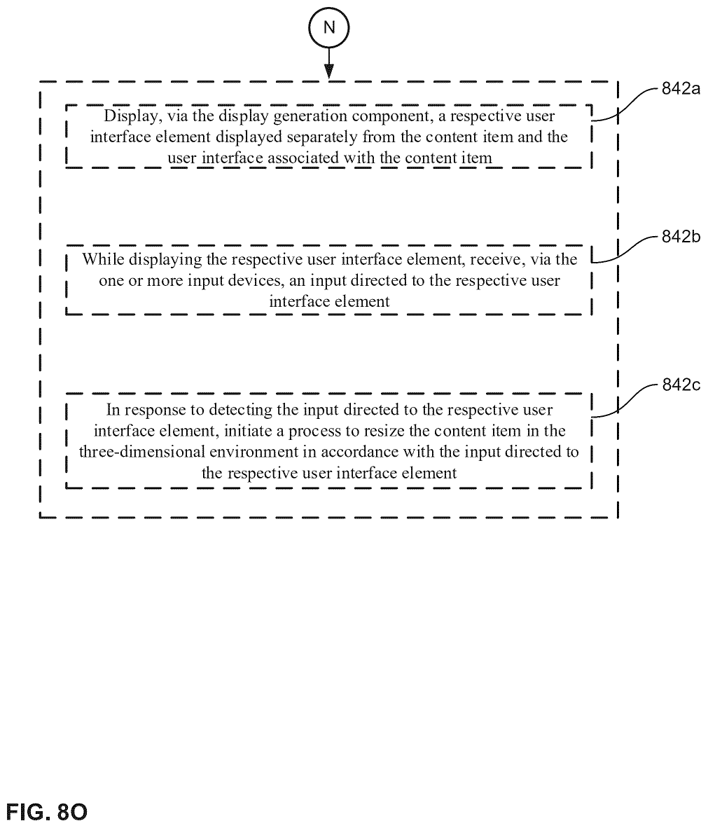

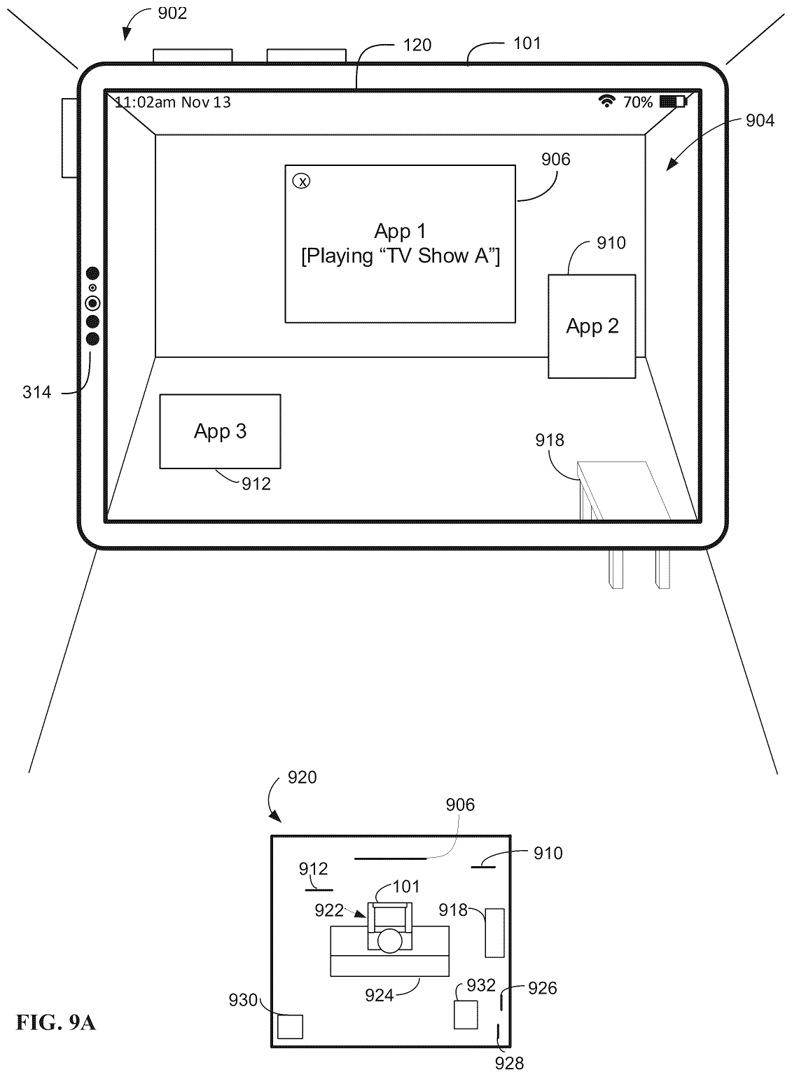

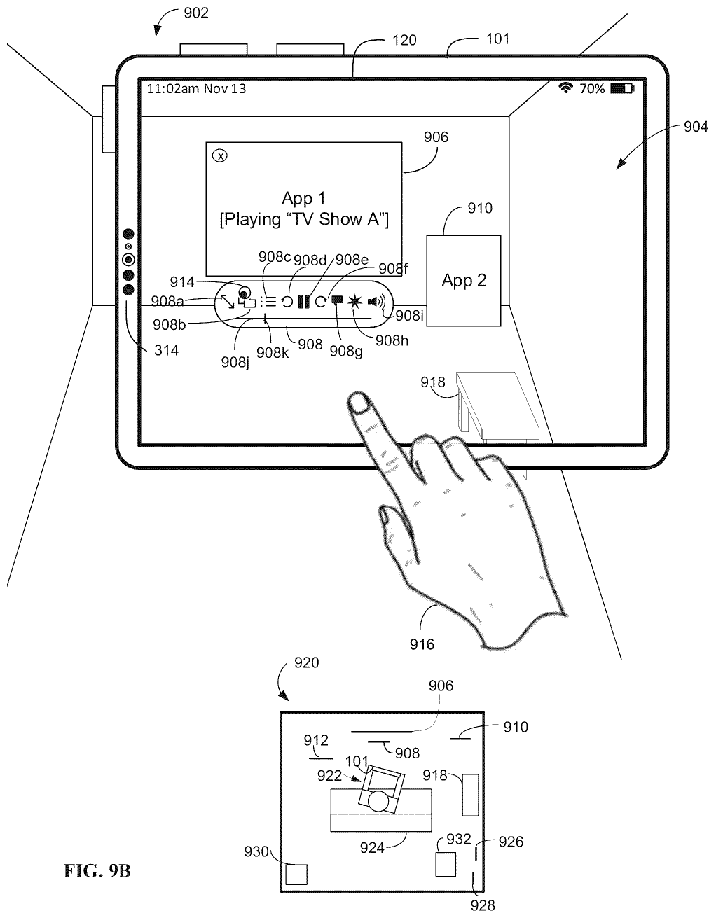

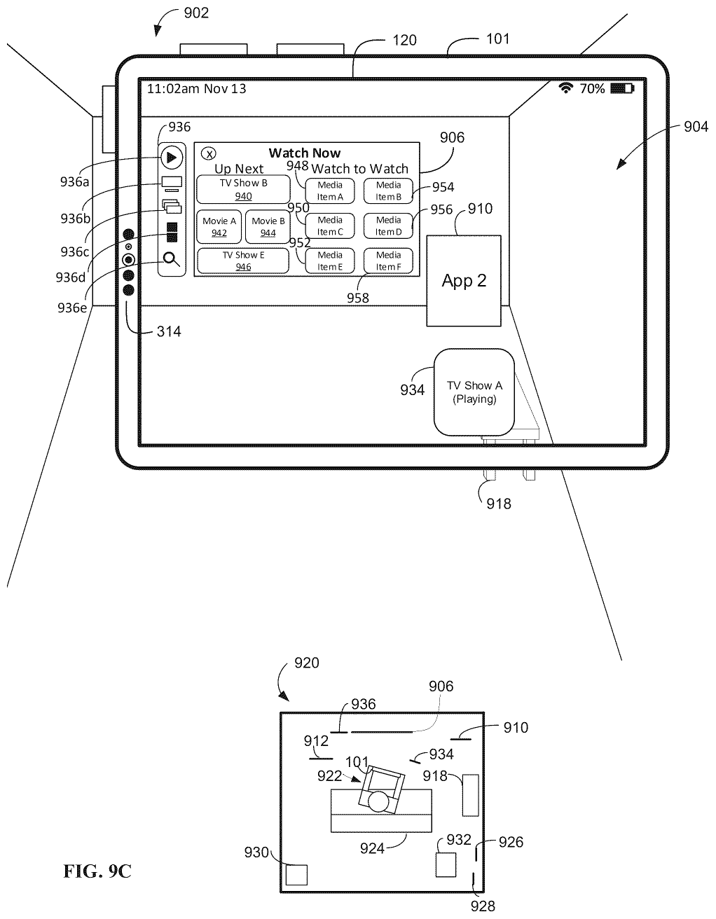

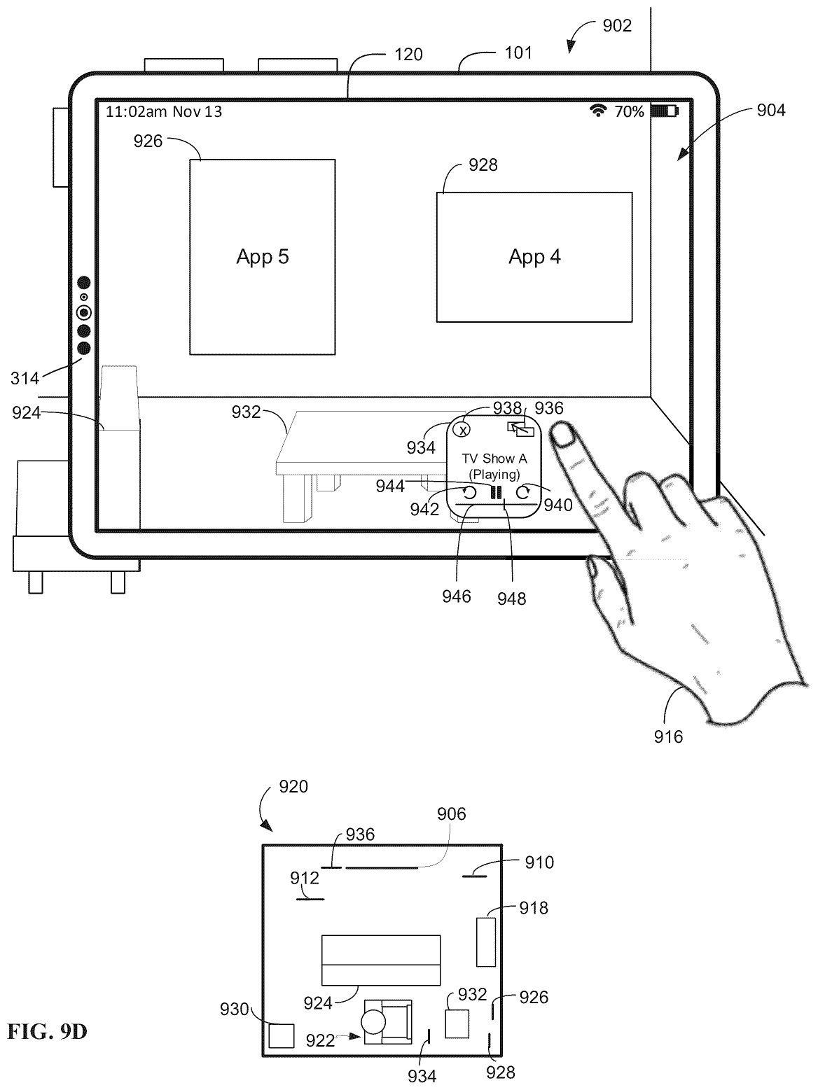

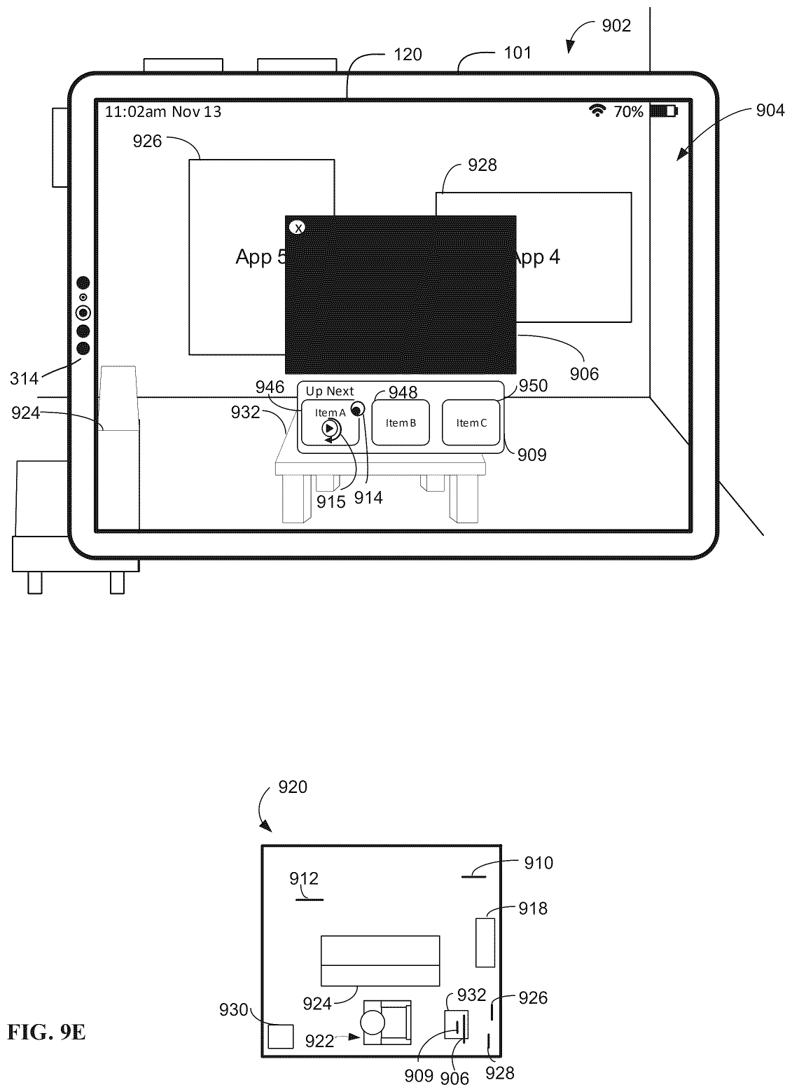

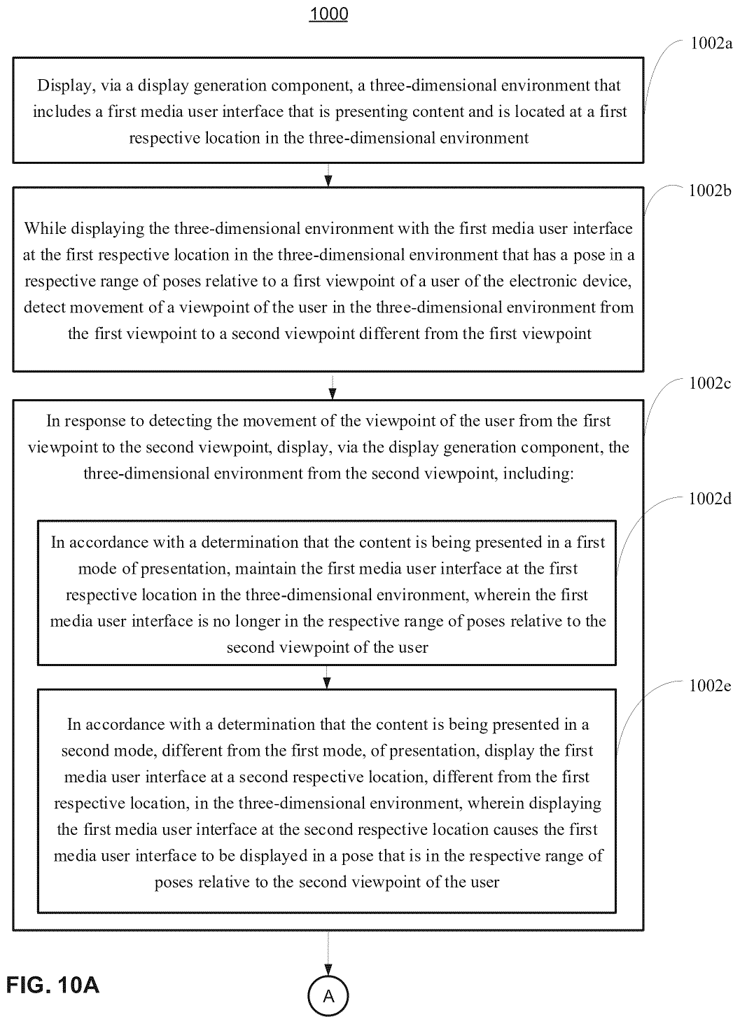

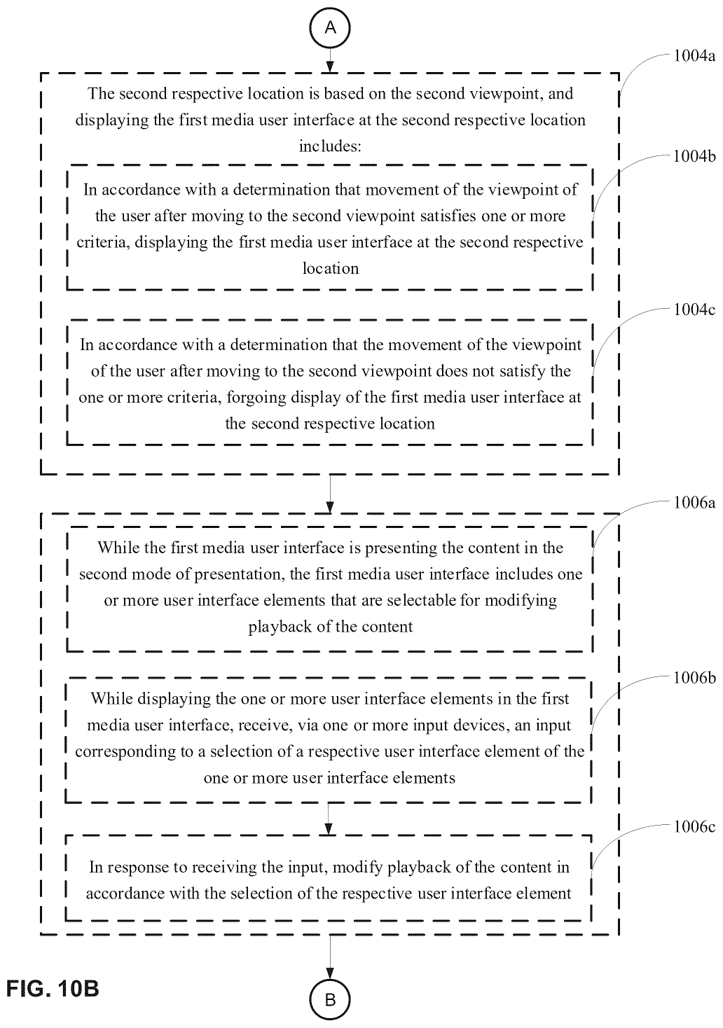

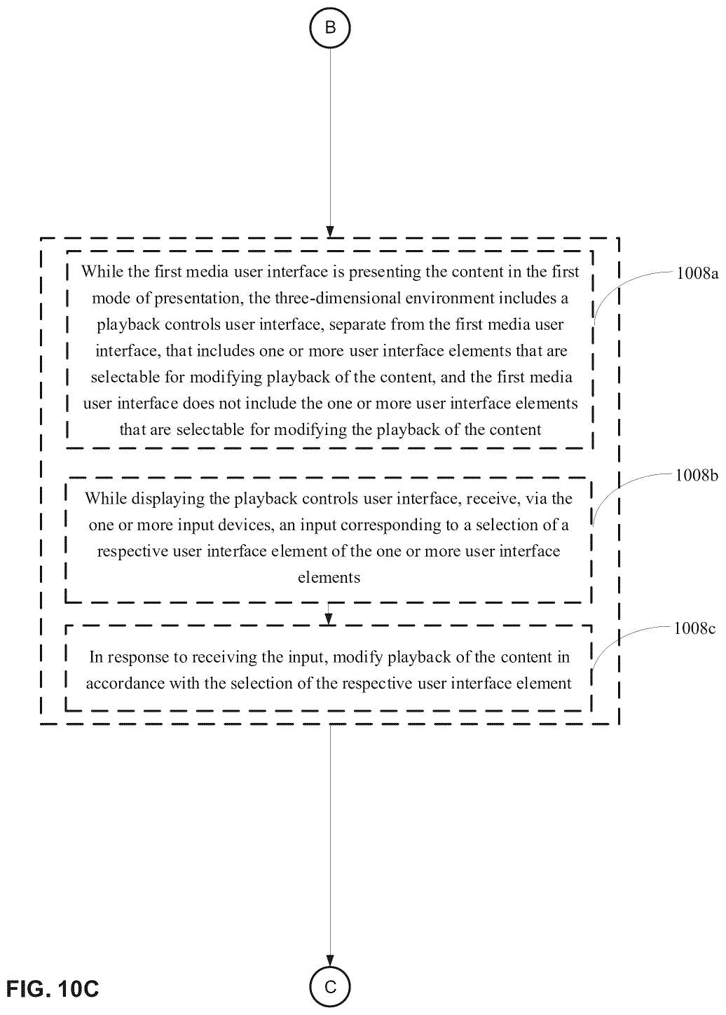

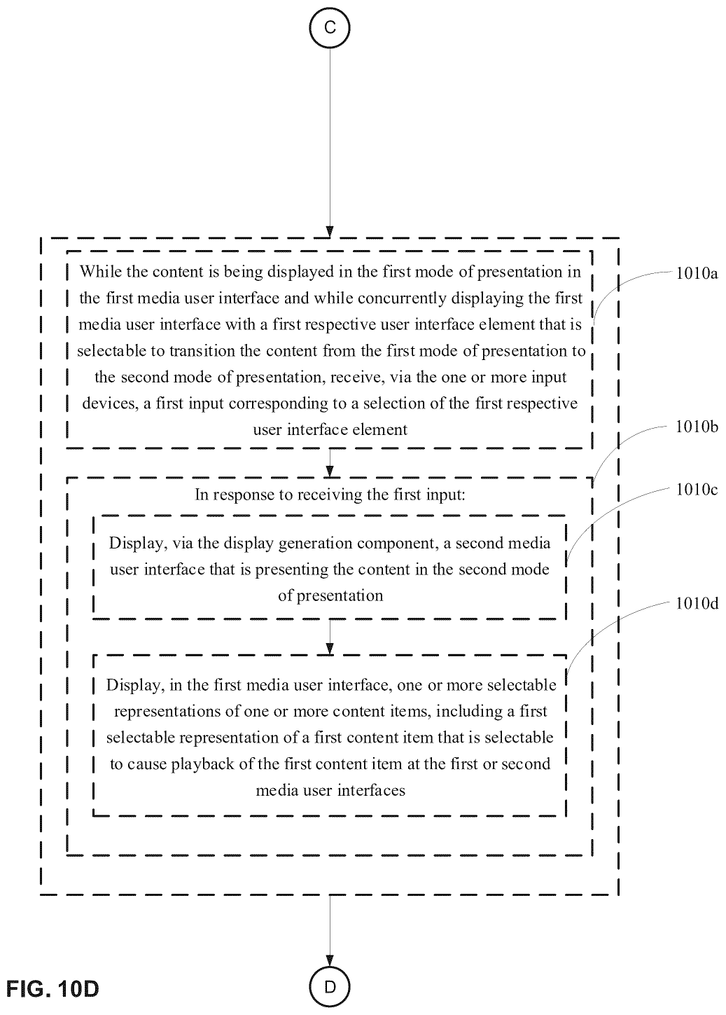

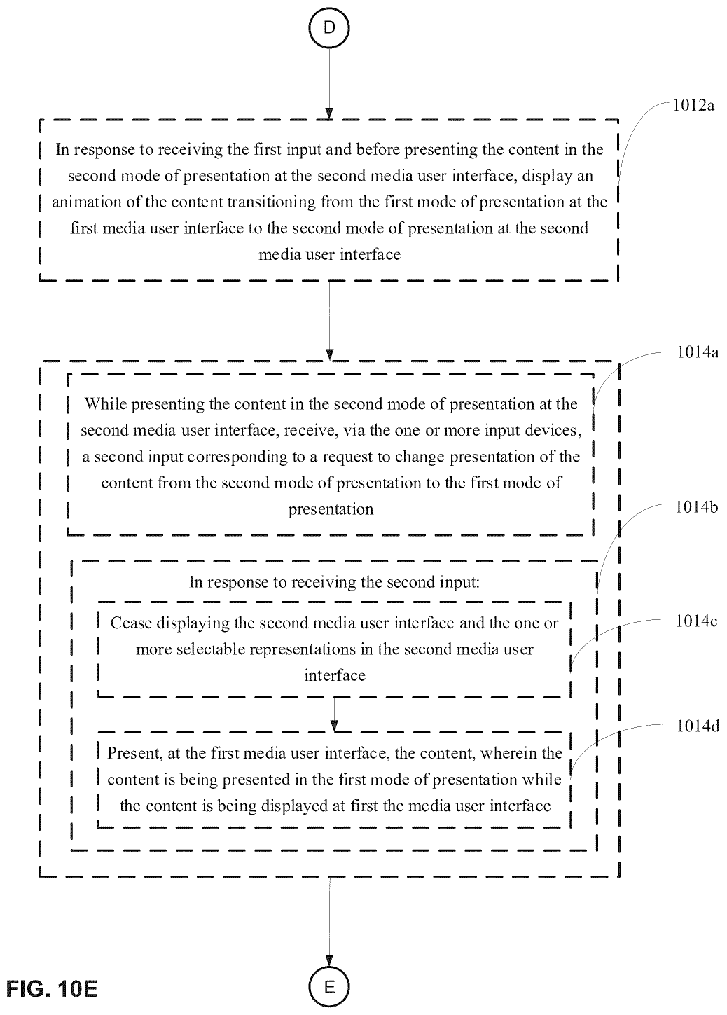

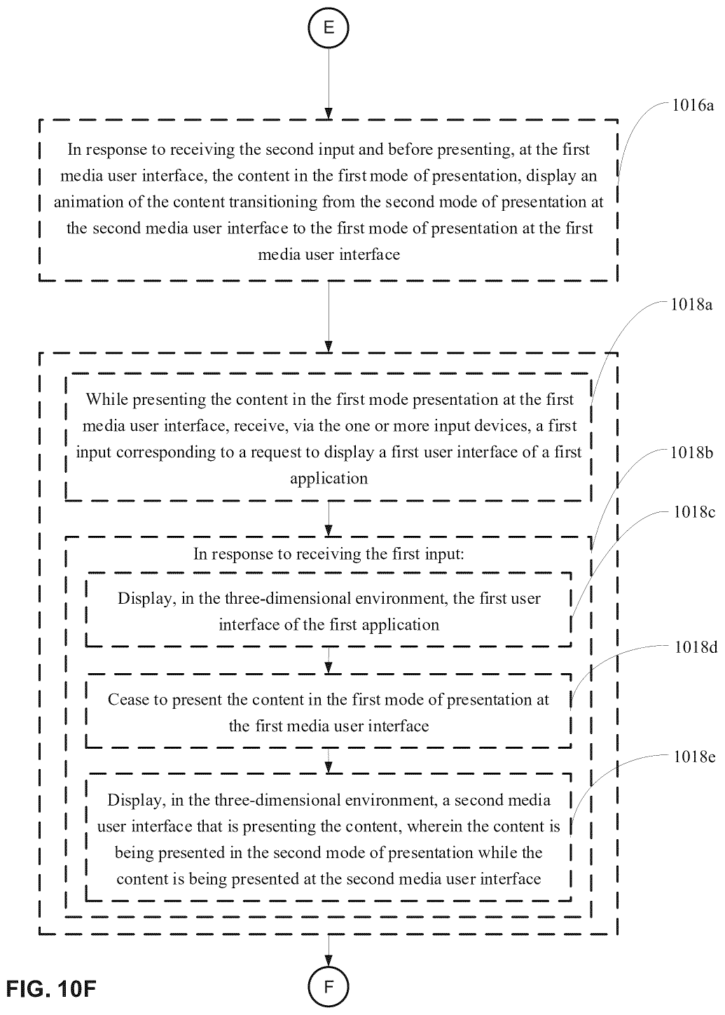

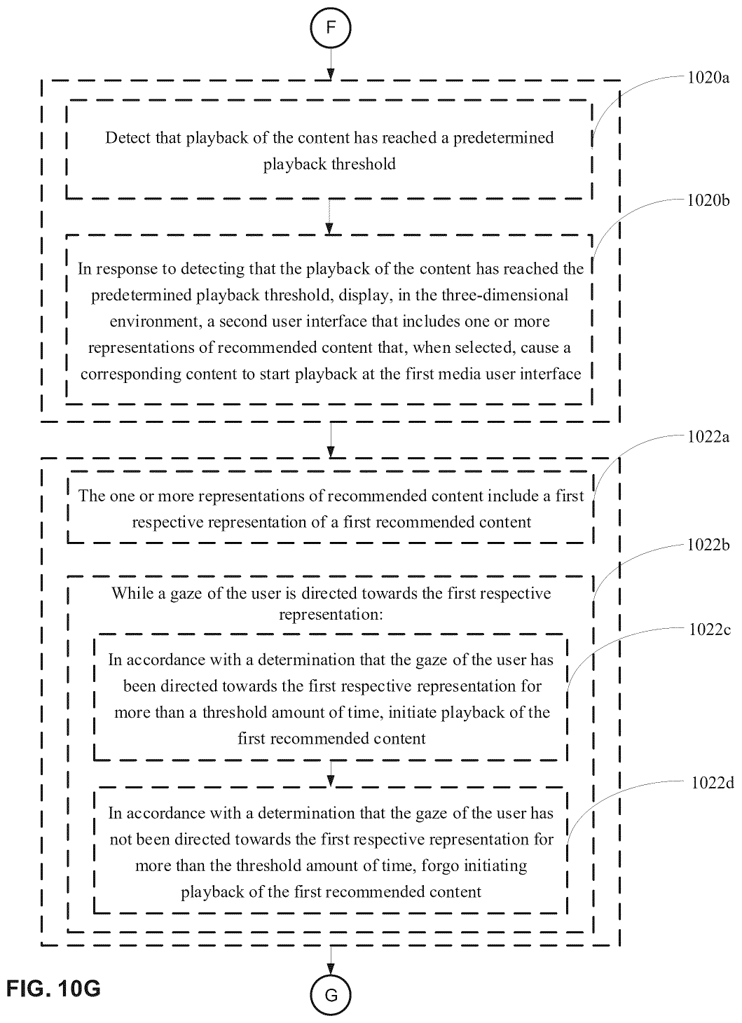

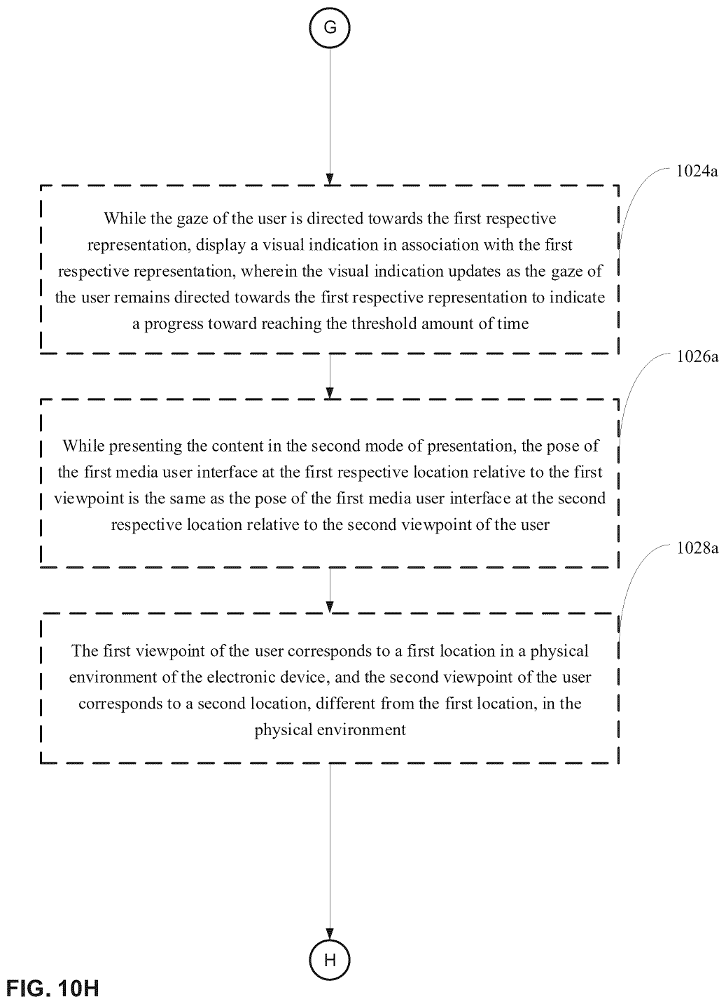

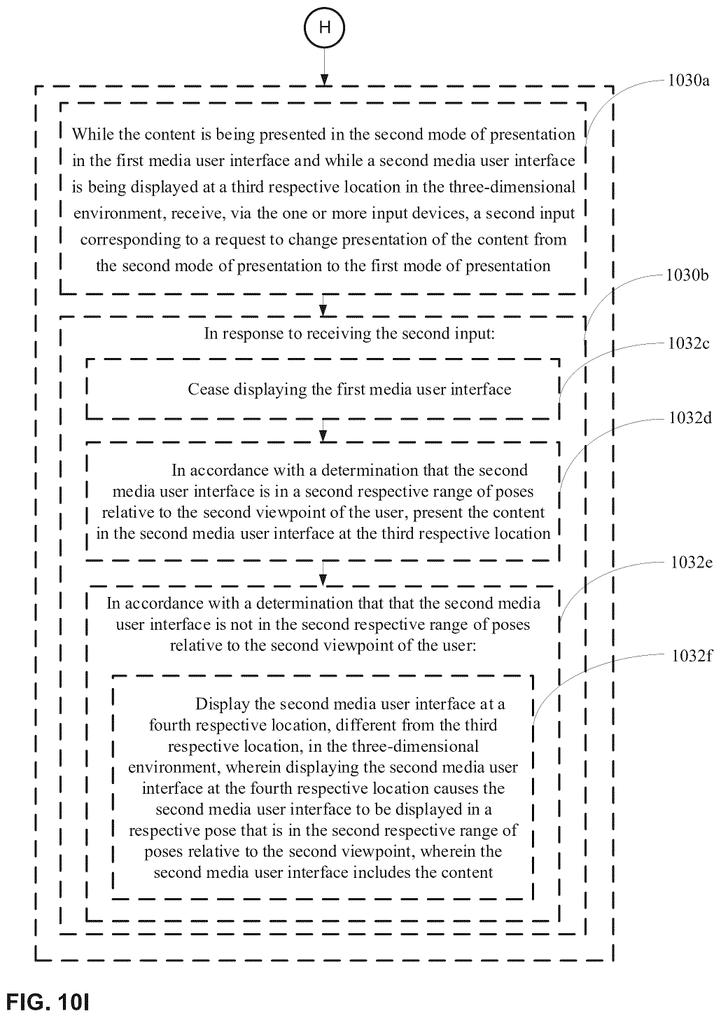

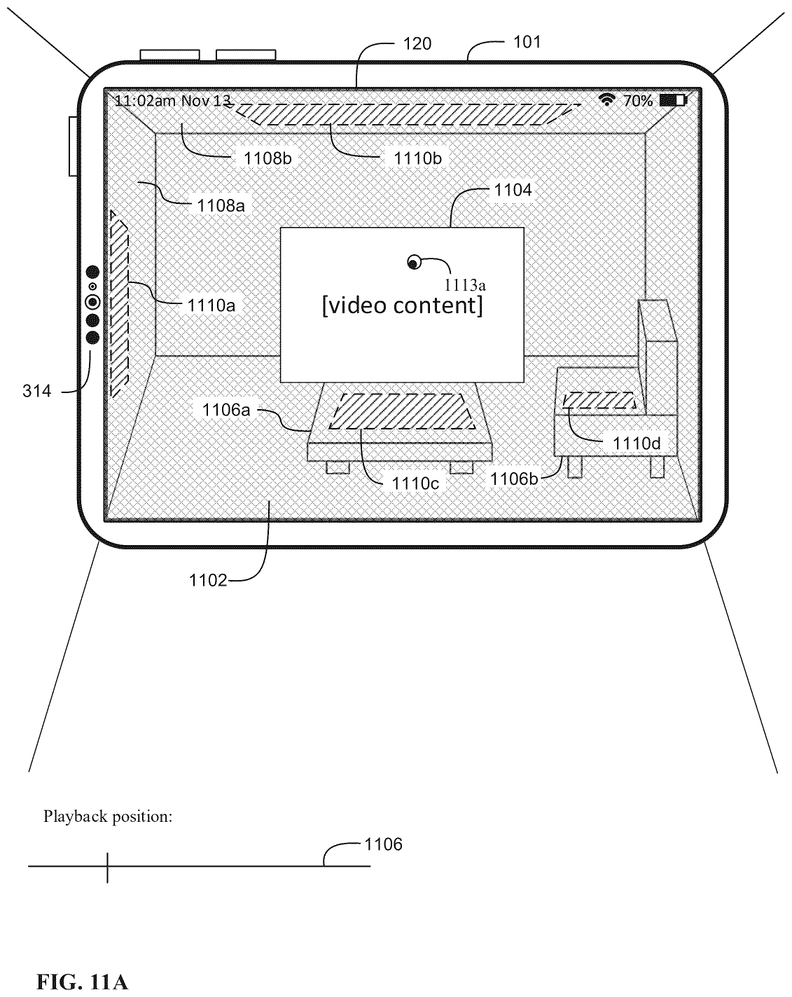

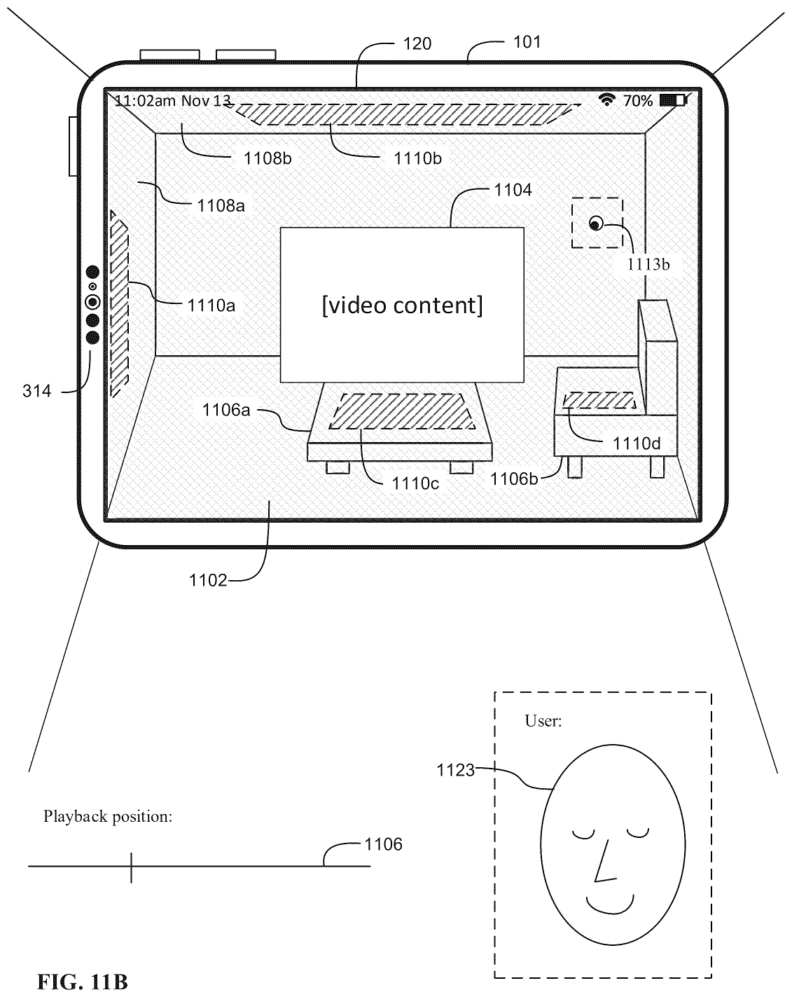

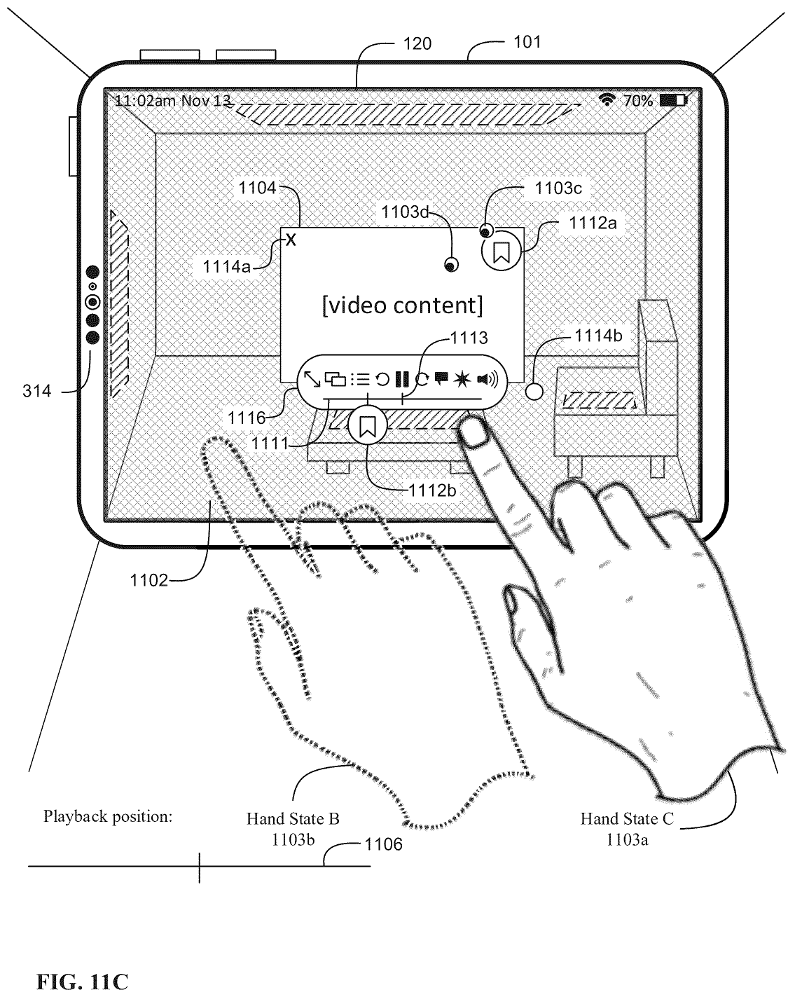

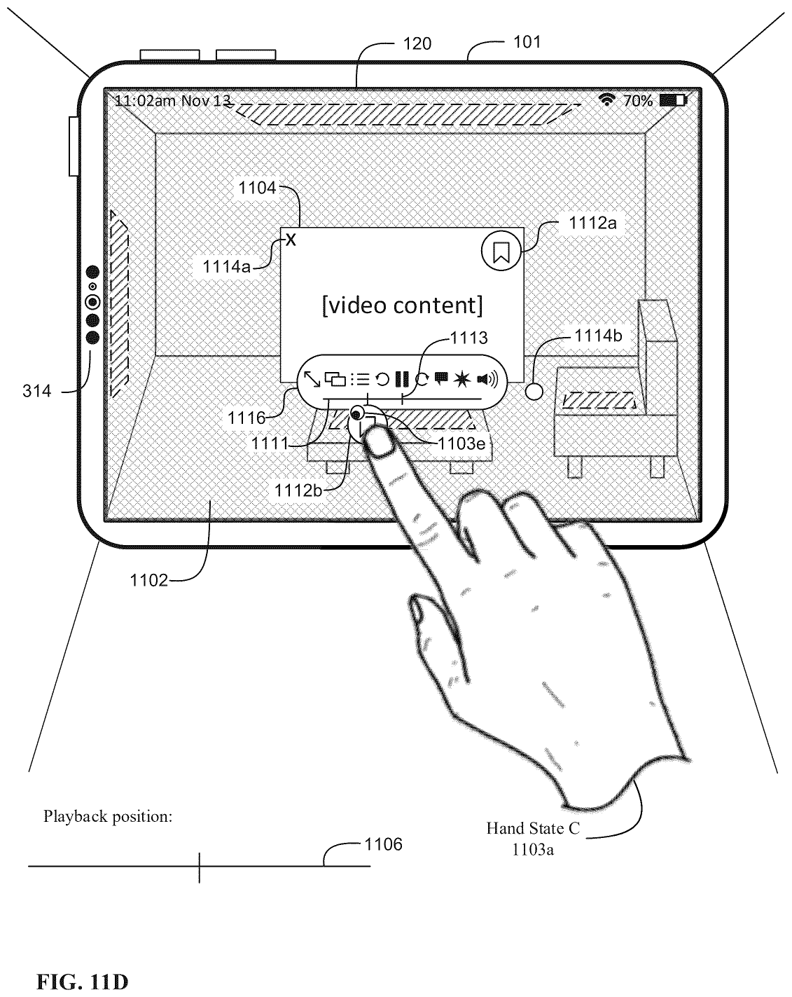

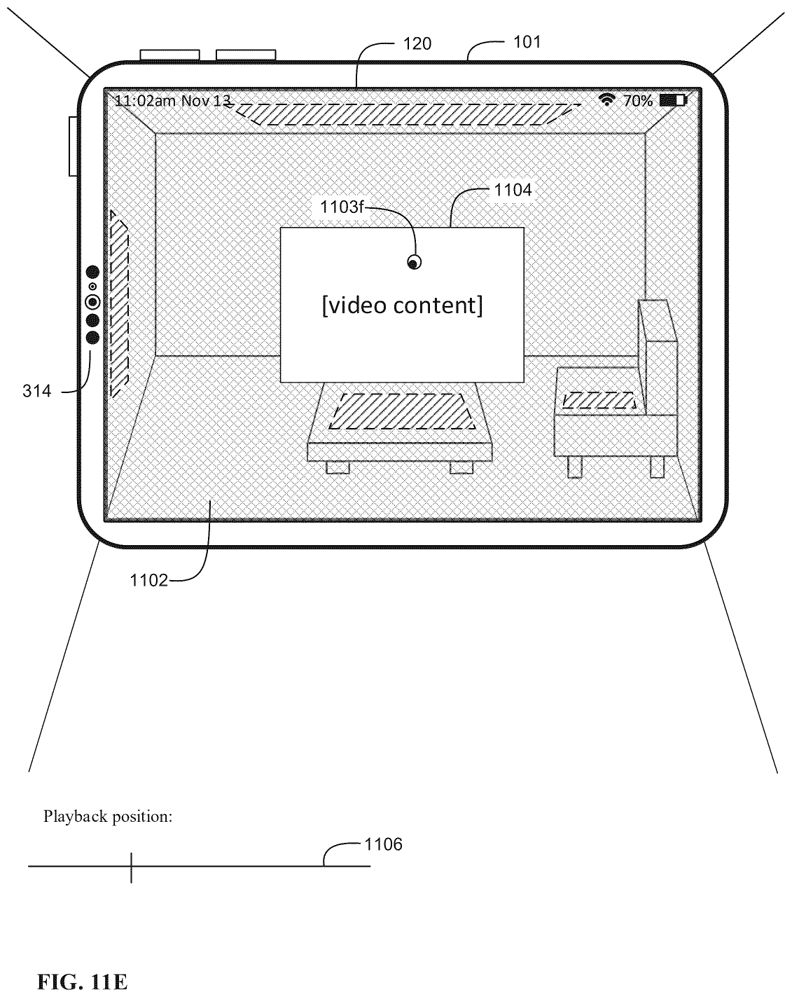

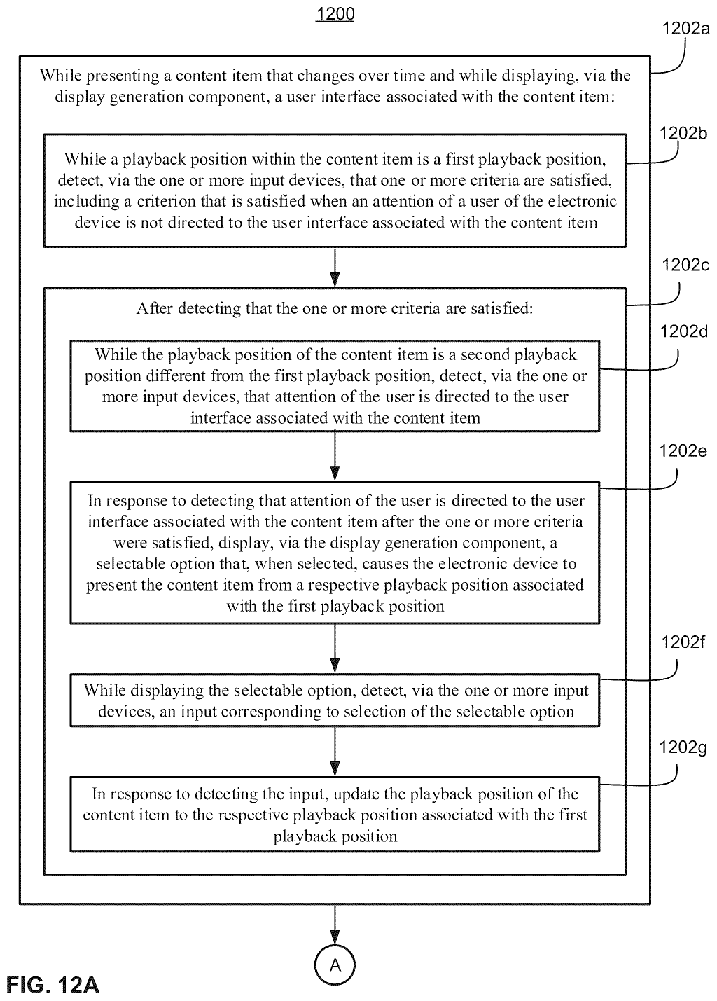

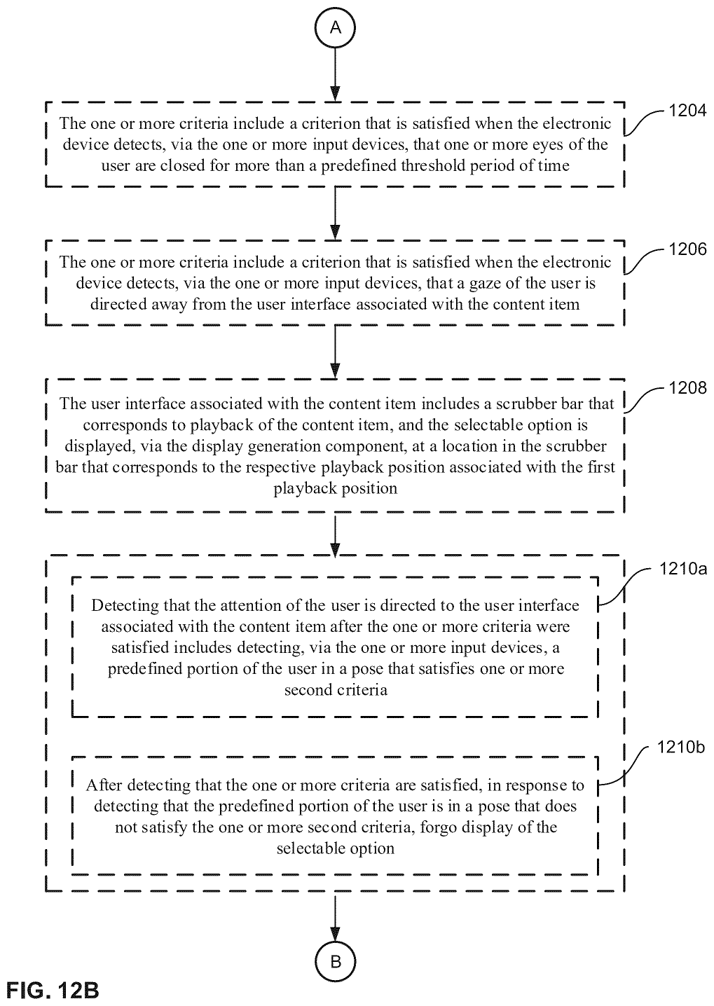

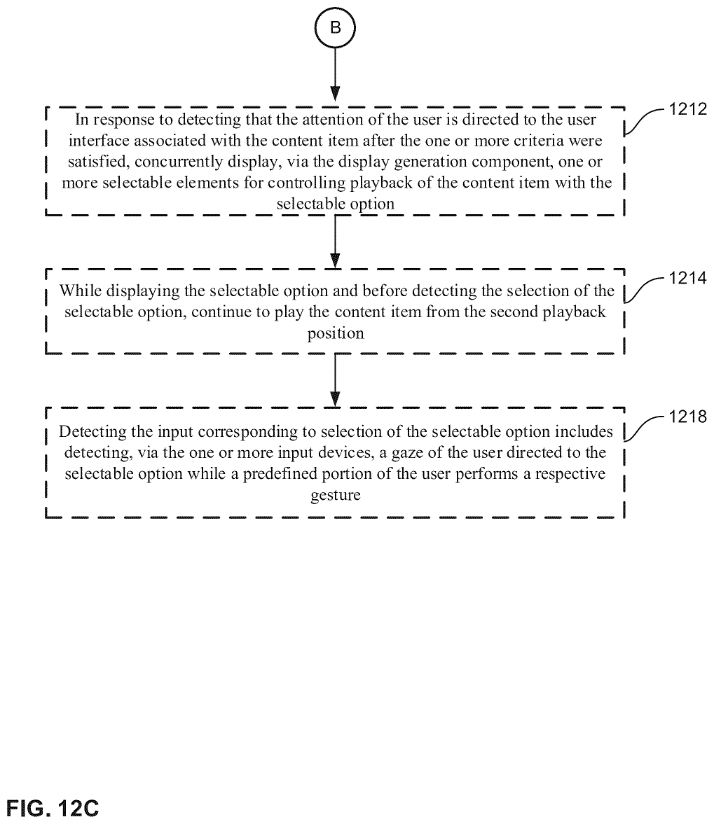

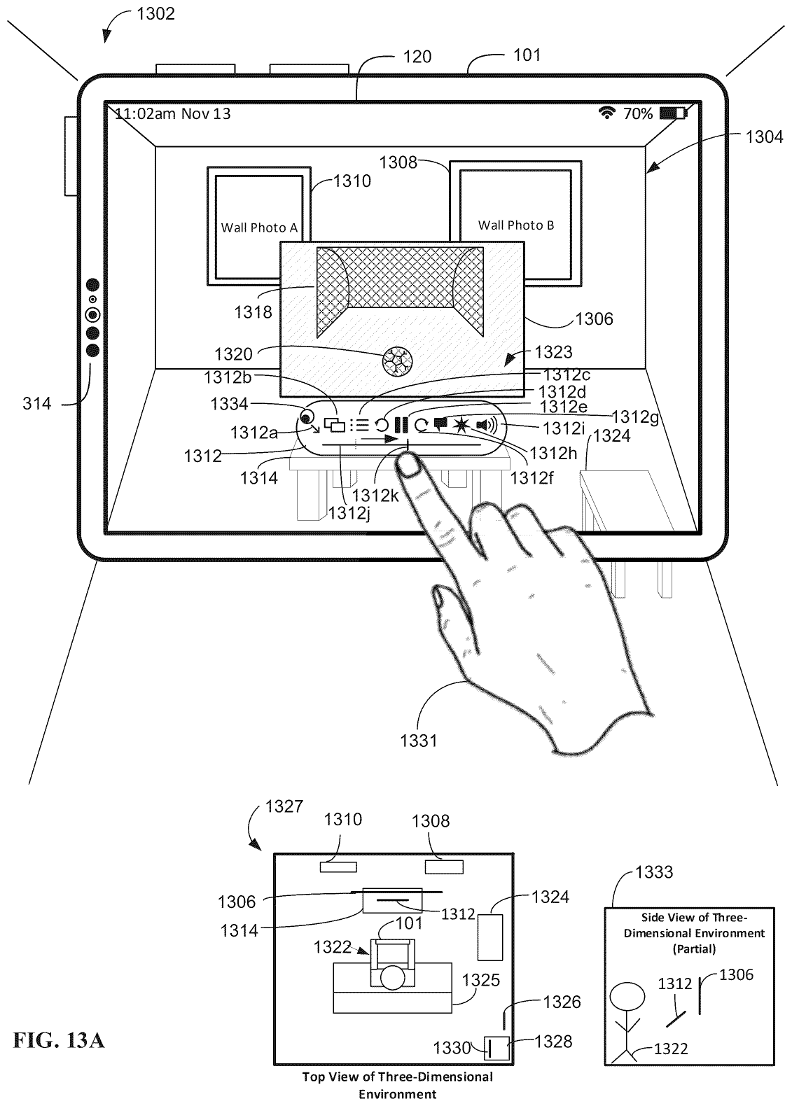

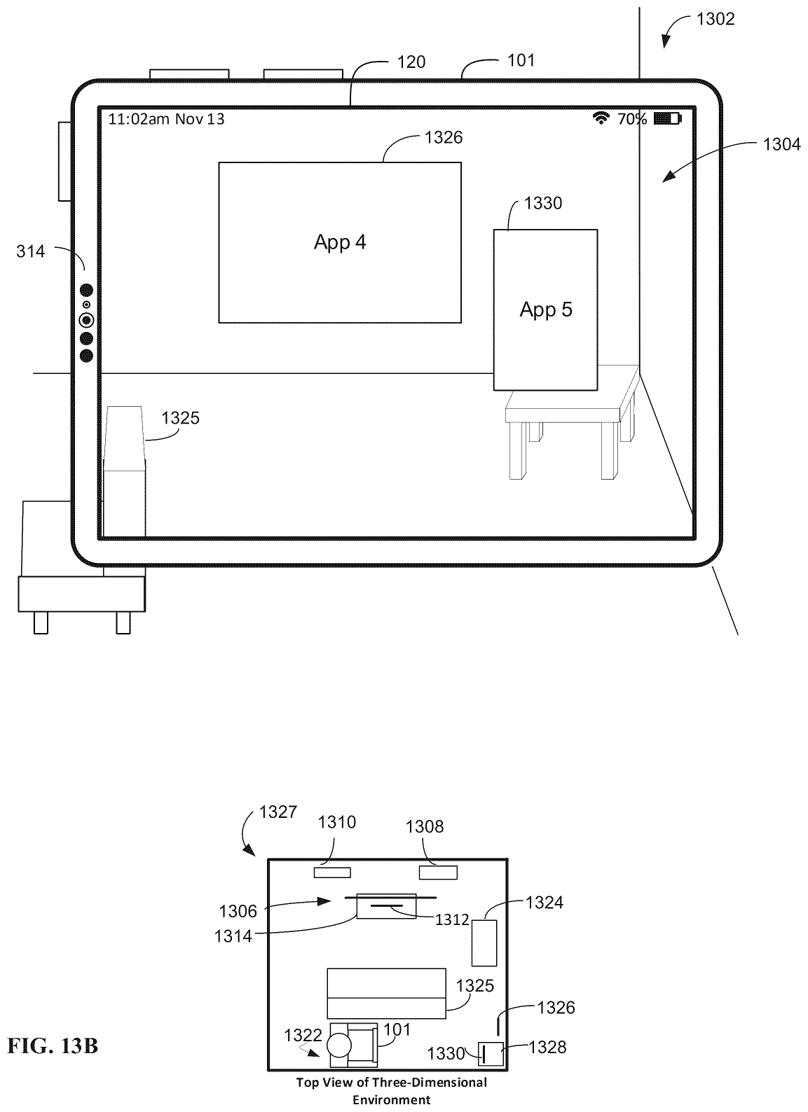

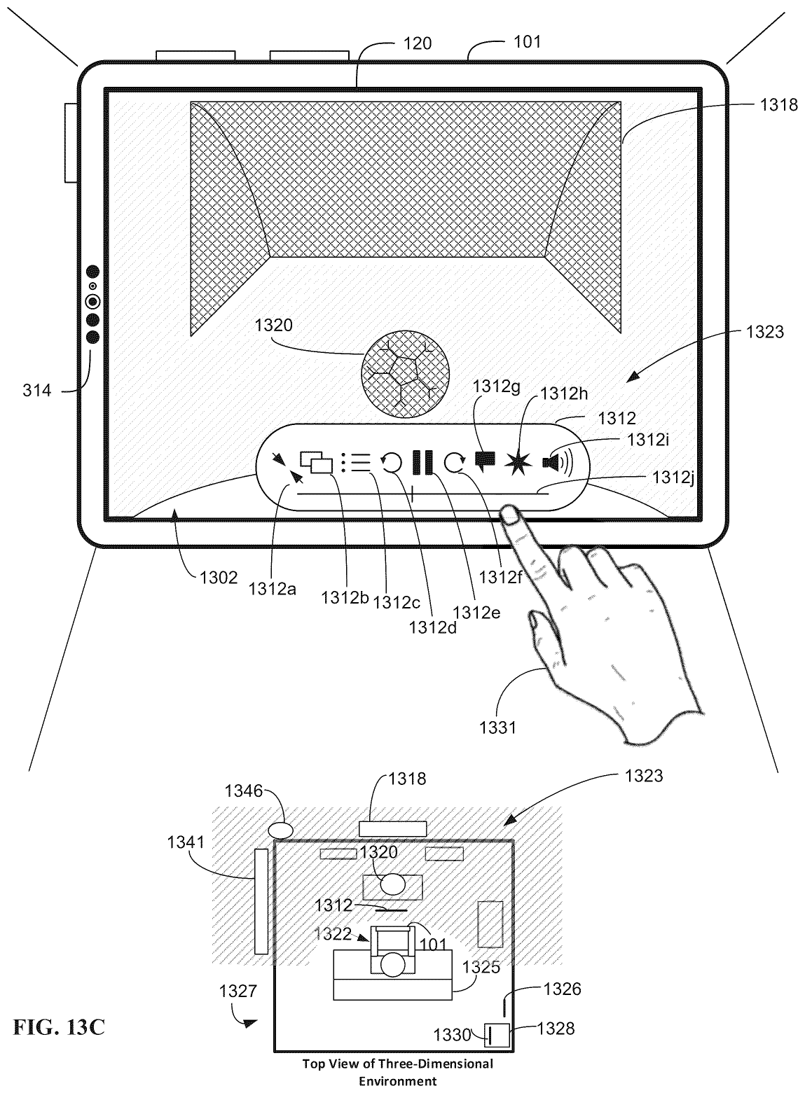

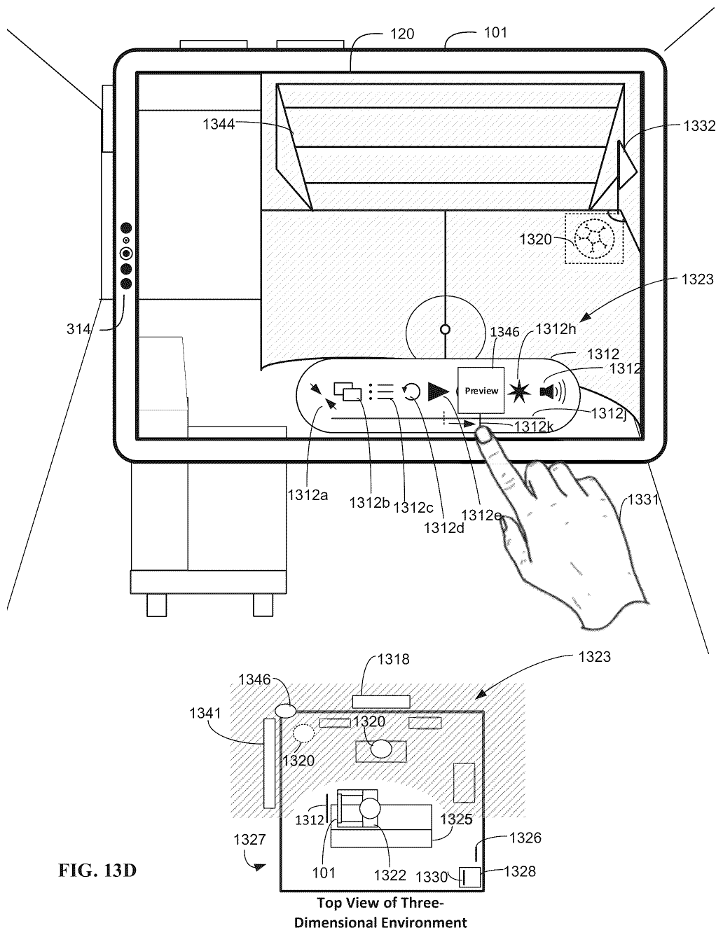

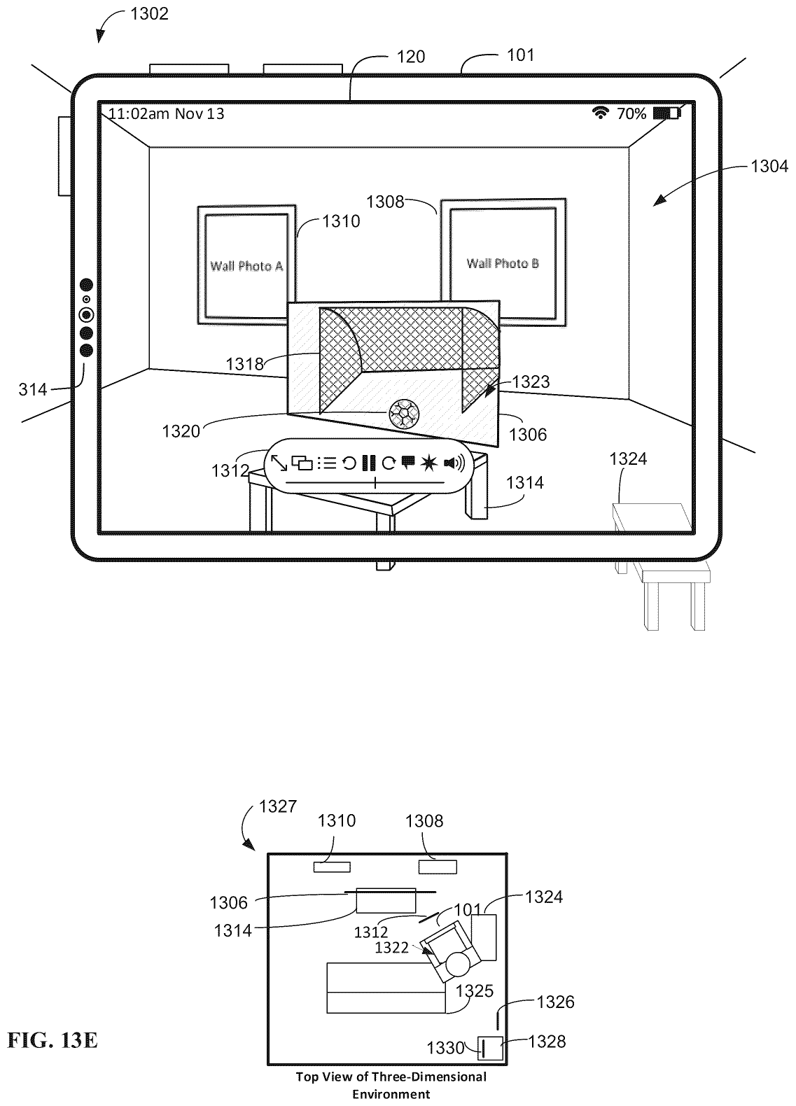

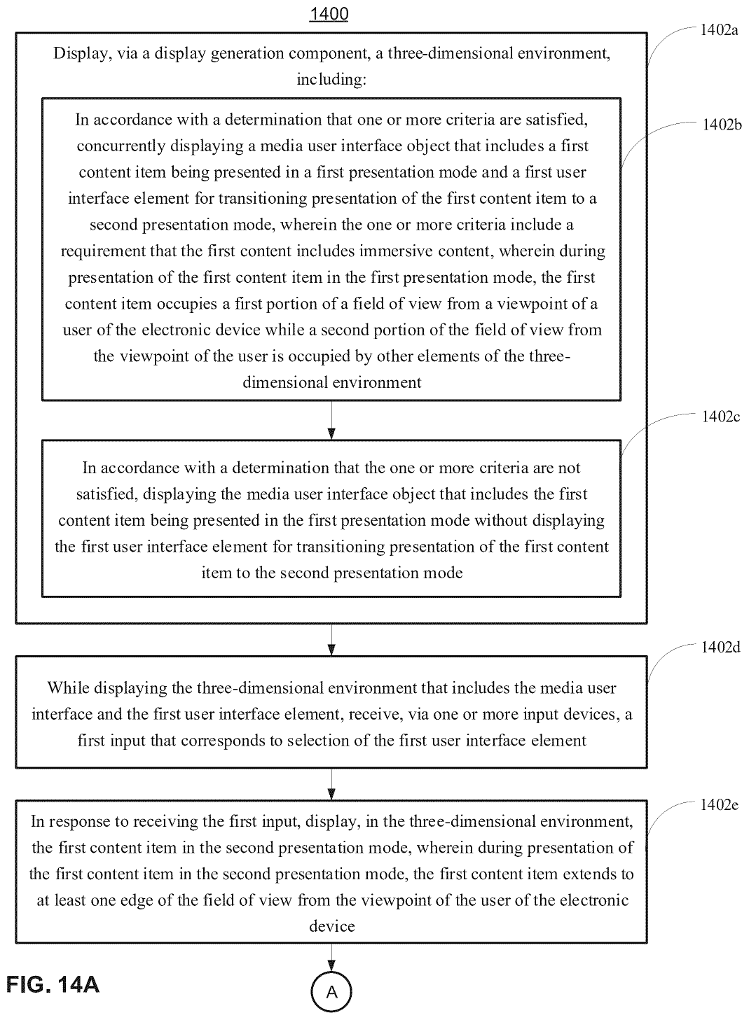

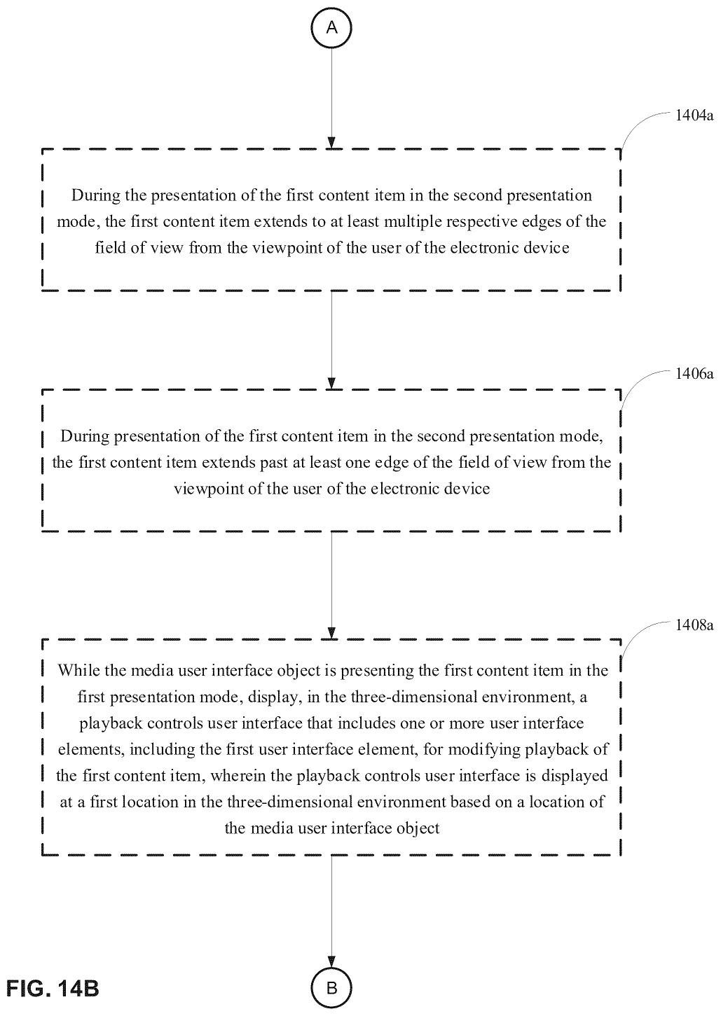

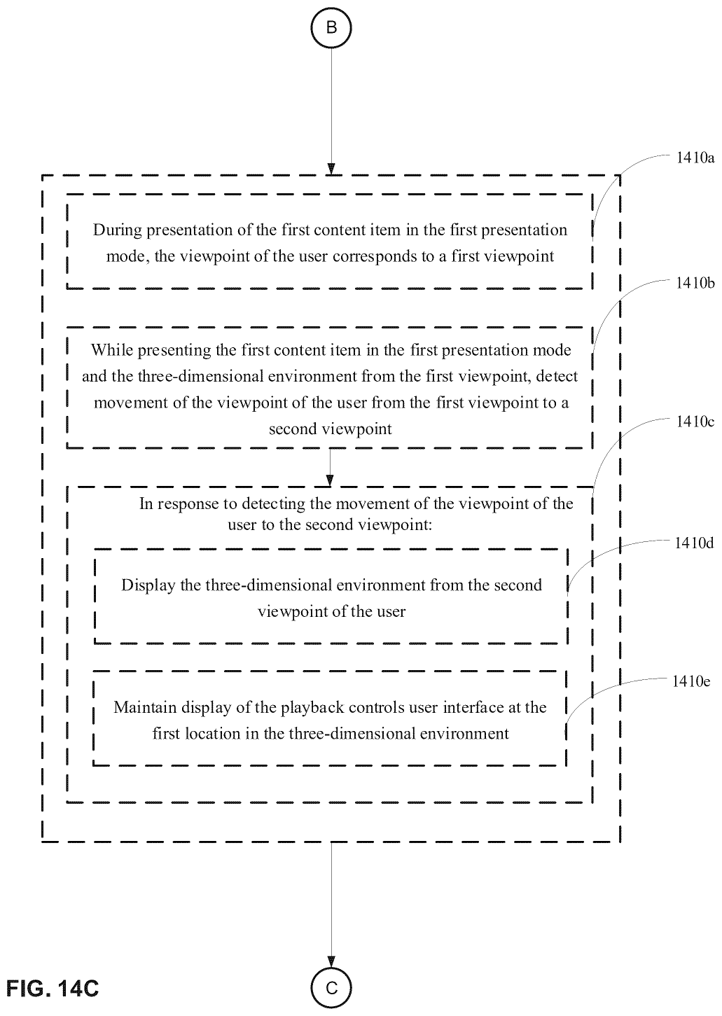

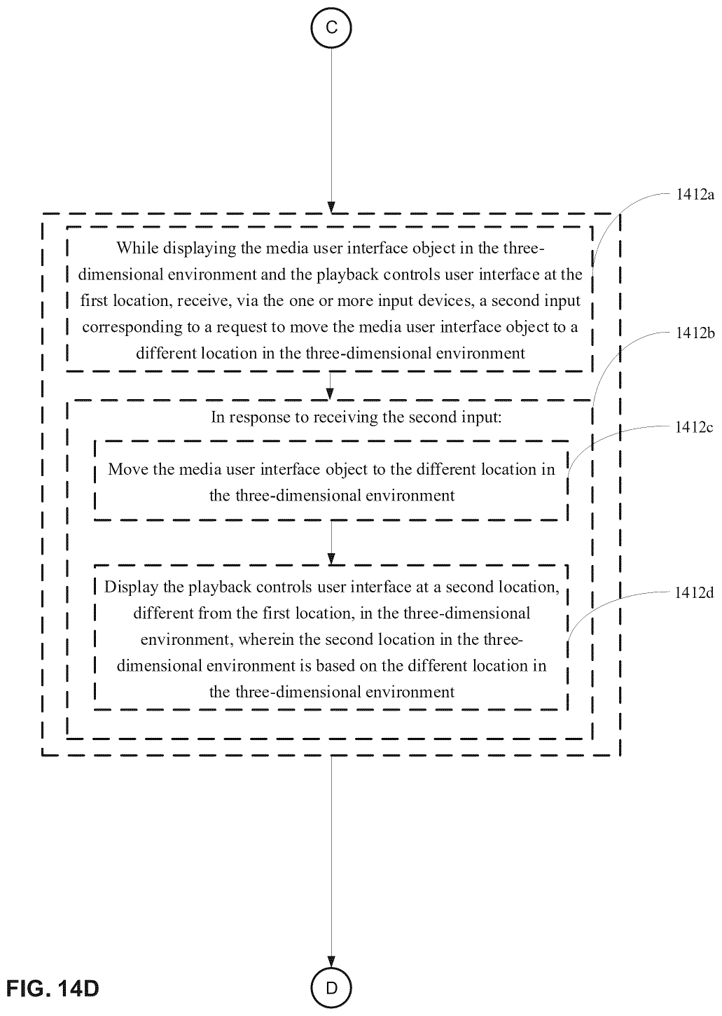

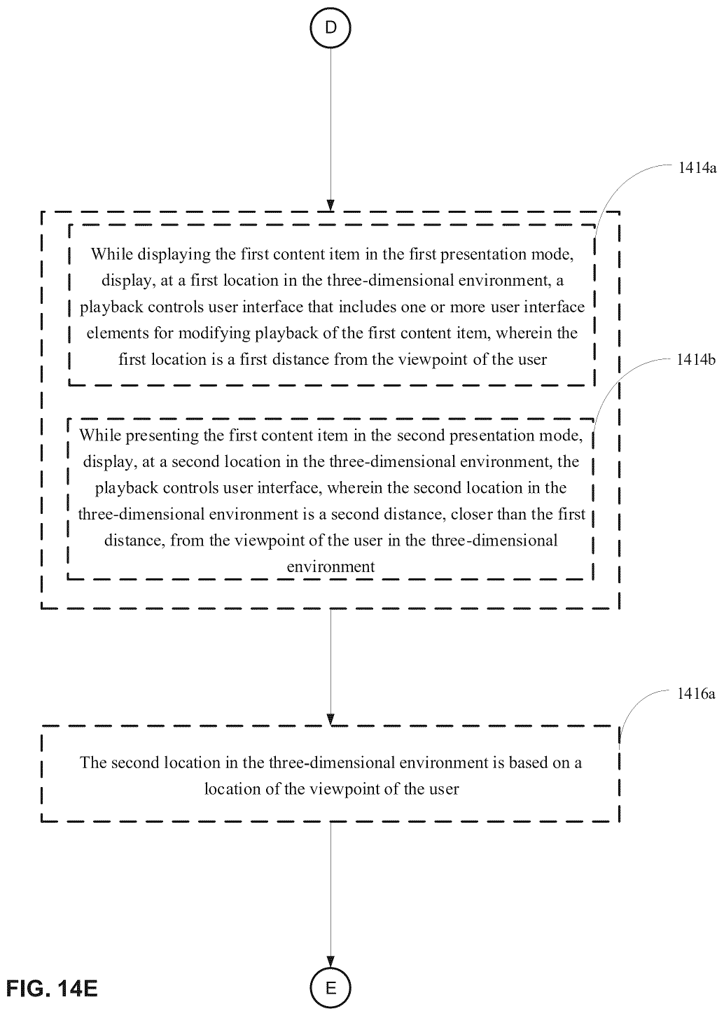

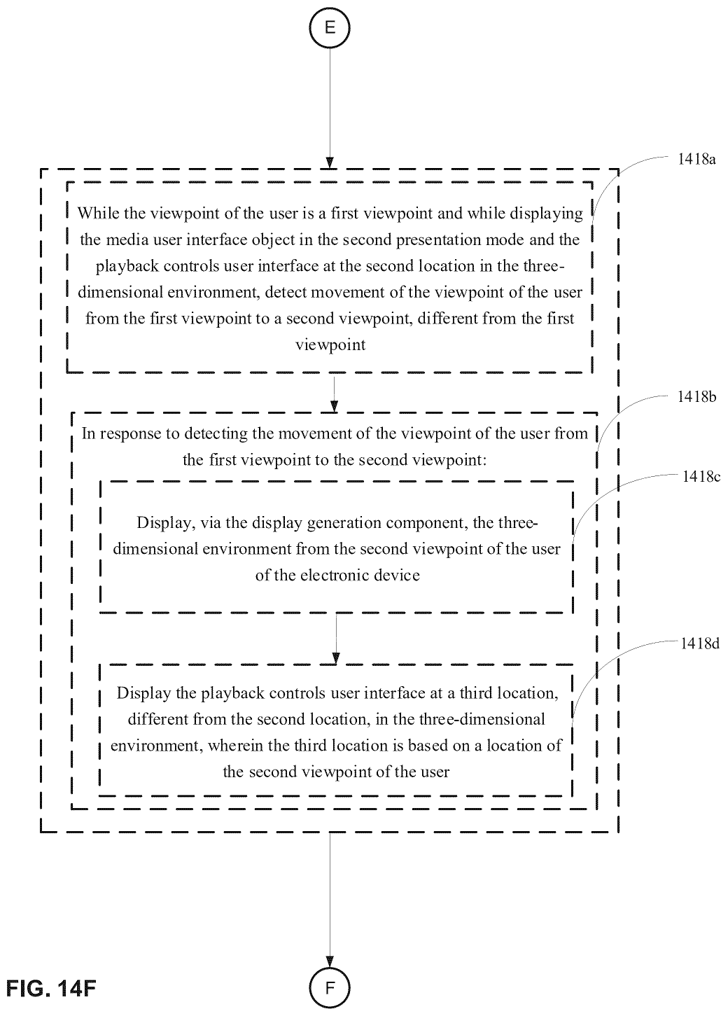

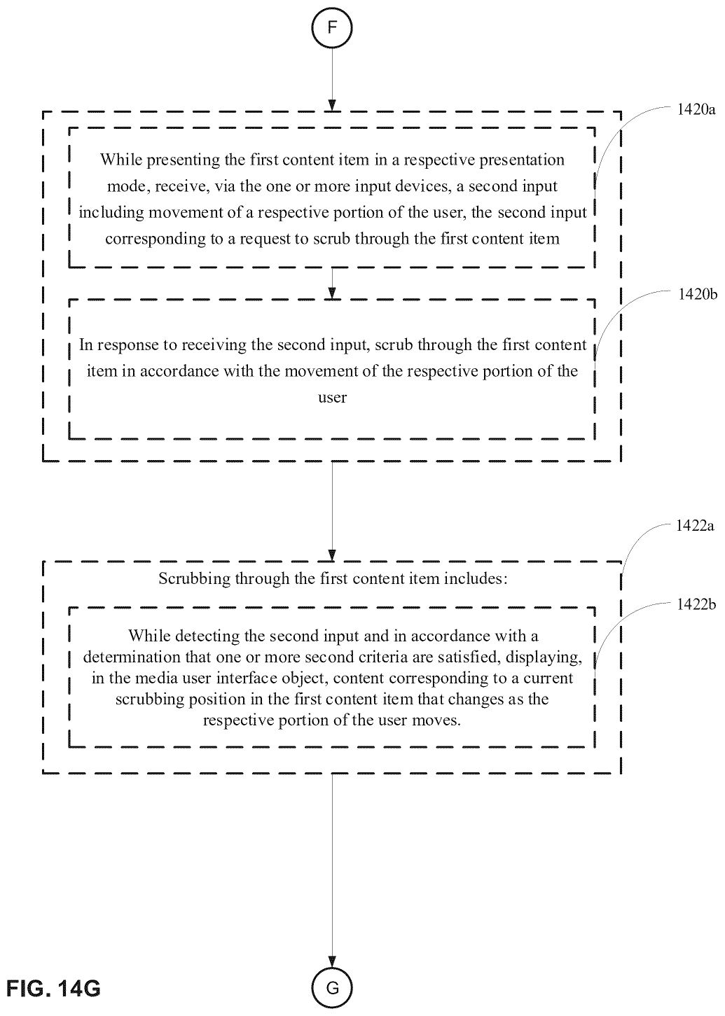

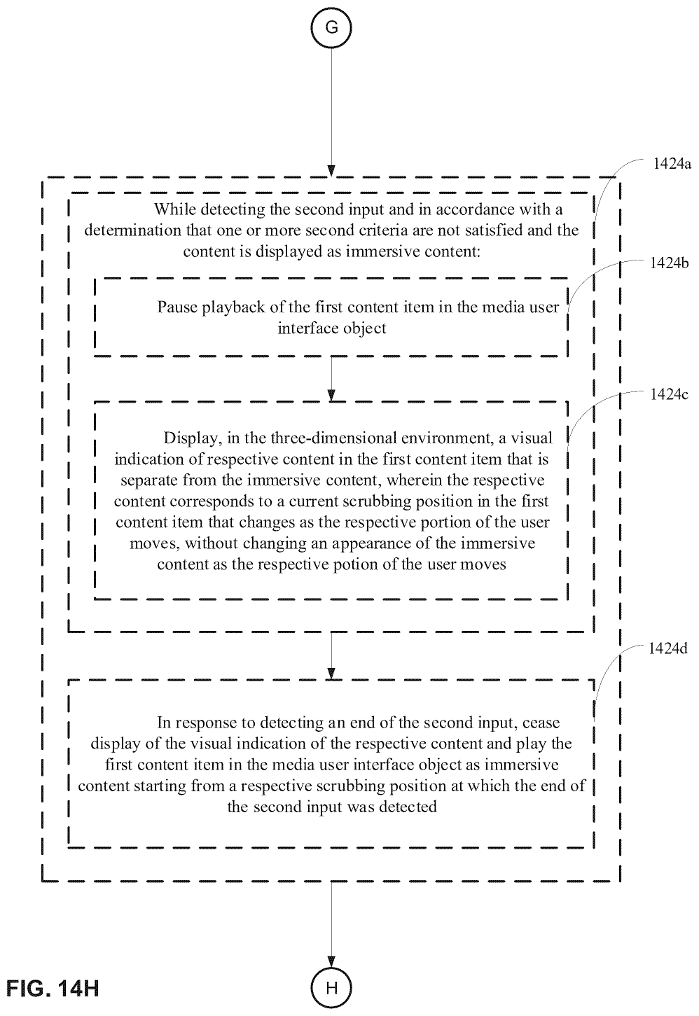

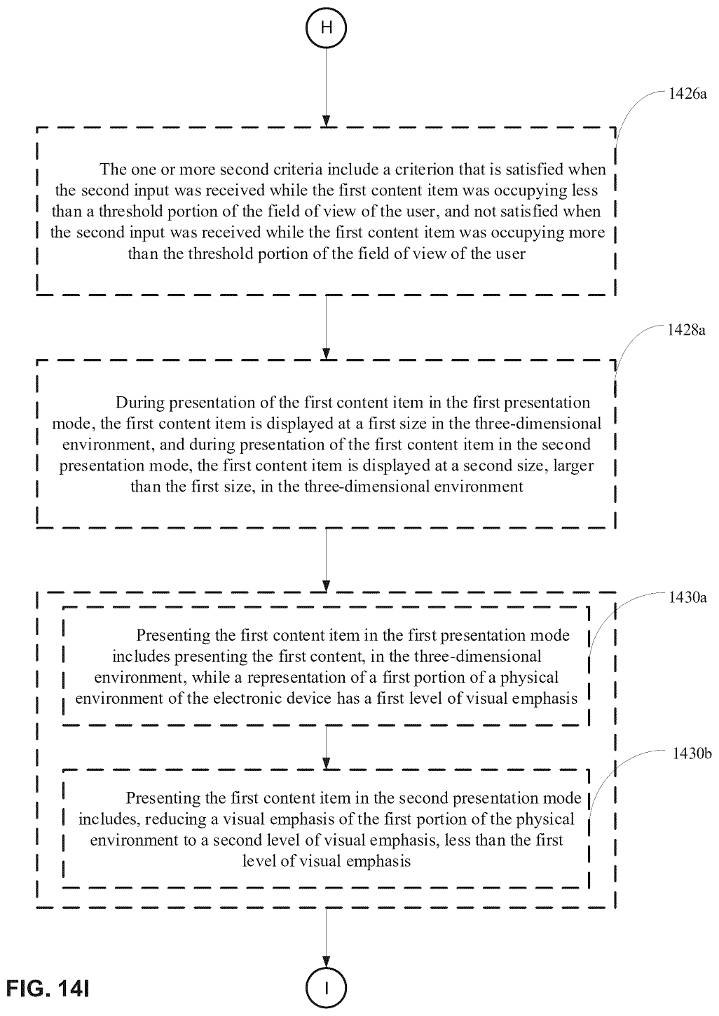

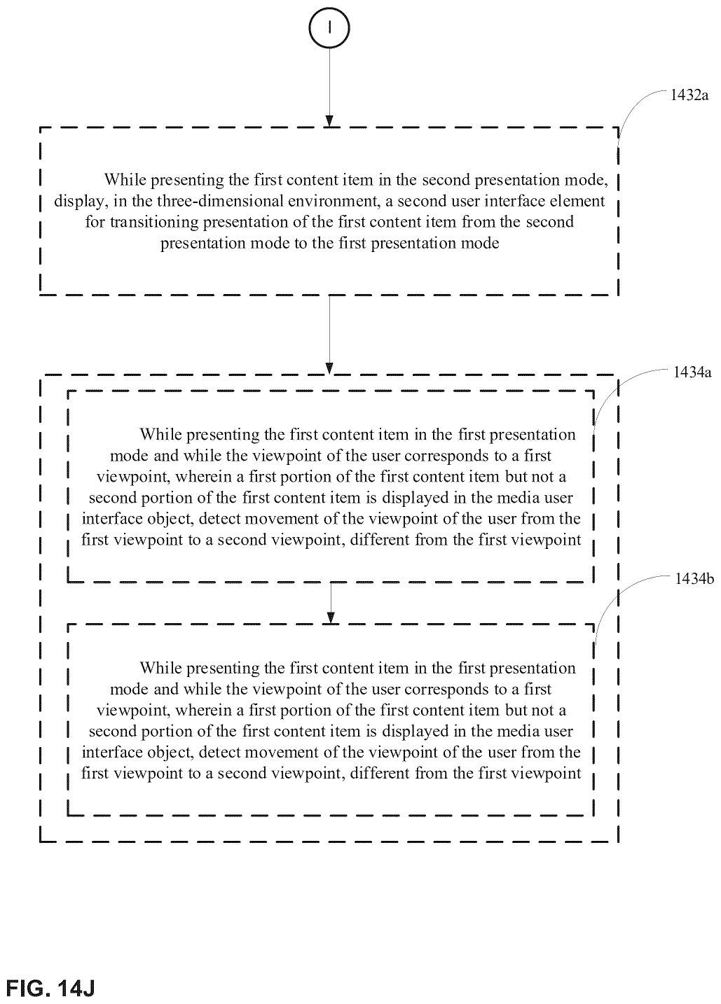

FIGS. 1-6 provide a description of example computer systems for providing XR experiences to users (such as described below with respect to methods 800, 1000, 1200, and 1400). FIGS. 7A-7E illustrate example techniques for generating virtual lighting effects while presenting a content item in accordance with some embodiments. FIGS. 8A-8O is a flowchart illustrating a method of generating virtual lighting effects while presenting a content item in accordance with some embodiments. FIGS. 9A-9E illustrate example techniques for displaying media content in a three-dimensional environment in accordance with some embodiments. FIGS. 10A-10I is a flowchart illustrating a method of displaying media content in a three-dimensional environment in accordance with some embodiments. FIGS. 11A-11E illustrate example techniques for enhancing navigation to a respective playback position of a content item in accordance with some embodiments. FIGS. 12A-12C is a flowchart illustrating a method of enhancing navigation to a respective playback position of a content item in accordance with some embodiments. FIGS. 13A-13E illustrate example techniques for presenting media content in an immersive and non-immersive presentation mode in accordance with some embodiments of the disclosure. FIGS. 14A-14J is a flowchart illustrating a method of presenting media content in an immersive and non-immersive presentation mode in accordance with some embodiments.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing a XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationery with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

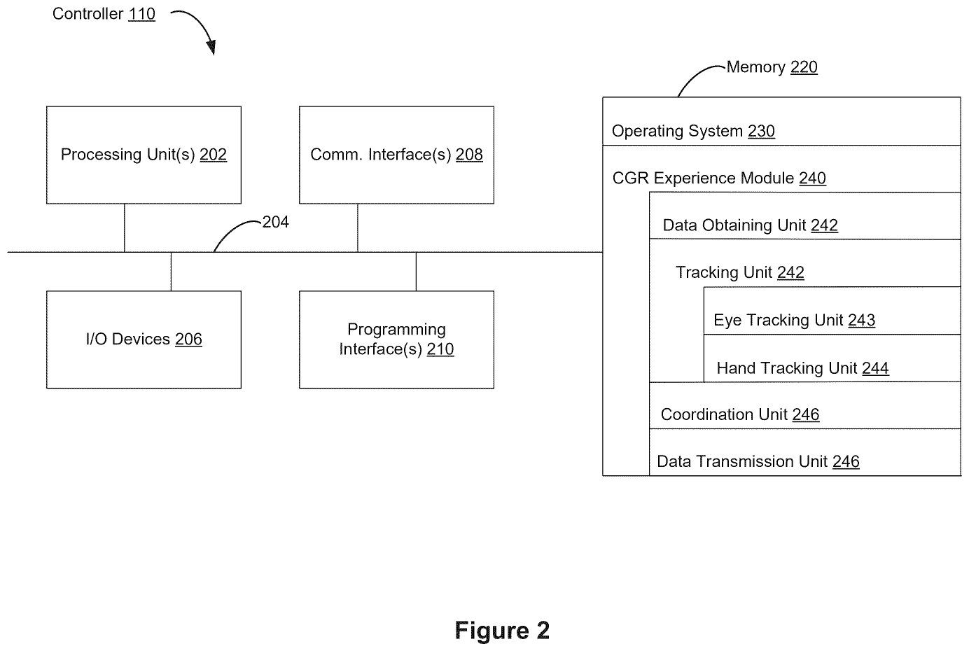

Hardware: There are many different types of electronic systems that enable a person to sense and/or interact with various XR environments. Examples include head mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mounted system may have one or more speaker(s) and an integrated opaque display. Alternatively, a head mounted system may be configured to accept an external opaque display (e.g., a smartphone). The head mounted system may incorporate one or more imaging sensors to capture images or video of the physical environment, and/or one or more microphones to capture audio of the physical environment. Rather than an opaque display, a head mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

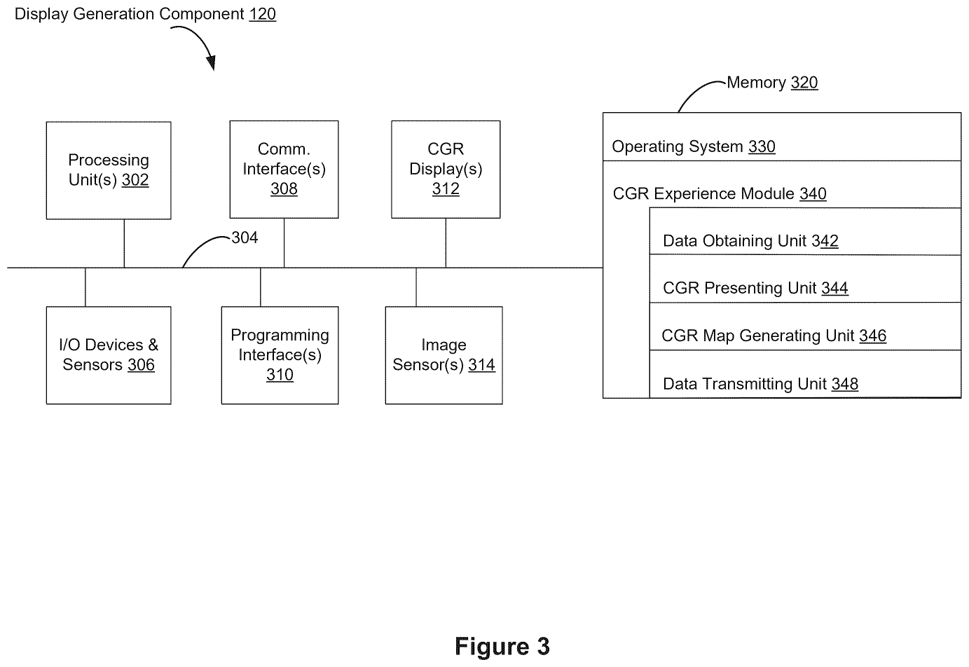

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with CRG content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1, those of ordinary skill in the art will appreciate from the present disclosure that various other features have not been illustrated for the sake of brevity and so as not to obscure more pertinent aspects of the example embodiments disclosed herein.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 242, a tracking unit 244, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

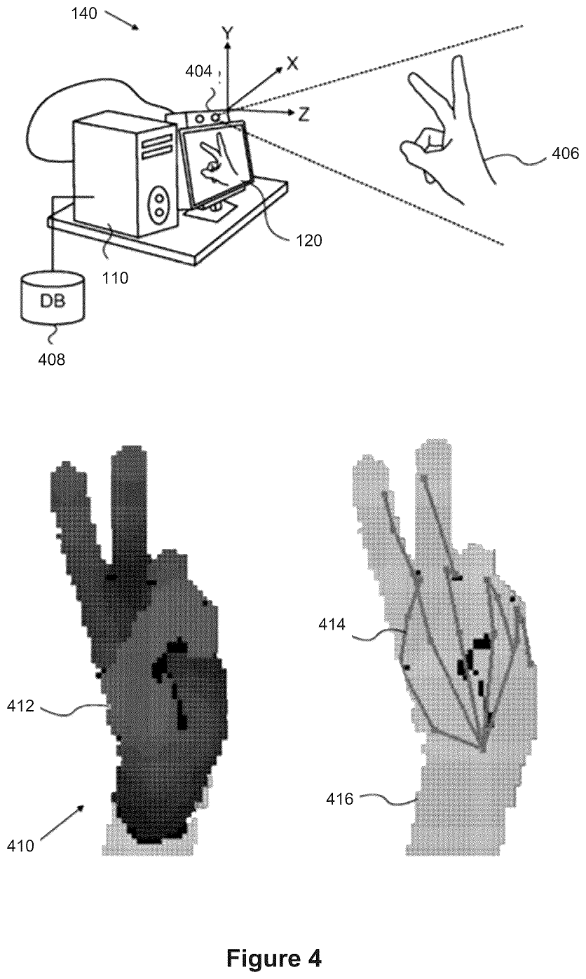

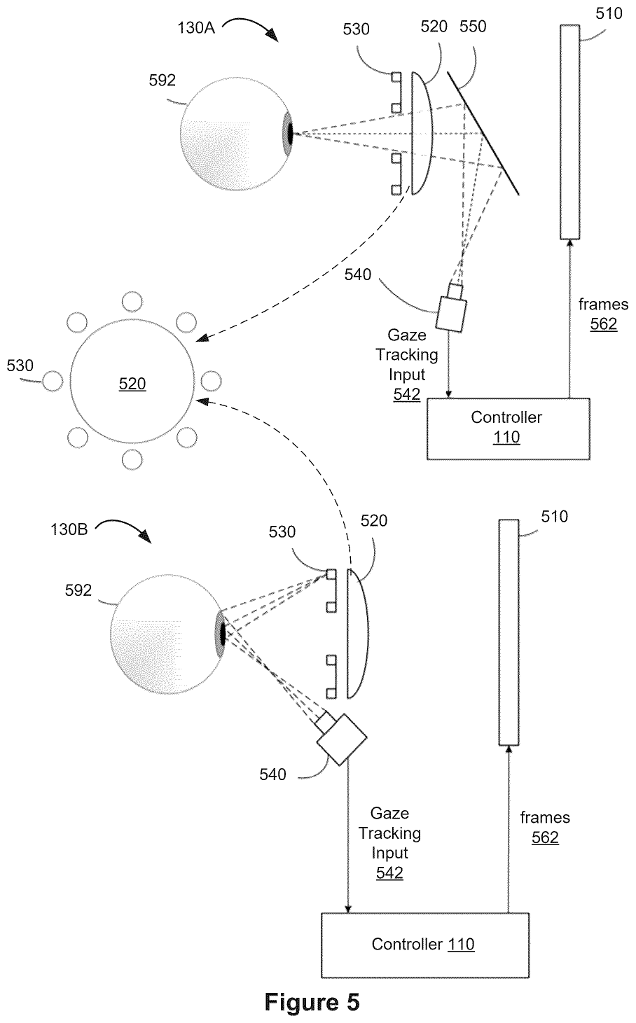

In some embodiments, the tracking unit 242 is configured to map the scene 105 and to track the position/location of at least the display generation component 120 with respect to the scene 105 of FIG. 1, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 (e.g., HMD) includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1) is controlled by hand tracking unit 244 (FIG. 2) to track the position/location of one or more portions of the user's hands, and/or motions of one or more portions of the user's hands with respect to the scene 105 of FIG. 1 (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands)

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors (e.g., a hand tracking device 402) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., light sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight light sources 530 (e.g., LEDs) are arranged around each lens 520 as an example. However, more or fewer light sources 530 may be used, and other arrangements and locations of light sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g. 850 nm) and a camera 540 that operates at a different wavelength (e.g. 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

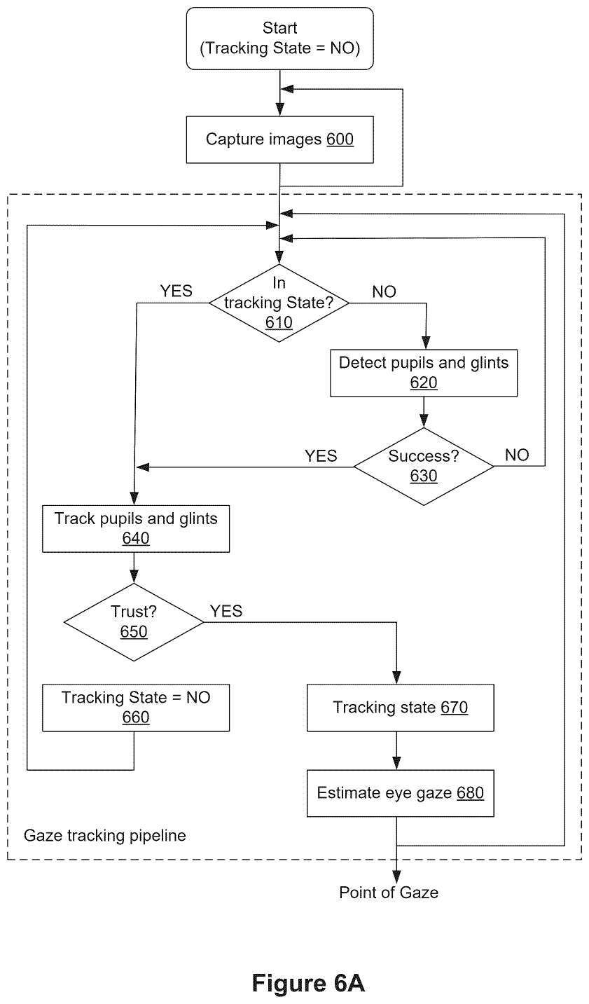

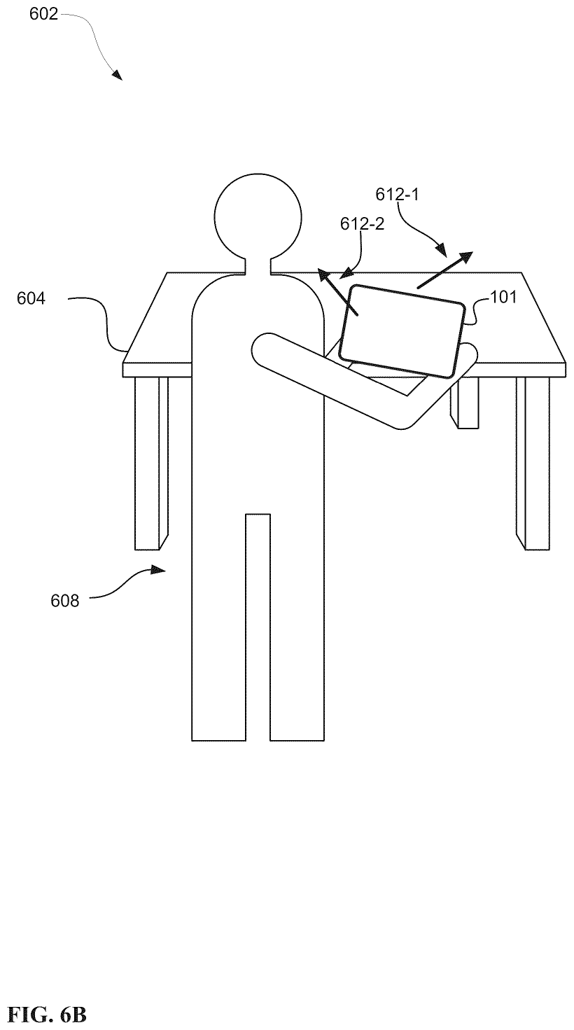

FIG. 6A illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1 and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6A, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660 and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6A is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

FIG. 6B illustrates an exemplary environment of an electronic device 101 providing a XR experience in accordance with some embodiments. In FIG. 6B, real world environment 602 includes electronic device 101, user 608, and a real world object (e.g., table 604). As shown in FIG. 6B, electronic device 101 is optionally mounted on a tripod or otherwise secured in real world environment 602 such that one or more hands of user 608 are free (e.g., user 608 is optionally not holding device 101 with one or more hands). As described above, device 101 optionally has one or more groups of sensors positioned on different sides of device 101. For example, device 101 optionally includes sensor group 612-1 and sensor group 612-2 located on the “back” and “front” sides of device 101, respectively (e.g., which are able to capture information from the respective sides of device 101). As used herein, the front side of device 101 is the side that is facing user 608, and the back side of device 101 is the side facing away from user 608.

In some embodiments, sensor group 612-2 includes an eye tracking unit (e.g., eye tracking unit 245 described above with reference to FIG. 2) that includes one or more sensors for tracking the eyes and/or gaze of the user such that the eye tracking unit is able to “look” at user 608 and track the eye(s) of user 608 in the manners previously described. In some embodiments, the eye tracking unit of device 101 is able to capture the movements, orientation, and/or gaze of the eyes of user 608 and treat the movements, orientation, and/or gaze as inputs.

In some embodiments, sensor group 612-1 includes a hand tracking unit (e.g., hand tracking unit 243 described above with reference to FIG. 2) that is able to track one or more hands of user 608 that are held on the “back” side of device 101, as shown in FIG. 6B. In some embodiments, the hand tracking unit is optionally included in sensor group 612-2 such that user 608 is able to additionally or alternatively hold one or more hands on the “front” side of device 101 while device 101 tracks the position of the one or more hands. As described above, the hand tracking unit of device 101 is able to capture the movements, positions, and/or gestures of the one or more hands of user 608 and treat the movements, positions, and/or gestures as inputs.

In some embodiments, sensor group 612-1 optionally includes one or more sensors configured to capture images of real world environment 602, including table 604 (e.g., such as image sensors 404 described above with reference to FIG. 4). As described above, device 101 is able to capture images of portions (e.g., some or all) of real world environment 602 and present the captured portions of real world environment 602 to the user via one or more display generation components of device 101 (e.g., the display of device 101, which is optionally located on the side of device 101 that is facing the user, opposite of the side of device 101 that is facing the captured portions of real world environment 602).

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the device and displayed via a display generation component. As a mixed reality system, the computer system is optionally able to selectively display portions and/or objects of the physical environment such that the respective portions and/or objects of the physical environment appear as though they exist in the three-dimensional environment displayed by the electronic device. Similarly, the computer system is optionally able to display virtual objects in the three-dimensional environment to appear as though the virtual objects exist in the real world (e.g., physical environment) by placing the virtual objects at respective locations in the three-dimensional environment that have corresponding locations in the real world. For example, the computer system optionally displays a vase such that it appears as though a real vase is placed on top of a table in the physical environment. In some embodiments, each location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as though the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

Similarly, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7E illustrate examples of how an electronic device generates virtual lighting effects while presenting a content item in accordance with some embodiments.

FIG. 7A illustrates an electronic device 101 displaying, via a display generation component 120, a three-dimensional environment 702. It should be understood that, in some embodiments, electronic device 101 utilizes one or more techniques described with reference to FIGS. 7A-7E in a two-dimensional environment without departing from the scope of the disclosure. As described above with reference to FIGS. 1-6, the electronic device 101 optionally includes a display generation component 120 (e.g., a touch screen) and a plurality of image sensors 314. The image sensors optionally include one or more of a visible light camera, an infrared camera, a depth sensor, or any other sensor the electronic device 101 would be able to use to capture one or more images of a user or a part of the user while the user interacts with the electronic device 101. In some embodiments, display generation component 120 is a touch screen that is able to detect gestures and movements of a user's hand. In some embodiments, the user interfaces shown below could also be implemented on a head-mounted display that includes a display generation component that displays the user interface to the user, and sensors to detect the physical environment and/or movements of the user's hands (e.g., external sensors facing outwards from the user), and/or gaze of the user (e.g., internal sensors facing inwards towards the face of the user).

In FIG. 7A, the electronic device 101 displays a content item 704 in a three-dimensional environment 702. The three-dimensional environment 702 further includes representations of real objects in the physical environment of the electronic device 101, including a representation 706a of a table, a representation 706b of a sofa, a representation 708a of a wall, and a representation 708b of the ceiling. The electronic device 101 detects, via one or more sensors 314, the gaze 713a of the user directed to the content item 704, which is optionally video content that is currently playing on the electronic device 101. In some embodiments, because the gaze 713a of the user is directed to the content item 704 while the content item 704 is playing, the electronic device 101 displays the three-dimensional environment 702 with one or more or a plurality of virtual lighting effects.

In some embodiments, the virtual lighting effects generated by the electronic device 101 include visually emphasizing the content item, such as by blurring and/or darkening portions of the three-dimensional environment 702 not including the content item 704 and displaying a virtual light spill emanating from the content item 704. The virtual light spill includes virtual lighting 710a displayed on the representation 708a of the wall, virtual lighting 710b displayed on the representation 708b of the ceiling, virtual lighting 710c displayed on the representation 706a of the table, and virtual lighting 710d displayed on representation 706b of the sofa. In some embodiments, the virtual lighting 710a-d is based on video content of the content item 704. For example, the colors, intensities, etc. of the virtual lighting 710a-d are optionally based on the colors, intensity, etc. of the video content of the content item 704 to simulate that the virtual lighting 710a-d is a reflection of the video content of the content item 704 and/or that virtual lighting 710a-d is emitting from content item 704 on various surfaces in the three-dimensional environment 702. In some embodiments, the sizing of the virtual lighting 710a, 710b, 710c, and 710d is based on the distance from the respective surface of the virtual lighting effect to the content item 704 and the position of the virtual lighting 710a, 710b, 710c, and 710d is based on the position of the content item 704 in the three-dimensional environment 702.

In FIG. 7A, the hand 703a of the user is in a pose that does not cause the electronic device 101 to display one or more selectable options for controlling playback of the content item 704, as will be described in more detail below with reference to FIGS. 7B-7E. Thus, the electronic device 101 forgoes display of the selectable options for controlling playback of the content item 704 in FIG. 7A.

FIG. 7B illustrates display of a plurality of selectable options 712a-L for controlling playback of the content item 704 and a user input corresponding to a request to resize the content item 704 in the three-dimensional environment 702. In some embodiments, the electronic device 101 displays the selectable options 712a-L in response to detecting the hand 703b of the user in the ready state pose while the gaze 713a of the user is directed to the content item 704. In some embodiments, detecting the hand 703b in the ready state pose includes detecting the hand 703b in a pre-pinch hand shape in which the thumb is within a threshold distance (e.g., 0.1, 0.2, 0.3, 0.5, 1, 2, 3, or 5 centimeters) of, but not touching, another finger of the hand 703b or detecting the hand 703b in a pointing hand shape in which one or more fingers are extended and one or more fingers are curled towards the palm.

In FIG. 7B, the plurality of the selectable options 712c-L for controlling playback of the content item 704 are displayed in a user interface element 711 separate from the content item 704. In some embodiments, the user interface element 711 is angled towards a viewpoint of the user, as will be described in more detail below with reference to method 1400, at a different angle than the angle at which the content item 704 is displayed relative to the viewpoint of the user. For example, because the user interface element 711 is displayed at a lower height in three-dimensional environment 702 than the content item 704, the electronic device 101 angles the user interface element 711 up relative to the angle of the content item 704. As shown in FIG. 7B, a portion of the user interface element 711 is visually or spatially overlaid on the content item 704 and the user interface element 711 is optionally displayed closer to the viewpoint of the user in the three-dimensional environment 702 than the content item 704.

The selectable options 712c-L included in the user interface element 711 will now be described. Option 712c, when selected, causes the electronic device 101 to display the content item 704 in an immersive content mode according to one or more steps of method 1400. Option 712d, when selected, causes the electronic device 101 to display the content item 704 in a picture-in-picture element according to one or more steps of method 1000. Option 712e, when selected, causes the electronic device 101 to present a content playback queue (e.g., in a user interface element separate from the content item 704 and/or in place of the content item 704) including one or more content items the electronic device 101 is configured to play next. Option 712f, when selected, causes the electronic device 101 to adjust the playback position of the content item 704 back by a predetermined amount (e.g., 5, 10, 15, 30, or 60 seconds). Option 712g, when selected, causes the electronic device 101 to pause playback of the content item 704. In some embodiments, while the content item 704 is paused, the electronic device 101 ceases to display the content item 704 with greater visual emphasis relative to the rest of the three-dimensional environment. In some embodiments, while the content item 704 is paused, the electronic device 101 ceases display of the virtual lighting effects, including blurring and/or dimming the three-dimensional environment 702 other than the content item 704 and/or display of the virtual light spill emanating from the content item 704. Option 712h, when selected, causes the electronic device 101 to adjust the playback position of the content item 704 ahead by a predetermined amount (e.g., 5, 10, 15, 30, or 60 seconds). Option 712i, when selected, causes the electronic device 101 to present subtitle options associated with the content item 704. Option 712j, when selected, causes the electronic device 101 to adjust the virtual lighting effects, such as the blurring and/or dimming effect and/or the light spill effect, as will be described in more detail below with reference to FIGS. 7C-7E. Option 712k, when selected, causes the electronic device 101 to adjust the playback volume of audio content included in the content item 704. The user interface element 711 further includes a scrubber bar 712L that includes an indication of the current playback position of the content item 704 and, in response to an input moving the indication of the current playback position, causes the electronic device 101 to adjust the playback position of the content item 704 and resume playback of the content item 704 from the adjusted playback position.

In addition to the selectable options 712c-712L displayed in the user interface element 711, the electronic device 101 further displays a selectable option 712a that, when selected, causes the electronic device 101 to cease display of the content item 704 (and, optionally, the user interface element 711 and options 712a and 712b) and a selectable option 712b that, when the electronic device 101 detects an input directed to it, causes the electronic device 101 to resize the content item 704 in the three-dimensional environment 702. The selectable option 712a for closing the content item 704 is displayed overlaid on the content item 704 outside of user interface element 711. The selectable option 712b for resizing the content item 704 is displayed outside of the content item 704 and the user interface element 711.

As shown in FIG. 7B, the electronic device 101 receives an input directed to the selectable option 712b for resizing the content item 704 provided by hand 703a and gaze 713b. In some embodiments, detecting the input includes detecting the user perform a selection pose with hand 703a, including a predetermined hand shape, such as a pinch hand shape in which the thumb of the hand 703a touches another finger of the hand or a pointing hand shape in which one or more fingers of hand 703a are extended and one or more fingers of hand 703a are curled towards the palm of the hand 703a while gaze 713b is directed to option 712b. In some embodiments, while maintaining the predetermined hand shape, the user moves their hand and, in response to detecting the movement, the electronic device 101 resizes the content item 704 in accordance with the (e.g., speed, duration, distance, direction, etc. of the) movement of the hand 703a. As will be described in more detail below with reference to FIG. 7C, the electronic device 101 does not resize element 711 when resizing the content item 704 in accordance with the input provided by hand 703a and gaze 713b.

FIG. 7C illustrates how the electronic device 101 resizes the content item 704 in response to the input illustrated in FIG. 7B without changing the size of the user interface element 711. In response to the input illustrated in FIG. 7B, the electronic device 101 displays the content item 704 in FIG. 7C at a smaller size than the size at which the content item 704 was displayed in FIG. 7B while maintaining the size of user interface element 711. The electronic device 101 also updates one or more characteristics (e.g., the size) of the virtual lighting 710a-710c in accordance with the updated size of the content item 704; for example, by reducing the sizes of the virtual lighting 710a-710c in the three-dimensional environment 702 to correspond to the reduced size of content item 704. In FIG. 7C, the electronic device 101 optionally continues to display the user interface element 711 and other selectable options in response to detecting the hand 703b in the ready state as described above.

FIG. 7C also illustrates the electronic device 101 displaying a user interface element 714 indicating functionality of the virtual lighting effect option 712j in response to the gaze 713d of the user being directed to the option 712j. In some embodiments, the electronic device 101 displays the user interface element 714 associated with the lighting effect option 712j because the lighting effect option 712j is particularly related to displaying content items in a three-dimensional environment 702. As shown in FIG. 7C, if the gaze 713c of the user were instead directed to the option 712f to adjust the playback position of the content item back by a predetermined amount, the electronic device 101 would optionally forgo display of a user interface element associated with the option 712f, optionally because the option 712f is not particularly related to presenting content items in three-dimensional environments moreso than presenting content items in other environments or user interfaces. In some embodiments, a first plurality of the interactive elements in user interface element 711 are associated with visual indications similar to indication 714 and a second plurality of interactive elements in the user interface element 711 are not associated with visual indications similar to indication 714.

In FIG. 7C, the electronic device 101 detects an input provided by hand 703a and gaze 713a directed to the content item 704. In some embodiments, the input corresponds to a request to update the position of the content item in the three-dimensional environment 702. In some embodiments, the electronic device 101 displays a user interface element other than the content item itself that, when selected, causes the electronic device 101 to initiate a process to reposition the content item 704 in the three-dimensional environment 702. In some embodiments, the repositioning user interface element is displayed outside of the content item 704 and outside of the user interface element 711, similar to the resizing user interface element 714. In some embodiments, the repositioning user interface element is a horizontal bar or line aligned along the bottom of user interface element 711. In some embodiments, the repositioning user interface element is included in user interface element 711 or overlaid on content item 704 without being included in user interface element 711.

In some embodiments, detecting the input corresponding to the request to reposition the content item 704 in the three-dimensional environment 702 includes detecting the user make a predefined hand shape with hand 703a, such as the pinch hand shape or pointing hand shape described above while detecting gaze 713a directed to content item 704. In some embodiments, while the user makes the predefined hand shape, the electronic device 101 detects movement of the hand 703a and, in response, moves the content item 704 and user interface element 711 in accordance with the (e.g., distance, duration, speed, direction, etc. of the) movement of the hand 703a, as shown in FIG. 7D.

FIG. 7D illustrates the electronic device 101 displaying the content item 704 and the user interface element 711 at updated locations in the three-dimensional environment 702 in accordance with the input illustrated in FIG. 7C. In accordance with the input illustrated in FIG. 7C, the electronic device 101 displays the content item 704 and the user interface element 711 in FIG. 7D at locations in the three-dimensional environment 702 that are closer to the viewpoint of the user from which the three-dimensional environment 702 is displayed than the locations of the content item 704 and the user interface element 711 in FIG. 7C. In accordance with displaying the content item 704 closer to the viewpoint of the user in FIG. 7D, the electronic device 101 displays the content item 704 at a larger angular size (e.g., occupying more space in the field of view of the user and/or of the display generation component 120) in FIG. 7D than in FIG. 7C; however, in some embodiments, the size of the content item 704 in the three-dimensional environment 702 is the same in FIGS. 7C and 7D (e.g., the size of content item 704 I three-dimensional environment 702 does not change from FIGS. 7C to 7D). As shown in FIGS. 7C-7D, the electronic device 101 does not update the angular size of the user interface element 711 even though the user interface element 711 is closer to the viewpoint of the user in FIG. 7D than in FIG. 7C. In some embodiments, forgoing updating the angular size of the user interface element 711 includes updating a size of the user interface element 711 in three-dimensional environment 702. For example, because the user interface element 711 is closer to the viewpoint of the user in FIG. 7D than in FIG. 7C, but is displayed at the same angular size in FIGS. 7C and 7D, the electronic device 101 has decreased the size of the user interface element 711 in environment 702 in FIG. 7D compared to the size of the user interface element 711 in environment 702 in FIG. 7C. As shown in FIG. 7D, in accordance with the movement of the content item 704, the electronic device 101 updates the positions of virtual lighting 710a, 710b, and 710d on other portions of the three-dimensional environment 702.

In FIG. 7D, the electronic device 101 detects an input directed to lighting effect option 712j provided by gaze 713e and hand 703a. In some embodiments, detecting the input includes detecting the hand 703a make the pinch hand shape described above or the pointing hand shape described above while detecting gaze 713e directed to option 712j. In some embodiments, in response to detecting the pinch hand shape or pointing hand shape for less than a predetermined time threshold (e.g., 0.1, 0.2, 0.3, 0.5, 1, or 2 seconds), the electronic device 101 toggles the lighting effects (e.g., the blurring and/or darkening lighting effect and/or the light spill lighting effect) on or off. In some embodiments, in response to detecting the pinch hand shape or the pointing hand shape for more than the time threshold, the electronic device 101 presents slider element 716 that, when interacted with, enables the user to adjust the level (e.g., of intensity) of the lighting effects. In some embodiments, both the blurring and/or dimming lighting effect and the light spill lighting effect are updated in accordance with inputs directed to the lighting effect option 712j and/or slider 716. In some embodiments, the three-dimensional environment 702 includes separate elements for adjusting each lighting effect. As shown in FIG. 7D, the electronic device 101 detects the user's gaze 713e directed to slider 716 while detecting movement of hand 703a while the hand 703a makes the pinch or pointing hand shape. In response to the input illustrated in FIG. 7E, the electronic device 101 reduces the intensity of the blurring and/or darkening lighting effect and the light spill lighting effect, as shown in FIG. 7E.

FIG. 7E illustrates the three-dimensional environment 702 with reduced visual emphasis of the content item 704 relative to the rest of the three-dimensional environment 702, such as reduced intensity of the blurring and/or darkening lighting effect and the light spill effect. For example, in FIG. 7E, the amount of darkening and/or blurring applied to regions of the three-dimensional environment 702 other than the content item 704 is reduced and the sizes and/or intensities of the virtual lighting 710a, 710b, and 710d are reduced. In some embodiments, the electronic device 101 reduces the intensity of the virtual lighting effects in response to the input illustrated in FIG. 7D. In some embodiments, the electronic device 101 reduces the intensity of (or ceases display of) the virtual lighting effects in response to detecting the gaze 713f of the user directed away from the content item 704. In some embodiments, the electronic device reduces the intensity of (or ceases display of) the virtual lighting effect in response to detecting that the content item is paused. Also, FIG. 7E illustrates the electronic device 101 ceasing display of selectable options 712a-712L and user interface element 711 in response to no longer detecting a hand of the user in the ready state.

Additional or alternative details regarding the embodiments illustrated in FIGS. 7A-7E are provided below in description of method 800 described with reference to FIGS. 8A-8O.

FIGS. 8A-8O is a flowchart illustrating a method of generating virtual lighting effects while presenting a content item in accordance with some embodiments. In some embodiments, the method 800 is performed at a computer system (e.g., computer system 101 in FIG. 1) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, such as in FIG. 7A, method 800 is performed at an electronic device (e.g., 101) in communication with a display generation component (e.g., 120) and one or more input devices (e.g., 314) (e.g., a mobile device (e.g., a tablet, a smartphone, a media player, or a wearable device), or a computer). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, such as in FIG. 7B, while presenting a content item (e.g., 704) in a three-dimensional environment (e.g., 702), the electronic device (e.g., 101) displays (802a), via the display generation component (e.g., 120), a user interface (e.g., 711) associated with the content item, wherein the user interface (e.g., 711) includes one or more user interface elements (e.g., 712f) for modifying playback of the content item, and a respective user interface element (e.g., 712j) for modifying a virtual lighting effect that affects an appearance of the three-dimensional environment (e.g., 702). In some embodiments, the content item is video content and the one or more user interface elements for modifying playback of the content item include play/pause, skip ahead, skip back, subtitle, and audio options. In some embodiments, the one or more user interface elements include options for displaying the content item in a picture-in-picture user interface element according to one or more steps of method 1000 or displaying the content item in an immersive (e.g., full-screen) mode according to one or more steps of method 1400.

In some embodiments, the content item is an item of video content, such as a movie, episode in a series of episodic content, or video clip that is being played/displayed in the three-dimensional environment or the content item is an item of audio content, such as music, a podcast, or audiobook that is being played in the three-dimensional environment. In some embodiments, the three-dimensional environment includes virtual objects, such as application windows, operating system elements, representations of other users, and/or content items and representations of physical objects in the physical environment of the electronic device. In some embodiments, the representations of physical objects are displayed in the three-dimensional environment via the display generation component (e.g., virtual or video passthrough). In some embodiments, the representations of physical objects are views of the physical objects in the physical environment of the electronic device visible through a transparent portion of the display generation component (e.g., true or real passthrough). In some embodiments, the electronic device displays the three-dimensional environment from the viewpoint of the user at a location in the three-dimensional environment corresponding to the physical location of the electronic device in the physical environment of the electronic device. In some embodiments, the three-dimensional environment is generated, displayed, or otherwise caused to be viewable by the device (e.g., a computer-generated reality (XR) environment such as a virtual reality (VR) environment, a mixed reality (MR) environment, or an augmented reality (AR) environment, etc.).

In some embodiments, such as in FIG. 7D, while displaying the user interface (e.g., 711) associated with the content item (e.g., 704), the electronic device (e.g., 101) receives (802b), via the one or more input devices, a user input directed to the respective user interface element (e.g., 716), the user input corresponding to a request to modify the virtual lighting effect. In some embodiments, the input corresponds to a request to change the amount of the virtual lighting effect to a different (e.g., non-zero) amount. In some embodiments, the input corresponds to a request to display the three-dimensional environment without the virtual lighting effect. In some embodiments, the virtual lighting effect is based on the content item, such as a light spill effect onto virtual objects and/or representations of real objects in the three-dimensional environment that has colors, patterns, and/or motion that are based on image and/or video content of the content item. In some embodiments, the virtual lighting effect is independent from the content item, such as a degree of dimness and/or blurring applied to regions of the three-dimensional environment other than the content item or the user interface including one or more user interface elements for modifying playback of the content item (described below).

In some embodiments, such as in FIG. 7E, in response to receiving the user input (802c), the electronic device (e.g., 101) continues (802d) to present the content item (e.g., 704) in the three-dimensional environment (e.g., 702).

In some embodiments, such as in FIG. 7E, in response to receiving the user input (802c), the electronic device (e.g., 101) applies (802e) the virtual lighting effect to the three-dimensional environment (e.g., 702). For example, in response to a request to display the three-dimensional environment without a dimming virtual lighting effect, the electronic device displays the three-dimensional environment such that (e.g., all) regions of the three-dimensional environment have the same relative degree of dimness, including regions in which the content is presented and regions in which the content is not presented. As another example, in response to a request to display the three-dimensional environment with an increased amount of a light spill virtual lighting effect, the electronic device increases the size and/or brightness of the light spill (e.g., from the content item) on objects in the three-dimensional environment. In some embodiments, the virtual light spill changes over time in accordance with changes to the (e.g., visual content included in the) content item.

Modifying the amount of the virtual lighting effect with which the three-dimensional environment is displayed provides an efficient way of toggling between an immersive experience and a low-distraction virtual environment, thereby reducing cognitive burden on the user both when engaging with the content item and when engaging with other content or applications in the three-dimensional environment.

In some embodiments, before receiving the user input directed to the respective user interface (e.g., 711 in FIG. 7C), the electronic device (e.g., 101) displays, via the display generation component (e.g., 120), the three-dimensional environment (e.g., 702) without the virtual lighting effect (804a). In some embodiments, the virtual lighting effect includes one or more of displaying, in a region of the three-dimensional environment other than the content item, a virtual light spill effect emanating from the content item, dimming the region of the three-dimensional environment other than the content item with respect to the content item, and/or blurring the region of the three-dimensional environment other than the content item with respect to the content item. In some embodiments, displaying the three-dimensional environment without the virtual lighting effect includes forgoing display of the virtual light spill effect emanating from the content item, displaying the region of the three-dimensional environment other than the content item the same level of blur as the content item, and/or displaying the region of the three-dimensional environment other than the content item with the same level of dimness as the content item.

In some embodiments, in response to receiving the user input, the electronic device (e.g., 101) displays, via the display generation component (e.g., 120), the three-dimensional environment (e.g., 702) with the virtual lighting effect (804b), such as in FIG. 7A. In some embodiments, the virtual lighting effect includes one or more of displaying, in a region of the three-dimensional environment other than the content item, a virtual light spill effect emanating from the content item, dimming the region of the three-dimensional environment other than the content item with respect to the content item, and/or blurring the region of the three-dimensional environment other than the content item with respect to the content item. In some embodiments, in response to detecting a first input directed to the respective user interface element, the electronic device toggles display of the three-dimensional environment with or without the virtual lighting effect. For example, the first input is selection of the respective user interface element (e.g., a primary selection, such as a “click”). In some embodiments, the first input include detecting a predefined portion of the user in a predefined shape (e.g., the hand of the user in a pinch hand shape) for a period of time less than a respective threshold (e.g., 0.1, 0.2, 0.3, 0.5, 1, or 2 seconds) while the gaze of the user directed to the respective user interface element. In some embodiments, in response to a second input directed to the respective user interface element (e.g., a secondary selection, an input analogous to a “long click”), the electronic device updates the respective user interface element to a user interface element for adjusting the amount of the lighting effect applied to the three-dimensional environment, as will be described below. For example, detecting the second input includes detecting a predefined portion of the user (e.g., the user's hand) make a predefined gesture, such as a pinch hand gesture that includes touching the thumb to another finger for more than the threshold amount of time (e.g., 0.1, 0.2, 0.3, 0.5, 1, or 2 seconds) before moving the thumb away from the finger.

Turning the virtual lighting effect on in response to an input directed to the respective user interface element provides an efficient way of toggling the virtual lighting effect on and off, thereby reducing the cognitive burden on the user to switch between an immersive experience and a three-dimensional environment in which other user interface elements are clearly displayed.

In some embodiments, before receiving the user input directed to the respective user interface (e.g., 711), such as in FIG. 7iD, the electronic device (e.g., 101) displays, via the display generation component (e.g., 120), the three-dimensional environment (e.g., 702) with a first amount of the virtual lighting effect (806a). In some embodiments, displaying the three-dimensional environment with the first amount of the virtual lighting effect includes one or more of displaying, in a region of the three-dimensional environment other than the content item, a virtual light spill effect emanating from the content item with a first size, intensity, clarity, etc., dimming the region of the three-dimensional environment other than the content item with respect to the content item by a first amount, and/or blurring the region of the three-dimensional environment other than the content item with respect to the content item by a first amount. In some embodiments, the first amount of the virtual lighting effect is zero (e.g., the electronic device displays the three-dimensional environment without the virtual lighting effect).

In some embodiments, in response to receiving the user input, the electronic device (e.g., 101) displays, via the display generation component (e.g., 120), the three-dimensional environment (e.g., 702) with a second amount the virtual lighting effect, the second amount different from the first amount (806b), such as in FIG. 7E. In some embodiments, the electronic device modifies a plurality of virtual lighting effects (e.g., light spill, blurring, dimming) by the same amount in response to the input. For example, in response to an input to increase the virtual lighting effect by a respective amount, the electronic device increases the size, intensity, clarity, etc. of the light spill by the respective amount, increases the blurring by the respective amount, and increases the dimming by the respective amount. As another example, in response to an input to decrease the virtual lighting effect by a respective amount, the electronic device decreases the size, intensity, clarity, etc. of the light spill by the respective amount, decreases the blurring by the respective amount, and decreases the dimming by the respective amount. In some embodiments, the electronic device adjusts the amount of the virtual lighting effect in accordance with the determination that the input directed to the respective user interface element satisfies one or more respective criteria, such as a criterion that is satisfied when the electronic device detects a predefined portion of the user (e.g., the user's hand) in a predefined hand shape (e.g., a pinch hand shape) for more than a threshold period of time (e.g., 0.1, 0.2, 0.3, 0.5, 1, or 2 seconds). In some embodiments, in response to detecting the predefined pose for more than the threshold period of time, the electronic device presents an interactive slider that controls the amount of the virtual lighting effect with which the three-dimensional environment is displayed. For example, a continuation of the input directed to the respective user interface element including motion of the predefined portion of the user causes the electronic device to adjust the amount of the virtual lighting effect and the position of an indicator of the slider.

Adjusting the amount of the virtual lighting effect applied to the three-dimensional environment in response to the input directed to the respective user interface element provides an efficient way of selecting a tradeoff between immersion of the content item and clarity of elements in the three-dimensional environment other than the content item, which reduces the cognitive burden of the user when interacting with various elements in the three-dimensional environment.

In some embodiments, such as in FIG. 7C, before receiving the user input, a region of the three-dimensional environment (e.g., 702) that does not include the content item (e.g., 704) is displayed with a first level of brightness (808a). In some embodiments, the content item is displayed with a level of brightness that is greater than the first level of brightness (e.g., a dimming visual effect is active). In some embodiments, the content item is displayed with the same level of brightness as the region of the three-dimensional environment that does not include the content item (e.g., the dimming visual effect is not active). In some embodiments, the three-dimensional environment includes virtual objects and/or representations of real objects.

In some embodiments, such as in FIG. 7E, displaying the three-dimensional environment (e.g., 702) with the virtual lighting effect in response to the user input includes displaying the region of the three-dimensional environment (e.g., 702) that does not include the content item (e.g., 704) with a second level of brightness, different from (e.g., less than, greater than) the first level of brightness (808b). In some embodiments, the electronic device modifies the level of brightness of the region not including the content item without modifying the level of brightness of the content item. In some embodiments, in response to the input, the electronic device turns the dimming visual effect on or off. In some embodiments, in response to the input, the electronic device adjusts the amount of the dimming visual effect. In some embodiments, the entire three-dimensional environment is made up of the region that does not include the content item and the content item (e.g., the brightness of all of the three-dimensional environment other than the content item is adjusted). In some embodiments, the three-dimensional environment includes a third region that does not include the content item that is not affected by the adjustment of the amount of brightness. In some embodiments, the three-dimensional environment includes one or more virtual objects and/or regions outside of the content item and/or representations of real objects and/or regions outside of the content item that are dimmed when the three-dimensional environment is displayed with the virtual lighting effect.

Adjusting the level of brightness of the region of the three-dimensional environment that does not include the content item in response to the input directed to the respective user interface element provides an efficient way of making a tradeoff between an immersive experience with the content item and the ability to view and interact with elements in the three-dimensional environment other than the content item.

In some embodiments, such as in FIG. 7A, displaying the three-dimensional environment (e.g., 702) with the virtual lighting effect in response to the user input includes displaying a respective virtual lighting effect (e.g., 710a) (e.g., a virtual light spill) emanating from the content item (e.g., 704) on one or more objects (e.g., 708a) in the three-dimensional environment (e.g., 704) (810). In some embodiments, the respective virtual lighting effect changes over time based on the content. For example, the respective virtual lighting effect includes one or more colors, intensities, patterns, animations, etc. currently included in video and/or image content of the content item. In some embodiments, the respective virtual lighting effect is a virtual light spill that simulates reflection of light emanating from image and/or video content of the content item on one or more (e.g., real, virtual) surfaces and/or objects in the three-dimensional environment outside of the content item. In some embodiments, the one or more objects include virtual objects. In some embodiments, the one or more objects include representations of real objects in the physical environment of the electronic device and/or display generation component. In some embodiments, representations of real objects include one or more of true or real passthrough and/or video or virtual passthrough described in more detail above. In some embodiments, the virtual light spill is more intensely displayed (e.g., displayed with greater brightness, sharpness and/or size) at locations in the three-dimensional environment that are closer to the content item than at locations in the three-dimensional environment that are further from the content item.

In some embodiments, presenting a respective virtual lighting effect emanating from the content item on one or more objects in the three-dimensional environment provides an immersive experience with the content item, which reduces distractions and cognitive burden on the user while consuming the content item.

In some embodiments, such as in FIG. 7A, before receiving the user input directed to the respective user interface (e.g., 711), the electronic device (e.g., 101) displays, via the display generation component (e.g., 120), the three-dimensional environment (e.g., 702) with a first amount of the virtual lighting effect, including displaying a region of the three-dimensional environment (e.g., 702) that does not include the content item with a first level of brightness and displaying a first amount of a respective virtual lighting effect (e.g., 710a) (e.g., a virtual light spill) emanating from the content item (e.g., 704) on one or more objects (e.g., 708a) in the three-dimensional environment (812a). In some embodiments, the virtual lighting effect includes dimming the region of the three-dimensional environment other than the content item with respect to the content item and displaying a virtual light spill emanating from the content item on other objects in the three-dimensional environment. In some embodiments, the first amount of the virtual lighting effect is zero (e.g., the electronic device displays the three-dimensional environment without the virtual lighting effect)

In some embodiments, such as in FIG. 7E, in response to receiving the user input, the electronic device (e.g., 101) displays, via the display generation component (e.g., 120), the three-dimensional environment (e.g., 702) with a second amount of the virtual lighting effect, including displaying the region of the three-dimensional environment (e.g., 702) that does not include the content item (e.g., 704) with a second level of brightness and displaying a second amount of the respective virtual lighting effect (e.g., 710a) (e.g., the virtual light spill) emanating from the content item (e.g., 704) on the one or more objects in the three-dimensional environment (e.g., 702) (812b). In some embodiments, the respective user interface element controls both the level of dimness of the region of the three-dimensional environment other than the content item with respect to the content item and the level of (e.g., brightness, size, translucency, etc. of) the virtual light spill emanating from the content item on other objects in the three-dimensional environment. In some embodiments, in response to a first input directed to the respective user interface element, the electronic device toggles the dimming and light spill virtual lighting effects on or off. In some embodiments, in response to a second input directed to the respective user interface element, the electronic device adjusts the level of dimness and level(s) of (e.g., brightness, size, translucency, etc. of) the virtual light spill emanating from the content item on other objects outside of the content item in the three-dimensional environment.

Adjusting both the amount of dimness and the amount of the respective virtual lighting effect emanating from the content item in response to the input directed to the respective user interface element provides an efficient way of adjusting multiple characteristics of the virtual lighting of the three-dimensional environment with one input, thereby reducing the amount of time and number of inputs needed to make the adjustments.

In some embodiments, such as in FIG. 7A, displaying the three-dimensional environment (e.g., 702) with the virtual lighting effect in response to the user input includes (814a), in accordance with detecting, via the one or more input devices (e.g., 314), that an attention (e.g., gaze 713a) of a user of the electronic device (e.g., 101) is directed to a first region (e.g., including the content item 704) of the three-dimensional environment (e.g., 702) (e.g., detecting, via an eye tracking device, that a gaze of the user is directed to the first region), displaying, via the display generation component (e.g., 120), the three-dimensional environment (e.g., 702) with a first amount of the virtual lighting effect (815b). In some embodiments, in response to detecting that the attention (e.g., gaze) of the user is directed to the content item, the electronic device increases the amount of the virtual lighting effect with which the three-dimensional environment is displayed.

In some embodiments, such as in FIG. 7E, displaying the three-dimensional environment (e.g., 702) with the virtual lighting effect in response to the user input includes (814a), in accordance with detecting, via the one or more input devices (e.g., 314), that the attention (e.g., gaze 713f) of the user is directed to a second region (e.g., detecting, via an eye tracking device, that a gaze of the user is directed to the second region that does not include the content item), different from the first region, of the three-dimensional environment (e.g., 702), displaying, via the display generation component (e.g., 120), the three-dimensional environment with a second amount of the virtual lighting effect different from the first amount (814c). In some embodiments, in response to detecting that the attention (e.g., gaze) of the user is not directed to the content item, the electronic device decreases the amount of the virtual lighting effect with which the three-dimensional environment is displayed. In some embodiments, in response to detecting that the attention (e.g., gaze) of the user is not directed to the content item, the electronic device updates the three-dimensional environment to display the three-dimensional environment without the virtual lighting effect.

Adjusting the amount of the virtual lighting effect depending on the region of the three-dimensional environment to which the user directs their attention provides an efficient way of adjusting the level of immersion with the content item automatically based on the user's attention, which reduces the cognitive burden on the user and number of inputs when the user changes which region of the three-dimensional environment to which they direct their attention.

In some embodiments, while displaying the three-dimensional environment without the virtual lighting effect, the electronic device (e.g., 101) receives (816a), via the one or more input devices (e.g., 314), a first input directed to the respective user interface element (e.g., 712j in FIG. 7C) that includes detecting, via the one or more input devices (e.g., 314), a predefined portion (e.g., hand 703b) of a user of the electronic device in a predefined pose for less than a predetermined time threshold (e.g., 0.1, 0.2, 0.3, 0.5, 1, or 2 seconds). In some embodiments, the predefined pose of the predefined portion of the user is the hand of the user making a pinch shape in which the thumb touches another finger of the hand. In some embodiments, the predefined pose of the predefined portion of the user is the hand of the user making a pointing hand shape with one or more fingers extended and one or more fingers curled towards the palm while the hand is within a threshold distance (e.g., 1, 2, 3, 5, 10, 15, 30, or 50 centimeters) of a location in the three-dimensional environment corresponding to the respective user interface element. In some embodiments, detecting the first input further includes detecting, via the one or more input devices, that the attention of the user is directed to the respective user interface element. In some embodiments, detecting the first input further includes detecting, via an eye tracking device of the one or more input devices, that the gaze of the user is directed to the respective user interface element.

In some embodiments, in response to receiving the first input, the electronic device (e.g., 101) displays (816b), via the display generation component (e.g., 120), the three-dimensional environment (e.g., 702) with the virtual lighting effect, such as in FIG. 7A. In some embodiments, in response to detecting the first input while displaying the three-dimensional environment without the virtual lighting effect, the electronic device toggles the virtual lighting effect on.

In some embodiments, while displaying the three-dimensional environment with the virtual lighting effect, the electronic device (e.g., 101) receives (816c), via the one or more input devices (e.g., 314), a second input directed to the respective user interface element (e.g., 712j in FIG. 7C) that includes detecting, via the one or more input devices (e.g., 314), the predefined portion (e.g., hand 703b) of the user of the electronic device (e.g., 101) in the predefined pose for less than the predetermined time threshold (e.g., 0.1, 0.2, 0.3, 0.5, 1, or 2 seconds). In some embodiments, detecting the second input further includes detecting, via the one or more input devices, that the attention of the user is directed to the respective user interface element. In some embodiments, detecting the second input further includes detecting, via an eye tracking device of the one or more input devices, that the gaze of the user is directed to the respective user interface element.

In some embodiments, in response to receiving the second input, the electronic device (e.g., 101) displays (816d), via the display generation component (e.g., 120), the three-dimensional environment (e.g., 314) without the virtual lighting effect. In some embodiments, in response to detecting the second input while displaying the three-dimensional environment with the virtual lighting effect, the electronic device toggles the virtual lighting effect off.

Turning the virtual lighting effect on or off in response to detecting the predefined pose of the predefined portion of the user for less than the threshold amount of time provides an efficient way of switching between an immersive experience with the content item and viewing other parts of the three-dimensional environment with less distraction, thereby reducing cognitive burden on the user when interacting with the three-dimensional environment.

In some embodiments, such as in FIG. 7D, while displaying the three-dimensional environment (e.g., 702) with a first amount of the virtual lighting effect, the electronic device (e.g., 101) receives (818a), via the one or more input devices (e.g., 314), an input directed to the respective user interface element (e.g., 712j) that includes detecting, via the one or more input devices (e.g., 314), movement of a predefined portion (e.g., a hand 703a) of a user of the electronic device (e.g., 101) while the predefined portion of the user is in a predefined pose. In some embodiments, detecting the input further includes detecting that the attention (e.g., gaze) of the user is directed to the respective user interface element via the one or more input devices (e.g., an eye tracking device). In some embodiments, the predefined pose is the hand of the user in a pinch hand shape described above. In some embodiments, the predefined pose is the hand of the user in a pointing handing shape described above while the hand of the user is within a threshold distance (e.g., 5, 10, 15, 30, or 50 centimeters) of the location of the respective user interface element.

In some embodiments, in response to the input directed to the respective user interface element (e.g., 712j in FIG. 7D), the electronic device (e.g., 101) displays (818b), via the display generation component (e.g., 120), the three-dimensional environment (e.g., 702) with a second amount of the virtual lighting effect, such as in FIG. 7E, wherein the second amount is based on (e.g., speed, duration, distance, etc. of) the movement of the predefined portion (e.g., hand 703a in FIG. 7D) of the user while the predefined portion of the user is in the predefined pose. In some embodiments, in response to detecting movement of the predefined portion of the user in a first (e.g., downward, leftward) direction, the electronic device decreases the amount of the virtual lighting effect. In some embodiments, in response to detecting movement of the predefined portion of the user in a second (e.g., upward, rightward) direction, the electronic device increases the amount of the virtual lighting effect. In some embodiments, in response to movement having a first magnitude (e.g., of speed, duration, distance), the electronic device changes the amount of the virtual lighting effect by a first amount corresponding to the first magnitude. In some embodiments, in response to movement having a second magnitude (e.g., of speed, duration, distance), the electronic device changes the amount of the virtual lighting effect by a second amount corresponding to the first magnitude. For example, in response to a downward movement having a relatively small magnitude, the electronic device decreases the amount of the virtual lighting effect by a relatively small amount. As another example, in response to an upward movement having a relatively large magnitude, the electronic device increases the amount of the virtual lighting effect by a relatively large amount.

Adjusting the amount of the virtual lighting effect based on movement of the predefined portion of the user during an input directed to the respective user interface element provides an efficient way of the user making a tradeoff between an immersive experience with the content item and clarity of the rest of the three-dimensional environment, which reduces the cognitive burden on the user when interacting with elements in the three-dimensional environment.

In some embodiments, while the content item is playing (820a), the electronic device (e.g., 101) displays (820b), via the display generation component (e.g., 120), the three-dimensional environment (e.g., 702) with the virtual lighting effect, such as in FIG. 7A. In some embodiments, the virtual lighting effect includes one or more of blurring and/or dimming a region of the three-dimensional environment that does not include the content item and/or the virtual light spill emanating from the content item described above.

In some embodiments, while the content item is playing (820a), the electronic device (e.g., 101) receives (820c), via the one or more input devices, a user input corresponding to a request to pause the content item (e.g., 704) (e.g., such as selection of option 712g in FIG. 7B). For example, the input corresponding to the request to pause the content item is selection of a respective user interface element of the one or more user interface elements for modifying playback of the content item displayed in the user interface associated with the content item.

In some embodiments, in response to receiving the user input corresponding to the request to pause the content item (820d), the electronic device (e.g., 101) pauses (820e) the content item (e.g., 704 in FIG. 7A). In some embodiments, the electronic device continues to display the paused content item (e.g., displaying a frame of video content at the playback position at which the video content was paused).

In some embodiments, in response to receiving the user input corresponding to the request to pause the content item (e.g., 704 in FIG. 7A) (820d), the electronic device (e.g., 101) displays (820f), via the display generation component (e.g., 120), the three-dimensional environment (e.g., 702) without the virtual lighting effect (or with the lighting effect having a reduced magnitude). In some embodiments, while the content item is paused and the electronic device displays the three-dimensional environment without the virtual lighting effect, in response to receiving an input to play the content item, the electronic device resumes playback of the content item and displays the three-dimensional environment with the virtual lighting effect. In some embodiments, in response to the input to pause the content item, the electronic device reduces the amount of the virtual lighting effect with which the three-dimensional environment is displayed without ceasing display of the virtual lighting effect. Ceasing display of the virtual lighting effect in response to the input to pause the content item provides an efficient way of improving legibility of elements in the three-dimensional environment other than the content item while the content item is paused, thereby reducing the number of inputs needed to switch between engaging with the content item and engaging with other elements in the three-dimensional environment.

In some embodiments, such as in FIG. 7C, the electronic device (e.g., 101) receives (822a), via the one or more input devices (e.g., 314), a respective user input directed to a second respective interface element of the one or more user interface elements (e.g., 712f) for modifying playback of the content item (e.g., 704).

In some embodiments, in response to receiving the respective user input (822b), in accordance with a determination that the second respective user interface element is a user interface element (e.g., 712g in FIG. 7B) that, when selected, causes the electronic device (e.g., 101) to toggle between playing and pausing the content item (e.g., 704), the electronic device (e.g., 101) toggles (822c) a play or pause state of the content item (e.g., 704). In some embodiments, the electronic device selects a user interface element in response to detecting, via the one or more input devices (e.g., an eye tracking device) that the attention (e.g., gaze) of the user is directed to the user interface element while detecting, via the one or more input devices (e.g., a hand tracking device), that a predefined portion (e.g., hand) of the user is in a predefined pose. For example, detecting the predefined portion of the user in the predefined pose includes detecting the hand of the user in a pinch hand shape as described above. In some embodiments, in response to detecting the input directed to the user interface element that causes the electronic device to toggle the play or pause state while the content item is playing, the electronic device pauses the content. In some embodiments, in response to detecting the input directed to the user interface element that causes the electronic device to toggle the play or pause state while the content item is paused, the electronic device plays the content.

In some embodiments, in response to receiving the respective user input (822b), in accordance with a determination that the second respective user interface element is a user interface element (e.g., 712f, 712h in FIG. 7B) that, when selected, causes the electronic device (e.g., 101) to update a playback position of the content item (e.g., 704) (e.g., an option to skip ahead or an option to skip back), the electronic device (e.g., 101) updates (822d) the playback position of the content item (e.g., 704) in accordance with the respective user input. In some embodiments, selection of the respective user interface element causes the electronic device to change the playback position of the content item at a rate that is different than the rate at which the playback position of the content item changes while playing the content item. In some embodiments, the respective user interface element for modifying the virtual lighting effect is displayed in the user interface associated with the content item that includes the first user interface element and the second user interface element. In some embodiments, the user interface further includes selectable options for accessing audio and subtitle settings of the content item, toggling a picture-in-picture element according to one or more steps of method 1000, toggling an immersive content mode according to one or more steps of method 1400, and viewing a content item playback queue of the electronic device.

Displaying the respective user interface element in the user interface with the user interface element for toggling the play or pause state and the user interface element for updating the playback position of the content item provides an efficient way of facilitating modification of playback of the content item and modification of the three-dimensional environment, which reduces cognitive burden on the user when interacting with the content item and the three-dimensional environment.

In some embodiments, the electronic device (e.g., 101) receives (824a), via the one or more input devices (e.g., 314), a respective user input directed to a second respective interface element (e.g., 712k in FIG. 7B) of the one or more user interface elements for modifying playback of the content item.

In some embodiments, in response to receiving the respective user input, in accordance with a determination that the second respective user interface element is a user interface element (e.g., 712k in FIG. 7B) that, when selected, causes the electronic device (e.g., 101) to modify a volume of audio content of the content item (e.g., 704), the electronic device (e.g., 101) modifies (824b) the volume of the audio content in accordance with the respective input. In some embodiments, in response to receiving a first input directed to the user interface element for modifying the volume of the audio content of the content item, the electronic device updates the user interface element to include a slider user interface element that, when a position of an indicator of the slider is changed, causes the electronic device to change the volume of the audio content in accordance with the updated position of the indicator. In some embodiments, the user interface element for modifying the volume of the audio content is displayed in the user interface associated with the content item with the respective user interface element for modifying the virtual lighting effect.

Displaying the respective user interface element in the user interface with the user interface element for modifying the volume of the audio content provides an efficient way of facilitating modification of playback of the content item and modification of the three-dimensional environment, which reduces cognitive burden on the user when interacting with the content item and the three-dimensional environment.

In some embodiments, such as in FIG. 7B, the user interface (e.g., 711) associated with the content item (e.g., 704) is a separate user interface from the content item (e.g., 704) and is displayed, via the display generation component (e.g., 120), between the content item (e.g., 704) and a viewpoint of a user of the electronic device (e.g., 101) in the three-dimensional environment (e.g., 702) (826). In some embodiments, the content item and the user interface are displayed in separate windows in the three-dimensional environment. In some embodiments, the user interface associated with the content item is partially overlaid on the content item. In some embodiments, the user interface associated with the content item is not overlaid on the content item.

Displaying the user interface associated with the content item separately from the content item and between the viewpoint of the user and the content item in the three-dimensional environment provides an efficient way of facilitating user interaction with the user interface, which reduces the cognitive burden and time needed to modify playback of the content item via interaction with the user interface.

In some embodiments, the content item (e.g., 704 in FIG. 7B) is displayed, via the display generation component (e.g., 120), at a first angle relative to a viewpoint of the user in the three-dimensional environment (828a). In some embodiments, the first angle includes a lateral angle in the three-dimensional environment (e.g., tilt towards the user's left or right). In some embodiments, the first angle includes a vertical angle in the three-dimensional environment (e.g., tilt up or down from the viewpoint of the user).

In some embodiments, the user interface (e.g., 711 in FIG. 7B) associated with the content item (e.g., 704) is displayed, via the display generation component (e.g., 120), at a second angle, different from the first angle, relative to the viewpoint of the user in the three-dimensional environment (e.g., 702) (828b). In some embodiments, the second angle includes a lateral angle in the three-dimensional environment (e.g., tilt towards the user's left or right). In some embodiments, the second angle includes a vertical angle in the three-dimensional environment (e.g., tilt up or down from the viewpoint of the user). For example, the user interface associated with the content item is displayed at a location in the three-dimensional environment below the content item and at an angle that is more upward relative to the viewpoint of the user than the angle with which the content item is displayed relative to the user.

Displaying the content item and user interface associated with the content item with different angles relative to the viewpoint of the user in the three-dimensional environment provides an efficient way of legibly presenting the content item and the user interface associated with the content item when the content item and user interface associated with the content item are at different positions in the three-dimensional environment, which reduces time and effort needed to interact with the content item and the user interface associated with the content item.

In some embodiments, such as in FIG. 7B, the electronic device (e.g., 101) displays the one or more user interface elements (e.g., 712f, 712g) for modifying playback of the content item (e.g., 704) in response to detecting, via the one or more input devices (e.g., 314) (e.g., a hand tracking device), a predefined portion of a user (e.g., hand 703b) of the electronic device in a pose that satisfies one or more criteria (830). In some embodiments, detecting the pose of the predefined portion of the user that satisfies the one or more criteria includes detecting movement of a hand of the user from a location proximate to the user's body to a raised position (e.g., within a predefined region of the three-dimensional environment). In some embodiments, detecting the pose of the predefined portion of the user that satisfies one or more criteria includes detecting the hand of the user in a predefined hand shape, such as a pointing hand shape described above or a pre-pinch hand shape in which the thumb of the hand is within a threshold distance (e.g., 0.1, 0.2, 0.3, 0.5, 1, 2, or 3 centimeters) but not touching another finger of the hand. In some embodiments, the one or more criteria include a criterion that is satisfied when the electronic device detects, via the one or more input devices (e.g., an eye tracking device) that the attention (e.g., gaze) of the user is directed to the content item. In some embodiments, while the electronic device does not detect the predefined portion of the user in the pose that satisfies the one or more criteria, the electronic device forgoes display of the one or more user interface elements for modifying playback of the content item. In some embodiments, the electronic device continues to present (and play) the content item.

Displaying the one or more user interface elements for modifying playback of the content item in response to detecting the predefined portion of the user in the pose that satisfies the one or more criteria provides an efficient way of selectively facilitating interaction with the one or more user interface elements, which reduces the time and inputs needed to modify playback of the content item.

In some embodiments, while displaying the one or more user interface elements (e.g., 712f, 712g in FIG. 7B) for modifying playback of the content item (e.g., 704) (e.g., in response to detecting the predefined portion of the user in the pose that satisfies the one or more criteria), the electronic device (e.g., 101) detects (832a), via the one or more input devices (e.g., 314) (e.g., hand tracking device), the predefined portion (e.g., hand 703a) of the user in a pose that does not satisfy the one or more criteria, such as in FIG. 7A. In some embodiments, the one or more input devices (e.g., hand tracking device, eye tracking device) detects that one or more of the criteria described above are not satisfied. In some embodiments, the one or more input devices (e.g., hand tracking device) do not detect the predefined portion (e.g., hand) of the user (e.g., because the predefined portion of the user is out of range of the one or more input devices (e.g., hand tracking device)). In some embodiments, the electronic device detects the predefined portion of the user in a pose (e.g., a shape and/or position) that does not satisfy the one or more criteria. For example, the electronic device detects the user drop their hand to their lap or side.

In some embodiments, in response to detecting the predefined portion of the user (e.g., 703a) in the pose that does not satisfy the one or more criteria, such as in FIG. 7A, the electronic device (e.g., 101) reduces (832b) a visual prominence with which the electronic device (e.g., 101) displays, via the display generation component (e.g., 120), of the one or more user interface elements (e.g., 712f in FIG. 7B) for modifying playback of the content item. In some embodiments, the electronic device reduces the opacity of the one or more user interface elements for modifying playback of the content item. In some embodiments, the electronic device ceases display of the one or more user interface elements for modifying playback of the content item. In some embodiments, the electronic device continues to present (and play) the content item.

Ceasing display of the one or more user interface elements for modifying playback of the content item in response to detecting the predefined portion of the user in the pose that does not satisfy the one or more criteria provides an efficient way of reducing distraction while the user is consuming the content item without indicating an intention to interact with the one or more interactive elements, which reduces the cognitive burden on the user while consuming the content item.

In some embodiments, such as in FIG. 7B, while displaying, via the display generation component (e.g., 120), the content item (e.g., 704) at a first size and the user interface (e.g., 711) associated with the content item (e.g., 704) at a second size, the electronic device (e.g., 101) receives (834a), via the one or more input devices (e.g., 314), an input corresponding to a request to resize the content item (e.g., 704). In some embodiments, the input corresponding to the request to resize the content item is a request to change the virtual size of the content item in the three-dimensional environment with or without changing a position of the content item in the three-dimensional environment. In some embodiments, the input corresponding to the request to resize the content item is a request to change an angular size (e.g., a portion of the display generation component occupied by the content item) with or without changing the position and/or virtual size of the content item in the three-dimensional environment.

In some embodiments, such as in FIG. 7C, in response to receiving the input corresponding to the request to resize the content item (e.g., 704) (834b), the electronic device (e.g., 101) displays (834c), via the display generation component (e.g., 120), the content item (e.g., 704) at a third size, different from the first size, in accordance with the input corresponding to the request to resize the content item (e.g., 704). In some embodiments, the electronic device changes the size of the content item in a direction corresponding to a direction of movement of a predefined portion (e.g., hand) of the user by an amount corresponding to a magnitude of (e.g., speed, duration, distance, etc. of) the movement of the predefined portion of the user.

In some embodiments, such as in FIG. 7C, in response to receiving the input corresponding to the request to resize the content item (834b), the electronic device (e.g., 101) displays (834d), via the display generation component (e.g., 120), the user interface (e.g., 711) associated with the content item (e.g., 704) at the second size. In some embodiments, the (e.g., angular) size of the user interface associated with the content item remains constant even if the content item is resized. In some embodiments, if the input is a request to change the size of the content item without changing the position of the content item, the electronic device maintains the angular size and virtual size of the user interface associated with the content item and maintains the position of the user interface in the three-dimensional environment, too. In some embodiments, if the input is a request to change the size and position of the content item in the three-dimensional environment, the electronic device maintains the angular size of the user interface and updates the virtual size of the user interface in accordance with the updated position of the user interface to maintain the angular size of the user interface in the three-dimensional environment.

Maintaining the size of the user interface associated with the content item when updating the size of the content item provides an efficient way of maintaining legibility of the user interface in the three-dimensional environment, which reduces the cognitive burden on the user when interacting with the user interface.

In some embodiments, such as in FIG. 7C, while displaying, via the display generation component (e.g., 120), the content item (e.g., 704) at a first (e.g., angular) size and first distance from a viewpoint of the user in the three-dimensional environment (e.g., 702) and the user interface (e.g., 711) associated with the content item (e.g., 704) at a second (e.g., angular) size and second distance from the viewpoint of the user in the three-dimensional environment (e.g., 702), the electronic device (e.g., 101) receives (836a), via the one or more input devices (e.g., 314), an input corresponding to a request to reposition the content item (e.g., 704) (e.g., and the user interface) in the three-dimensional environment (e.g., 702). In some embodiments, the electronic device repositions the content item and user interface in accordance with movement of a predefined portion (e.g., hand) of the user while the user is providing the input. For example, the electronic device moves the content item and user interface in a direction and by an amount corresponding to the direction and amount of (e.g., speed, distance, duration, etc. of) the movement of the predefined portion (e.g., hand) of the user while providing the input. In some embodiments, detecting the input includes detecting the gaze of the user directed to the content item or a user interface element for repositioning the content item while detecting the hand of the user in a predefined hand shape such as a pinch hand shape or pointing hand shape.

In some embodiments, such as in FIG. 7D, in response to receiving the input corresponding to the request to reposition the content item (836b), the electronic device (e.g., 101) displays (836c), via the display generation component (e.g., 120), the content item (e.g., 704) at a third (e.g., angular) size at a third distance, different from the first distance, from the viewpoint of the user in the three-dimensional environment (e.g., 702) in accordance with the input corresponding to the request to reposition the content item (e.g., 704). In some embodiments, the electronic device maintains the virtual size of the content item in response to the request to move the content item in the three-dimensional environment, which causes the electronic device to update the angular size (e.g., the portion of the display generation component occupied by the content item) of the content item in accordance with a change in the distance between the content item and the viewpoint of the user. For example, in response to a request to move the content item further away from the user, the electronic device displays the content item at a smaller angular size and in response to a request to move the content item closer to the user, the electronic device displays the content item at a larger angular size. In some embodiments, the electronic device updates the virtual size of the content item by a proportion that is less than the change in the angular size of the content item (e.g., to maintain display of the content item within maximum and minimum sizes if updating the angular size of the content item without changing the virtual size of the content item would cause the angular size of the content item to be outside of the maximum or minimum angular size).

In some embodiments, such as in FIG. 7D, in response to receiving the input corresponding to the request to reposition the content item (e.g., 704) (836b), the electronic device (e.g., 101) displays (836d), via the display generation component (e.g., 120), the user interface (e.g., 711) associated with the content item (e.g., 704) at the second (e.g., angular) size at a fourth distance from the viewpoint of the user in accordance with the input corresponding to the request to reposition the content item (e.g., 704). In some embodiments, the electronic device updates the virtual size of the user interface in accordance with updating the distance between the user interface and the viewpoint of the user in the three-dimensional environment while maintaining the angular size of the user interface.

Maintaining the size of the user interface associated with the content item provides an efficient way of maintaining legibility of the user interface in the three-dimensional environment, which reduces the cognitive burden on the user when interacting with the user interface.

In some embodiments, such as in FIG. 7B, the content item (e.g., 704) is separate from the user interface (e.g., 711) associated with the content item (e.g., 704) in the three-dimensional environment (e.g., 702) (838a). In some embodiments, the content item and user interface are displayed in separate containers (e.g., platters, user interface elements, windows, etc.) at distinct locations in the three-dimensional environment.

In some embodiments, such as in FIG. 7B, the electronic device (e.g., 101) displays (838b), via the display generation component (e.g., 120), one or more second user interface elements (e.g., 712a) for modifying playback of the content item (e.g., 704), the one or more second user interface elements (e.g., 712a) displayed overlaid on the content item (e.g., 704) in the three-dimensional environment (e.g., 702). In some embodiments, the one or more second user interface elements are displayed within the container including the content item. In some embodiments, the one or more second user interface elements visually (e.g., from the viewpoint of the user) or spatially overlap the content item in the three-dimensional environment. For example, the electronic device displays, via the display generation component, a user interface element that, when selected, causes the electronic device to cease display of the content item overlaid on the content item in the container of the content item and displays one or more other user interface elements (e.g., for modifying playback of the content item) in the user interface in a container separate from the content item.

Displaying the one or more second user interface elements overlaid on the content item in the three-dimensional environment provides an efficient way of interacting with the one or more second user interface elements while viewing the content item, thereby reducing the cognitive burden on the user.

In some embodiments, such as in FIG. 7C, the electronic device (e.g., 101) detects (840a), via the one or more input devices (e.g., 314) (e.g., eye tracking device), that an attention (e.g., gaze 713c, 713d) of the user directed to a respective user interface element (e.g., 712f, 712j) of the one or more user interface elements satisfies one or more first criteria. In some embodiments, the one or more first criteria include a criterion that is satisfied when the attention (e.g., gaze) of the user is directed to the respective user interface element for at least a threshold period of time (e.g., 0.1, 0.2, 0.3, 0.4, 0.5, 1, 2, or 3 seconds). In some embodiments, the one or more criteria are satisfied the instant the attention (e.g., gaze) of the user is directed to the respective user interface element.

In some embodiments, such as in FIG. 7C, in response to detecting that the attention (e.g., gaze 713d) of the user directed to the respective user interface element (e.g., 712j) satisfies the one or more first criteria (840b), in accordance with a determination that the respective user interface element (e.g., 712j) satisfies one or more second criteria, the electronic device (e.g., 101) displays (840c), via the display generation component (e.g., 120), a visual indication (e.g., 714) identifying a functionality of the respective user interface element (e.g., 712j). In some embodiments, the respective user interface element satisfies the one or more second criteria when the respective user interface element is included in a predetermined subset of the one or more user interface elements included in the user interface associated with the content item. For example, one or more of an immersive content option according to one or more steps of method 1400, a picture-in-picture option according to one or more steps of method 1000, and the respective user interface element for modifying the virtual lighting effect are included in the predetermined subset. In some embodiments, the respective user interface element satisfies the one or more second criteria when the respective user interface element is associated with a function related to presentation of content items in a three-dimensional environment (e.g., and may not be commonly associated with presentation of content items in another environment). In some embodiments, the visual indication identifying the functionality of the respective user interface element includes text that describes the functionality of the respective user interface element. For example, the visual indication identifying the functionality of the respective option for modifying the virtual lighting effect includes text that says “lighting effect,” or something similar. In some embodiments, the electronic device ceases display of the visual indication in response to detecting the attention of the user directed away from the respective user interface element. In some embodiments, the electronic device displays the visual indication in accordance with detecting, via the one or more input devices, a ready state of the user while the gaze of the user is directed to the respective user interface element.

In some embodiments, such as in FIG. 7C, in response to detecting that the attention (e.g., gaze 713c) of the user directed to the respective user interface element (e.g., 712f) satisfies the one or more first criteria (840b), in accordance with a determination that the respective user interface element (e.g., 712f) does not satisfy the one or more second criteria, the electronic device (e.g., 101) forgoes (840d) display of the visual indication identifying the functionality of the respective user interface element (e.g., 712f). In some embodiments, the respective user interface element does not satisfy the one or more second criteria when the respective user interface element is not included in a predetermined subset of the one or more user interface elements included in the user interface associated with the content item. For example, one or more of a playback queue option, an option to skip back or a head in the playback position of the content item, and option to play/pause the content item, an option to view subtitles options for the content item, and an option to view audio options for the content item are not included in the predetermined subset of the one or more user interface elements. In some embodiments, the respective user interface element does not satisfy the one or more second criteria when the respective user interface element is associated with a function related to presentation of content items general (e.g., and may not be especially associated with presentation of content items in a three-dimensional environment).

Displaying the visual indication identifying the functionality of the respective user interface element that satisfies the one or more second criteria provides an efficient way of indicating to the user the operation that will be performed in response to further input directed to the respective user interface element, which reduces user error and the number of inputs needed to correct user errors.

In some embodiments, such as in FIG. 7B, the electronic device (e.g., 101) displays (842a), via the display generation component (e.g., 120), a respective user interface element (e.g., 712b) displayed separately from the content item (e.g., 704) and the user interface (e.g., 711) associated with the content item (e.g., 711). In some embodiments, the content item and user interface are displayed in separate containers (e.g., platters, user interface elements, windows, etc.) at distinct locations in the three-dimensional environment and the respective user interface element is displayed outside of these containers at a location in the three-dimensional environment distinct from the locations of the content item and user interface. In some embodiments, the electronic device displays the respective user interface element concurrently with one or more selectable elements for modifying playback of the content item in response to detecting a predefined portion of the user in a pose that satisfies one or more criteria optionally while detecting the gaze of the user directed to the content item. For example, in response to detecting the predefined portion of the user in the pose that satisfies one or more criteria optionally while detecting the gaze of the user directed to the content item, the electronic device displays the respective user interface element and the plurality of selectable elements for modifying playback of the content item.

In some embodiments, such as in FIG. 7B, while displaying the respective user interface element (e.g., 712b), the electronic device (e.g., 101) receives (842b), via the one or more input devices (e.g., 314), an input directed to the respective user interface element (e.g., 712b).

In some embodiments, such as in FIG. 7B, in response to detecting the input directed to the respective user interface element (e.g., 712b), the electronic device (e.g., 101) initiates (842c) a process to resize the content item (e.g., 704) in the three-dimensional environment (e.g., 702) in accordance with the input directed to the respective user interface element (e.g., 712b). In some embodiments, in response to detecting selection of the respective user interface element, the electronic device initiates a process to resize the respective user interface element in accordance with movement of a predefined portion (e.g., hand) of the user after the selection of the respective user interface element. In some embodiments, in response to detecting the movement of the predefined portion (e.g., hand) of the user after the selection of the respective user interface element, the electronic device resizes the content item in accordance with the movement of the predefined portion (e.g., hand) of the user without resizing the respective user interface element including the one or more selectable elements for modifying playback of the content item, as described above.

Displaying the respective user interface element for resizing the content item separately from the content item and the user interface associated with the content item provides an efficient way of viewing the size of the content item while providing input to resize the content item, thereby improving the ergonomics of the resizing input and reducing the time and number of inputs needed to resize the content item to the desired size.

FIGS. 9A-9E illustrate exemplary ways of displaying media content in a three-dimensional environment.

FIG. 9A illustrates a three-dimensional environment 904 that is being displayed by a display generation component 120 of electronic device 101 and an overhead view 920 of the three-dimensional environment 904. As described above with reference to FIGS. 1-6, the electronic device 101 optionally includes a display generation component (e.g., a touch screen 120) and a plurality of image sensors (e.g., image sensors 314 of FIG. 3). The image sensors optionally include one or more of a visible light camera, an infrared camera, a depth sensor, or any other sensor the electronic device 101 would be able to be used to capture one or more images of a user or a part of the user while the user interacts with the electronic device 101. In some embodiments, the user interfaces shown below could also be implemented on a head-mounted display that includes a display generation component that displays the user interface to the user and sensors to detect the physical environment, movements of the user's hands (e.g., external sensors facing outwards from the user), and/or gaze of the user (e.g., internal sensors facing inwards towards the face of the user).

In FIG. 9A, the electronic device 101 is displaying a three-dimensional environment 904 that includes a user interface 906 of Application 1, a user interface 910 of Application 2, a user interface 912 of Application 3, and a representation 918 of a table, which is a physical table in the physical environment of device 101. In some embodiments, as will be described in more detail below, Applications 1-3 are optionally media applications, gaming applications, social applications, navigation applications, streaming applications, or the like. In some embodiments, the representation 918 and the user interfaces 906, 910, and 912 are being displayed by the electronic device 101 because these objects are in a field of view from the user's 922 current viewpoint of the three-dimensional environment 904. For example, as shown in overhead view 920 in FIG. 9A, the user's 922 current viewpoint of the three-dimensional environment 904 corresponds to a position in the center of the three-dimensional environment 904 and is oriented towards the top/back portions of the three-dimensional environment 904. For ease of description in the remaining parts of the disclosure, the position/pose of the user 922 in the three-dimensional environment 904 will be referred to herein as the user's 922 current viewpoint of the three-dimensional environment 904 or, more simply, the user's 922 viewpoint indicated in overhead view 920.

Accordingly, as shown in FIG. 9A, the electronic device 101 is displaying, via the display generation component 120, the representation 918 and the user interfaces 906, 910, and 912 because these objects are in the field of view from the user's 922 current viewpoint of the three-dimensional environment 904 (as indicated in overhead view 920). Conversely, the electronic device 101 is not displaying, via the display generation component 120, the representation 924 of a sofa, the representation 930 of a corner table, the representation 932 of a coffee table, and the user interfaces 926 and 928 because these objects are not in the field of view from the user's 922 current viewpoint of the three-dimensional environment 904, as indicated in overhead view 920.

In some embodiments, the user's 922 viewpoint of the three-dimensional environment 904 corresponds to the physical location of the user 922 in a physical environment 902 of the electronic device 101 (e.g., operating environment 100). For example, the user's 922 viewpoint is optionally the viewpoint illustrated in overhead view 920 because the user 922 is currently oriented towards a back wall in the physical environment 902 and is located in the center of physical environment 902 while holding the electronic device 101 (e.g., or wearing device 101 if device 101 were a head-mounted device).

As shown in FIG. 9A, the electronic device 101 is currently playing TV Show A at the user interface 906. In some embodiments, the TV Show A is being played at the user interface 906 in response to the electronic device detecting a request to start playback of TV Show A. In some embodiments, as will be described in more detail below, the electronic device 101 can present TV Show A in different presentation modes, including a picture-in-picture presentation mode and/or an expanded presentation mode (e.g., different from the picture-in-picture presentation mode). In the example of FIG. 9A, the electronic device 101 is currently presenting TV Show A in the expanded presentation mode at user interface 906. It should be understood that user interface 906 could also be displayed at other locations relative to the user's viewpoint of the three-dimensional environment 904 while TV Show A is being presented in the expanded presentation mode, such as other locations in the three-dimensional environment 904 that are in the field of view from the user's current viewpoint of the three-dimensional environment 904.

In FIG. 9B, while the electronic device 101 is playing TV Show A in the expanded presentation mode, the electronic device 101 has detected that the user's 922 viewpoint of the three-dimensional environment 904 has moved from the viewpoint indicated in FIG. 9A to the viewpoint indicated in FIG. 9B. In some embodiments, the user's viewpoint of the three-dimensional environment 904 moved to the viewpoint indicated in FIG. 9B because user 922 moved to a corresponding pose and/or position in the physical environment 902. As shown in FIG. 9B, in response to the electronic device 101 detecting movement of the user's 922 viewpoint in the three-dimensional environment 904, the electronic device 101 displays the three-dimensional environment 904 from the user's new viewpoint of the three-dimensional environment 904 indicated in overhead view 920 in FIG. 9B.

In particular, as a result of the movement of the user's 922 viewpoint from the viewpoint indicated in FIG. 9A to the viewpoint indicated in FIG. 9B, the electronic device 101 is no longer presenting the user interface 912 of Application 3—as previously shown in FIG. 9A—because user interface 912 is no longer in the field of view from the user's current viewpoint of the three-dimensional environment 904 (as indicated in overhead view 920 in FIG. 9B). Additionally, as a result of the movement of the user's 922 viewpoint, the electronic device 101 displays the representation 918 of a table, the user interface 910, and user interface 906 at locations in the three-dimensional environment that are further to the left of the user's field of view when compared to FIG. 9A because the user's 922 viewpoint of the three-dimensional environment 904 moved to the right from user's 922 viewpoint illustrated in FIG. 9A.

In some embodiments, if media content is being presented in an expanded presentation mode, the location of the user interface presenting the media content does not change in the three-dimensional environment 904 as the user's viewpoint of the three-dimensional environment 904 moves. For example, when the user's 922 viewpoint of the three-dimensional 904 moved from the viewpoint illustrated in FIG. 9A to the viewpoint illustrated in FIG. 9B, the location of the user interface 906 in the three-dimensional environment 904 did not change (as indicated in overhead view 920 in FIGS. 9A and 9B) because user interface 906 was presenting TV Show A in the expanded presentation mode.

In FIG. 9B, the electronic device 101 is also presenting a playback controls user interface 908. In some embodiments, the electronic device 101 displays the playback controls user interface 908 in response to the electronic device 101 detecting that the hand 916 of the user 922 is in a “pointing” pose (e.g., one or more fingers of hand 916 are extended and one or more fingers of hand 916 are curled towards the palm of hand 916) or in “pre-pinch” pose (e.g., the thumb of hand 916 is within a threshold distance (e.g., 0.1, 0.2, 0.3, 0.5, 1, 2, 3, or 5, centimeters) of, but not touching, another finger of the hand 1331) while the gaze of the user was optionally directed towards media user interface 906. In some embodiments, the user interface elements 908a-908j being displayed at playback controls user interface 908 are similar to the selectable user interface options 712c-L described previously in the FIG. 7 series.

Additionally, in FIG. 9B, while the electronic device 101 is playing TV Show A in the expanded presentation mode, the electronic device 101 detects a request to start playing TV Show A in the picture-in-picture presentation mode. In some embodiments, the electronic device 101 detected the request to start playing TV Show A in the picture-in-picture presentation mode because the user's hand 916 was in the “pointing” pose or in a “pinching” pose (e.g., the thumb and index finger of hand 916 converge at or within a threshold distance (e.g., 0.2, 0.5, 1, 1.5, 2, or 2.5 centimeters) of each other) while the gaze 914 of the user 922 was directed towards user interface element 908b.

In FIG. 9C, in response to detecting the request to start presenting TV Show A in a picture-in-picture presentation mode in FIG. 9B, the electronic device 101 ceases playback of TV Show A in user interface 906 and starts presenting TV Show A in picture-in-picture user interface 934. In some embodiments, as the playback of TV Show A is transitioning from the media user interface 906 to the picture-in-picture user interface 934, the electronic device 101 displays an animation of the picture-in-picture user interface fading-in with the playback of TV Show A fading out at the user interface 906.

As shown in overhead view 920, the picture-in-picture user interface 934 is being displayed at a location in the three-dimensional environment that is at a position in three-dimensional environment 904 that is in front of and to the right of the user's current viewpoint of the three-dimensional environment 904. In some embodiments, the electronic device 101 is displaying the picture-in-picture user interface 934 at the location indicated in overhead view 920 because that location in the three-dimensional environment 904 is within a threshold distance (e.g., 0.1, 0.2, 0.5, 1, 1.5, or 3 feet) from the user's current viewpoint of the three-dimensional environment 904 and/or occupies at a predetermined portion (e.g., bottom right, bottom left, top right, top left) in the field of view from the user's 922 viewpoint of the three-dimensional environment 904. Thus, in some embodiments, user interface 934 is displayed at a location in three-dimensional environment 904 that is based on the viewpoint of user 922, whereas user interface 906 is displayed at a location in three-dimensional environment 904 that is not based on the viewpoint of user 922.

In some embodiments, while the electronic device 101 is presenting media content in a picture-in-picture presentation mode, the electronic device optionally displays one or more representations of media items that are selectable for playback. For example, in FIG. 9C, in response to the electronic device 101 receiving the request to transition presentation of TV Show A from the expanded presentation mode to the picture-in-picture presentation mode in FIG. 9B, the electronic device 101 updates the user interface 906—the user interface that was previously presenting TV Show A during the expanded presentation mode—to include a plurality of representations 940-958 of respective media content. The plurality of representations 940-958 are optionally selectable such that when the electronic device 101 detects a selection of one of the representations 940-958, the media item corresponding to the selected representations starts playing in user interface 906 (optionally without ceasing playback of TV Show A at media user interface 934) and/or in picture-in-picture user interface 934.

In some embodiments, the plurality of representations 940-958 of respective media content are displayed in one or more groups (e.g., columns) in the user interface 906. For example, in FIG. 9C, the representations 940-946 are being displayed in a first column in the user interface 906 because the corresponding media items were selected for display based on the user's 922 content consumption history. Similarly, the representations 948-958 are being displayed in a second column in the user interface 906 because the corresponding media items correspond to content items that are popular/currently trending (e.g., a larger number of users have recently watched the media content corresponding to the representations 948-958 such as over the last hour, day, week, month, etc.).

In some embodiments, the electronic device 101 updates the type/categories of media content that is displayed in user interface 906. For example, in FIG. 9C, the electronic device 101 is displaying user interface 936 (which is also optionally displayed in response to the electronic device 101 receiving the request to start presenting TV Show A in the picture-in-picture presented mode, as previously described). The user interface element 936 includes a selectable option 936a that, when selected, causes the electronic device 101 to display, in user interface 906, representations of media content that is currently trending and/or being recommended based on user's 922 content consumption history (as illustrated in user interface 906 in FIG. 9C), a selectable option 936b that, when selected, causes the electronic device 101 to display, in user interface 906, one or more representations of media content corresponding to one or more TV Shows, a selectable option 936c that, when selected, causes the electronic device 101 to display, in user interface 906, one or more representations of media content corresponding to one or more movies, a selectable option 936d that, when selected, causes the electronic device 101 to display, in user interface 906, one or more representations of media content corresponding to one or more (e.g., live) sports games, and a selectable option 936e that, when selected, causes the electronic device 101 to present, in user interface 906, a user interface for searching for particular media content.

In FIG. 9D, the electronic device 101 has detected that the viewpoint of the user 922 has moved from the viewpoint indicated in FIG. 9C to the viewpoint indicated in FIG. 9D. In some embodiments, the user's 922 viewpoint of the three-dimensional 904 moved to the viewpoint indicated in FIG. 9D because the user 922 moved to a corresponding pose and/or location in the physical environment 902. As illustrated in FIG. 9D, in response to detecting that the user's 922 viewpoint of the three-dimensional environment 904 has moved to the viewpoint indicated in FIG. 9D, the electronic device 101 displays the three-dimensional environment 904 from the user's new viewpoint of the three-dimensional environment 904. In particular, the display generation component 120 of device 101 is now displaying the user interfaces 926 and 928 and the representations 924 and 932 because these elements are now in the field of view from the user's viewpoint indicated in FIG. 9D.

In some embodiments, as the user's 922 viewpoint of the three-dimensional environment 904 moves, the electronic device 101 updates the location of the picture-in-picture user interface 934 based on the user's 922 new viewpoint of the three-dimensional environment 904. For example, as shown in overhead views 920 in FIGS. 9C and 9D, in response to the electronic device 101 detecting that the user's viewpoint of the three-dimensional environment 904 has moved from the viewpoint indicated in FIG. 9C to the viewpoint indicated in FIG. 9D, the electronic device 101 moves the location of the picture-in-picture user interface 934 from the location indicated in FIG. 9C to the location in FIG. 9D. In some embodiments, the electronic device 101 moved the picture-in-picture user interface 934 from the location in the three-dimensional environment 904 indicated in overhead view 920 in FIG. 9C because based on the user's current viewpoint of the three-dimensional environment 904, the location of the user interface 934 indicated in overhead view 920 is no longer at or within a threshold distance (e.g., 0.1, 0.2, 0.5, 1, 1.5, or 3 feet) of the user's new viewpoint of the three-dimensional environment 904 and/or because that location is no longer in a predetermined (e.g., bottom-right) portion of the user's field of view from the user's new viewpoint of the three-dimensional environment 904. In some embodiments, the picture-in-picture user interface 934 is optionally being displayed at the location in the three-dimensional environment 904 indicated in overhead view 920 for reasons similar to those described with reference to FIG. 9C. Additionally, as shown in overhead view 920, the location of user interface 906 in the three-dimensional environment 904 has not changed for similar reasons described previously with reference to FIG. 9B.

In some embodiments, while the electronic device 101 is presenting content in the picture-in-picture presentation mode, playback controls are displayed overlaid or integrated on the picture-in-picture user interface. For example, because user interface 934 is currently presenting TV Show A in a picture-in-picture presentation mode, the electronic device 101 is displaying user interface elements 936-948 overlaid on the user interface 934 (as opposed to when the playback controls were presented in a separate user interface while TV Show A was being presented in the expanded presentation mode, as described with reference to FIG. 9B). In some embodiments, as illustrated in FIG. 9D, the user interface elements 936-948 are displayed in the media user interface 934 when the electronic device detects that hand 916 is in the “pre-pinch” pose and optionally when the gaze of user 922 is directed to user interface 934. If the electronic device 101 does not detect that hand 916 is in the “pre-pinch” pose, the user interface elements 936-948 are optionally not displayed.

The functionalities associated with the user interface elements 936-948 will now be described. User interface element 936 is optionally selectable, and when selected, causes the electronic device 101 to cease presentation of TV Show A in the picture-in-picture presentation mode and start presenting TV Show A in the expanded presentation mode. User interface element 938 is optionally selectable, and when selected, causes the electronic device 101 to cease playback of TV Show A (and optionally cease display of the user interface 934). User interface element 940 is optionally selectable and, when selected, causes the electronic device 101 to fast forward TV Show A by a predetermined amount (e.g., by 10, 15, 20, 30, 40, or 60 seconds). User interface element 942 is optionally selectable and, when selected, causes the electronic device 101 to rewind TV Show A by a predetermined amount (e.g., by 10, 15, 20, 30, 40, or 60 seconds). User interface element 944 is optionally selectable and, when selected, causes the electronic device 101 to pause playback of TV Show A (e.g., if TV Show A is currently playing) or start playback of TV Show A (e.g., if TV Show A is currently paused). Lastly, the media user interface 934 includes a scrubber bar 946 that includes an indication 948 indicating a current playback position of TV Show A. Further details of the scrubber bar 908j and operations associated with scrubber bar 908j will be described with reference to method 1400 and FIGS. 13A-13E.

Additionally, as illustrated in FIG. 9D, while displaying the user interface elements 936-946 and while TV Show A is playing in the picture-in-picture presentation mode, the electronic device receives a request to present TV Show A in the expanded presentation mode (indicated by the selection of user interface 936). In some embodiments, the input selecting user interface element 936 is similar to the input selecting the user interface element 918b in FIG. 9B. In some embodiments, in response to receiving the request to start presenting TV Show A in the expanded presentation mode, the electronic device 101 ceases presentation of TV Show A at media user interface 934 and starts displaying TV Show A in the expanded presentation mode at the user interface 906 illustrated in 9C (and optionally ceases display of the representations 940-958 at the user interface 906 and the user interface 934 illustrated in FIG. 9C).

In some embodiments, if the user interface 906 (e.g., the user interface that presents TV Show A in the expanded presentation mode) is not in the field of view from the user's current viewpoint of the three-dimensional environment 904 when the electronic device 101 receives the request to transition presentation mode of TV Show A from the picture-in-picture presentation mode to the expanded presentation mode, the electronic device 101 updates the location of the user interface 906 to be at location that is within the field of view from the user's current viewpoint of the three-dimensional environment 904, such as shown in FIG. 9E. Conversely, if the electronic device 101 received the request to transition TV Show A from being presented in the picture-in-picture presentation mode to the expanded presentation mode while the user interface 906 was at a location in the three-dimensional environment 904 that is currently in the field of view of the user (such as in FIG. 9C), the electronic device 101 would optionally not have updated the location of user interface 906 in the three-dimensional environment 904.

In some embodiments, if the playback of a media item during the expanded mode of presentation finishes, the electronic device 101 displays one or more representations of one or more suggested media items to watch next. For example, in FIG. 9E, the electronic device 101 has detected that the playback of TV Show A in the user interface 906 has finished, or has reached a respective position in playback (e.g., 0.25, 0.5, 1, 2, 3 or 5 minutes from the end of playback). In response, the electronic device 101 displays a user interface 909 that includes representations 946-950 of respective media items. In some embodiments, the media items corresponding to the representations 946-950 were selected for display in the user interface 909 based on the content consumption history of the user 922. In some embodiments, the representations 946-950 are selectable and, when selected, cause the electronic device 101 to playback the corresponding media item in user interface 906. For example, the electronic device 101 optionally starts playing Media Item C at the user interface 906 when the electronic device 101 detects that the hand of the user 916 of the user is in the “pointing” or “pinching” pose (as described previously) while the gaze 914 of the user 922 is directed towards the representation 950.

Additionally, or alternatively, the media items corresponding to the representations 946-950 are optionally selected for playback based on user's gaze 914 (without detecting input from the user's hand). For example, as shown in FIG. 9E, the gaze 914 of the user 922 is currently directed towards the representation 946 of Item A. In some embodiments, when the electronic device detects that the gaze 914 of the user 922 is directed towards the representation 914, the electronic device 101 starts playback of Item A at user interface 906. Alternatively, in some embodiments, the electronic device 101 only starts playback of Media Item A when the gaze 914 of the user has been directed towards the representation 946 for at least a threshold amount of time (e.g., 15, 30, 60, 90, or 200 seconds). For example, in FIG. 9E, the electronic device 101 has not started playback of Media Item A in the user interface 906 because the gaze 914 of the user 922 has not been directed towards the representation 946 for the above-discussed threshold amount of time.

In some embodiments, the electronic device 101 displays an indication 915 indicating the amount of time remaining until the gaze 914 of the user 922 will cause the electronic device 101 to start playback of the media item. For example, in FIG. 9E, the electronic device 101 is displaying a circular visual indication 915 within the representation 946. In some embodiments, as the user's gaze 914 remains directed towards the representation 946, the electronic device 101 updates (e.g., in real time) the visual indication 915 to occupy space from 0 (e.g., when user's gaze 914 has not been directed towards the representation 914) to 360 degrees of angular distance (e.g., when user's gaze 914 has been directed towards the representation 914 for the above-described threshold amount of time). For example, in FIG. 9E, the visual indication 915 is currently indicating that the user's gaze 914 has been directed towards the representation 946 for half the above-discussed threshold amount of time because the visual indication 915 is occupying 180 degrees of angular distance.

Additional or alternative details regarding the embodiments illustrated in FIGS. 9A-9E are provided below in description of method 1000 described with reference to FIGS. 10A-10I.

FIGS. 10A-10I is a flowchart illustrating a method of displaying media content in a three-dimensional environment in accordance with some embodiments. In some embodiments, the method 1000 is performed at a computer system (e.g., computer system 101 in FIG. 1) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1000 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1000 are, optionally, combined and/or the order of some operations is, optionally, changed.

In some embodiments, method 1000 is performed at an electronic device in communication with a display generation component and one or more input devices (e.g., a mobile device (e.g., a tablet, a smartphone, a media player, or a wearable device), or a computer). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the electronic device (e.g., device 101 in FIGS. 9A-9E) displays (1002a), via the display generation component, a three-dimensional environment (e.g., the three-dimensional environment is a computer-generated reality (XR) environment such as a virtual reality (VR) environment, a mixed reality (MR) environment, or an augmented reality (AR) environment, etc.) that includes a first media user interface (e.g., a user interface such as described with reference to methods 800, 1200 and/or 1400) that is presenting (e.g., media) content and is located at a first respective location in the three-dimensional environment. For example, in FIG. 9A, electronic device 101 is displaying a three-dimensional environment 904 that includes “TV Show A” being presented at the user interface 906. In some embodiments, while the first media user interface is being displayed in the three-dimensional environment, the first media user interface is presenting a movie, TV show, music video, and/or other types of video or audio content. In some embodiments, the first media user interface is located at the first respective location in the three-dimensional environment because the first respective location is a default launch location of an application associated with the first media user interface (e.g., in response to launching a respective application, the first media user interface is displayed at the first respective location in the three-dimensional environment). In some embodiments, the first media user interface is located at the first respective location in the three-dimensional environment because the user of the electronic device has moved the first media user interface to the first respective location. In some embodiments, if the three-dimensional environment is being displayed while the user's viewpoint is a first viewpoint (e.g., while the electronic device is oriented towards a first area in the physical environment), the three-dimensional environment optionally includes representations of some of or all of the objects located at the first location in physical environment and/or representations of virtual objects (e.g., objects that are not in the physical environment but are displayed because the user's viewpoint corresponds to the first viewpoint). In other words, different viewpoints of the user of the electronic device optionally cause different virtual objects and/or representations of physical objects to be in the user's field of view while displaying the three-dimensional environment from a respective viewpoint. For example, the first location in the physical environment may include one or more physical objects such as chairs, sofas, tables, etc., and the three-dimensional environment may include representations of those one or more chairs, sofas, tables, etc. Similarly, the first media user interface is optionally at a location in the three-dimensional environment such that when the user's viewpoint corresponds to the first viewpoint, the first media user interface is within the user's field of view from the first viewpoint.

In some embodiments, while displaying the three-dimensional environment with the first media user interface at the first respective location in the three-dimensional environment that has a pose (e.g., position and/or orientation) in a respective range of poses relative to a first viewpoint of a user of the electronic device (e.g., in some embodiments, the respective range of poses relative to the first viewpoint of the user includes all of (or a subset of) of the poses in the three-dimensional environment that are in a user's field of view of the three-dimensional environment from the first viewpoint of the user. In some embodiments, a position of the first media user interface in the three-dimensional environment is not in the respective range of poses relative to the first viewpoint if that position is not in the user's field of view from the first viewpoint), the electronic device detects (1002b) movement of a viewpoint of the user in the three-dimensional environment from the first viewpoint to a second viewpoint different from the first viewpoint (e.g., the electronic device detects that the user of the electronic device has started looking at a different location in the physical environment (e.g., the orientation of the user's field of view into the three-dimensional environment has changed). For example, in FIG. 9B, the electronic device 101 detects that the user's viewpoint of the three-dimensional environment 904 has changed from the viewpoint indicated in overhead view 920 in FIG. 9A to the viewpoint indicated in overhead view 920 in FIG. 9B. In some embodiments, portions of the three-dimensional environment that were in the field of view from the first viewpoint of the user are optionally still within the user's field of view from the second viewpoint (e.g., at least a portion of the three-dimensional environment displayed via the display generation component while the three-dimensional environment was being presented from the first viewpoint is displayed via the display generation component while the three-dimensional environment is being presented from the second viewpoint). Alternatively, in some embodiments, while the three-dimensional environment is being presented from the second viewpoint of the user, areas/portions of the three-dimensional environment that were in the user's field of view from the first viewpoint are optionally no longer in the user's field of view from the second viewpoint. In some embodiments, the user's viewpoint changes as the user moves (e.g., walks, runs, etc.) in the physical environment and/or looks towards a different area in the physical environment (e.g., while remaining stationary).)

In some embodiments, in response to detecting the movement of the viewpoint of the user from the first viewpoint to the second viewpoint, the electronic device displays (1002c), via the display generation component, the three-dimensional environment from the second viewpoint (e.g., the electronic updates display of the three-dimensional environment to correspond to the user's new viewpoint of the three-dimensional environment—the second viewpoint. In some embodiments, the display of the three-dimensional environment from the second viewpoint is analogous to the display of the three-dimensional environment from the first viewpoint of the user, as described above).

In some embodiments, in accordance with a determination that the content is being presented in a first mode of presentation (e.g., in some embodiments, the content is being presented in the first mode of presentation when the content is not being presented in a Picture-in-Picture (PiP) UI. In some embodiments, the content is being presented in the first mode of presentation when the content is being presented in a default presentation mode (e.g., natively playing in a video player application associated with the first media user interface). In some embodiments, the content is being presented in the first mode of presentation if the content is being presented with a video aspect ratio greater than 9:16 or 16:9)), the electronic device 101 maintains (1002d) the first media user interface at the first respective location in the three-dimensional environment, wherein the first media user interface is no longer in the respective range of poses relative to the second viewpoint of the user. For example, even though the user's 922 viewpoint of the three-dimensional environment 904 changed between FIGS. 9A and 9B, the location of the user interface 906 in the three-dimensional environment 904 did not change (as indicated in overhead view 920 in FIGS. 9A and 9B). For example, if the content in the first media user interface is being presented in a non-PiP presentation mode (e.g., presented natively in a video player application), movement of the user's viewpoint does not cause the location of the first media user interface in the three-dimensional environment to change. Thus, in some embodiments, the first media user interface is optionally no longer located in the user's field of view when the three-dimensional environment is displayed from the user's second viewpoint. In some embodiments, when the three-dimensional environment is being presented from the user's second viewpoint, the first media user interface is no longer in the respective range of poses relative to the second viewpoint of the user because the location (e.g., position) of the first media user interface in the three-dimensional environment is not in the user's field of view from the user's second viewpoint of the three-dimensional environment.

In some embodiments, in accordance with a determination that the content is being presented in a second mode, different from the first mode, of presentation (e.g., if the content is being presented in a Picture-in-Picture (PiP) format), the electronic device displays (1002e) the first media user interface at a second respective location, different from the first respective location, in the three-dimensional environment, wherein displaying the first media user interface at the second respective location causes the first media user interface to be displayed in a pose that is in the respective range of poses relative to the second viewpoint of the user (e.g., in some embodiment, the range of poses relative to the second viewpoint of the user includes all of (or a subset of) of the poses in the three-dimensional environment that are in the user's field of view from the second viewpoint of the user), such as the location of user interface 934 moving from the location indicated in FIG. 9C to the location indicated in FIG. 9D as a result of the movement of the user's viewpoint. For example, if the content in the first media user interface is being presented in a Picture-in-Picture (PiP) presentation mode, the location of the first media user interface in the three-dimensional environment changes as the user's viewpoint of the three-dimensional environment changes, such that the first media user interface is always being displayed in the portion of the three-dimensional environment that is currently being displayed (e.g., corresponding to the current viewpoint of the user). In some embodiments, if the first media user interface is being presented in the second mode of presentation, the first media user interface is displayed at locations in the three-dimensional environment such that the first media user interface appears within a threshold distance (0.5, 1, 2, 4, or 6 feet) of (e.g., a predetermined portion of) the user of the electronic device (or within a threshold distance (0.5, 1, 2, 4, or 6 feet) of a respective body part (e.g., right or left hip, right or left shoulder) of the user). For example, if the first media user interface is being presented in the second mode of the presentation, the first media user interface is displayed in the lower-right portion of the user's field of view of the three-dimensional environment, regardless of the location and/or orientation of the viewpoint. In some embodiments, if the first media user interface is not being presented in the second mode of presentation (e.g., being presented with the first mode of presentation), the first media user interface is optionally being displayed at a location in the three-dimensional environment that is not within a threshold distance (0.5, 1, 2, 4, or 6 feet) of the user of the electronic device (or within a threshold distance (0.5, 1, 2, 4, or 6 feet) of a respective body part (e.g., right or left hip, right or left shoulder) of the user).

Changing the location of the first media user interface as the user's viewpoint in the three-dimensional environment changes provides an efficient way of providing continuous access to certain user interfaces in the three-dimensional environment, regardless of the user's current viewpoint of the three-dimensional environment when the content of the first media user interface is being presented in a second mode of presentation, thereby reducing cognitive burden on the user both when engaging with the first media user interface and when engaging with other content or applications in the three-dimensional environment.

In some embodiments, the second respective location is based on the second viewpoint (1004a) (e.g., the location of the first media user interface is no longer based on a location of the first viewpoint of the user, but rather based on a location of the second viewpoint of the user). In some embodiments, the second respective location is a location in the three-dimensional environment that is within or at a threshold distance from the second viewpoint (e.g., 0.1, 0.2, 0.5, 1, 1.5, or 3 feet). In some embodiments, the second respective location is a location in the field of view of the user from the second viewpoint. In some embodiments, the second respective location in the three-dimensional environment corresponds to a location in the physical environment that is within or at a threshold distance of a respective body part (e.g., portion) of the user (e.g., within 0.1, 0.2, 0.3, 1, 2, or 3 feet of a user's hip, hand, head, foot, or knee). In some embodiments, the second respective location corresponds to a lower right portion (or lower left portion or upper right portion) of the user's field of view from the second viewpoint of the user. In some embodiments, displaying the first media user interface at the second respective location includes (1004a), in accordance with a determination that movement of the viewpoint of the user after moving to the second viewpoint satisfies one or more criteria (e.g., in some embodiments, the one or more criteria are satisfied if following movement of the user's viewpoint of three-dimensional environment to the second viewpoint, the user's viewpoint of the three-dimensional environment has not changed by more than a predetermined amount (e.g., the user's viewpoint has not moved by more than a threshold amount of movement (e.g., less than 1 cm, 2 cm, 5 cm, 10 cm, 50 cm, 100 cm, 300 cm, or 1000 cm of movement) and/or has corresponded to the second viewpoint for at least a threshold amount of time (e.g., 0.5, 1, 3, 7, 10, 20, or 30 seconds)), displaying the first media user interface at the second respective location (1004b). For example, in FIG. 9D, if the user's 922 viewpoint of the three-dimensional environment 904 satisfies the above-mentioned criteria, the user interface 934 is displayed at a location in the three-dimensional environment 904 that is within the field of view of the user 922. For example, the first media user interface is displayed at the second respective location in the three-dimensional environment if the user's viewpoint of the three-dimensional environment has corresponded to the second viewpoint for at least a threshold amount of time (e.g., 0.5, 1, 3, 7, 10, 20, or 30 seconds) and/or has moved less than the threshold amount of movement (e.g., less than 1 cm, 2 cm, 5 cm, 10 cm, 50 cm, 100 cm, 300 cm, or 1000 cm of movement).

In some embodiments, displaying the first media user interface at the second respective location includes (1004a): in accordance with a determination that the movement of the viewpoint of the user after moving to the second viewpoint does not satisfy the one or more criteria (e.g., in some embodiments, the one or more criteria are not satisfied if following movement of the user's viewpoint of three-dimensional environment to the second viewpoint, the user's viewpoint of the three-dimensional environment has moved by more than a threshold amount (e.g., the user's viewpoint has moved more than 1 cm, 2 cm, 5 cm, 10 cm, 50 cm, 100 cm, 300 cm, or 1000 cm of movement) and/or has not corresponded to the second viewpoint for at least a threshold amount (e.g., 0.1, 1, 3, 7, 10, 20, or 30 seconds)), forgoing display of the first media user interface at the second respective location (1004c). For example, in FIG. 9D, if the user's 922 viewpoint of the three-dimensional environment 904 does not satisfy the above-mentioned criteria, the user interface 934 is not displayed a location in the three-dimensional environment 904 that is within the field of view of the user 922. For example, if the user's viewpoint of the three-dimensional environment has not corresponded to the second viewpoint for at least a threshold amount (e.g., 0.1, 1, 3, 7, 10, 20, or 30 seconds) (and/or or has moved by more than the threshold amount of movement), the first media user interface is not displayed at the second respective location until the user's viewpoint of the three-dimensional environment satisfies the one or more criteria. In some embodiments, if the one or more criteria are not satisfied (e.g., the user's viewpoint of the three-dimensional environment has not corresponded to the second viewpoint for at least the above described threshold amount of time), the first media user interface continues to be displayed at a location in the three-dimensional environment based on the first viewpoint of the user. In some embodiments, when the user's viewpoint is moving to the second viewpoint, the first media user interface at the first respective location fades out and fades back in after the one or more criteria are satisfied. In some embodiments, the first media user interface does not change locations in the three-dimensional environment until the one or more criteria are satisfied. Thus, while the electronic device is forgoing display of the first media user interface at the second respective location, the electronic device optionally remains displayed at the first respective location in the three-dimensional environment.

Displaying or delaying the display of a first media user interface following movement of a user's viewpoint of the three-dimensional environment provides an efficient way of displaying the first media user interface relative to a user's new viewpoint after the movement of the user has settled down, thereby reducing cognitive burden on the user both when engaging with the first media user interface and when engaging with other content or applications in the three-dimensional environment.

In some embodiments, the first media user interface is associated with a respective application (e.g., a video application, a media application, or a streaming application). In some embodiments, the orientation of the first media user interface (e.g., whether the first media user interface is displayed in portrait or landscape mode) during the second mode of presentation is defined by the application associated with the first media user interface. In some embodiments, the type of application that is associated with the first media user interface defines the orientation of the first media user interface during the second mode of presentation. In some embodiments, during the second mode of presentation, the first media user interface is automatically oriented towards the viewpoint of the user (e.g., normal to the viewpoint of the user), such that content in the first media user interface is displayed (e.g., angled) towards the user's viewpoint of the three-dimensional environment.

In some embodiments, while the first media user interface is presenting the content in the second mode of presentation, the first media user interface includes one or more user interface elements that are selectable for modifying playback of the content (1006a), such as user interface elements 936-948 in the user interface 934 in FIG. 9D. In some embodiments, while displaying the one or more user interface elements in the first media user interface, the electronic device receives (1006b), via the one or more input devices, an input corresponding to a selection of a respective user interface element of the one or more user interface elements, such as the selection of user interface element 936 in FIG. 9D.

In some embodiments, in response to receiving the input, the electronic device modifies (1006c) playback of the content in accordance with the selection of the respective user interface element. For example, in response to the electronic device 101 detecting the selection of user interface element 936, the electronic device 101 transitions playback of TV Show A from the picture-in-picture presentation to the expanded presentation mode as described in more detail with reference to FIG. 9D. For example, when the content is being presented in a picture-in-picture mode (e.g., the second mode of presentation), the user interface elements for modifying playback of the content are displayed overlaying the first media user interface. In some embodiments, the user interface elements are integrated in the first media user interface (as opposed to overlaying the first media user interface), such that the content being presented in the first media user interface and the user interface elements are at a same Z-depth in the three-dimensional environment. In some embodiments, the user interface elements for modifying playback of the content include user interface elements for playing, pausing, fast forwarding, rewinding, displaying subtitles, and/or for modifying audio associated with the content being presented in the first media user interface. In some embodiments, the first media user interface also includes a user interface element associated with playing the content in a third mode of (e.g., immersive) presentation if the content being presented in the first media user interface is immersive content (as described in more detail in method 1400). In some embodiments, the one or more user interface elements are displayed in the first media user interface after the electronic device detects that the user of the electronic device performed a pinching gesture (e.g., such as with the thumb and index finger of a hand of a user) while a user's gaze was directed to the first media user interface element. In some embodiments, the user interface elements are displayed in the first media user interface when only a gaze of the user is directed towards the first media user interface and/or when a gaze of the user is directed towards the first media user interface while a hand of the user is performing a start of a pinching gesture (e.g. such as when the thumb and index finger of a hand of a user are more than a threshold distance apart (e.g., 0.5, 1, 1.5, 3, or 6 cm) and have not yet converged to be within the above-mentioned threshold distance of each other).

Displaying the user interface elements (e.g., overlaid on or integrated in) the first media user interface provides an efficient way of displaying user interface elements associated with modifying playback of content and interacting with such controls, thereby reducing cognitive burden on the user when engaging with the first media user interface and when modifying playback of the first media user interface.

In some embodiments, while the first media user interface is presenting the content in the first mode of presentation, the three-dimensional environment includes a playback controls user interface, separate from the first media user interface, that includes one or more user interface elements that are selectable for modifying playback of the content, and the first media user interface does not include the one or more user interface elements that are selectable for modifying the playback of the content (1008a). For example, in FIG. 9B, the playback controls user interface 908 is displayed separate from user interface 906 during the expanded presentation mode. In some embodiments, the content is being presented in the first mode of presentation if the content is not being presented in a picture-in-picture presentation mode. In some embodiments, the content is being presented in the first presentation mode if the content is being presented with a display size that is larger than a display size of the content during the second presentation mode. In some embodiments, the content is being presented in the first mode of presentation when the content is being presented in a default presentation mode (e.g., natively playing in a video player application associated with the first media user interface).

In some embodiments, while displaying the playback controls user interface, the electronic device 101 receives (1008b), via the one or more input devices, an input corresponding to a selection of a respective user interface element of the one or more user interface elements. For example, in FIG. 9B, the electronic device 101 detects a selection of user interface element 908b. In some embodiments, in response to receiving the input, the electronic device modifies (1008c) playback of the content in accordance with the selection of the respective user interface element. For example, in FIG. 9C, in response to the electronic device 101 detecting the selection of user interface element 908b in FIG. 9B, the electronic device 101 displays TV Show A at the picture-in-picture user interface 934. For example, during presentation of the content in the first mode of presentation, user interface elements associated with modifying playback of the content being presented in the first media user interface are displayed in a playback controls user interface that is separate from the first media user interface (e.g., and is not integrated with and/or overlaying the first media user interface). In some embodiments, the one or more user interface elements include an option for playing/pausing the content, advancing the content forward by a predetermined amount (e.g., 15, 30, 60, 90 seconds), rewinding the content by a predetermined amount (e.g., 15, 30, 60, 90 seconds), for modifying the display of subtitles and/or audio associated with the content being presented in the first media user interface. In some embodiments, the playback controls user interface is angled towards the user's viewpoint of the three-dimensional environment (e.g., normal to the user's viewpoint) in a different manner than the first media user interface. For example, in some embodiments, the playback controls user interface is displayed with an upward tilt relative to a fixed frame of reference, and the first media user interface is displayed parallel to the fixed frame of reference. In some embodiments, both the playback controls user interface and the first media user interface are normal to the viewpoint of the user. In some embodiments, the playback controls user interface includes an option to start playing the content in a third mode of presentation (e.g., immersive presentation) if the content is immersive content, as described in more detail with reference to method 1400. In some embodiments, the playback controls user interface is displayed in the three-dimensional environment after the electronic device detects that the user of the electronic device performed a pinching gesture (e.g. such as with the thumb and index finger of a hand of a user) while a user's gaze was directed to the first media user interface element. In some embodiments, the playback controls user interface is displayed in the three-dimensional environment when only a gaze of the user is directed towards the first media user interface and/or when a gaze of the user is directed towards the first media user interface while a hand of the user is performing a start of a pinching gesture (e.g. such as when the thumb and index finger of a hand of a user are more than a threshold distance apart (e.g., 0.5, 1, 1.5, 3, 6 cm) and have not yet converged to be within the above-mentioned threshold distance of each other).

Displaying user interface elements for modifying playback of the content in the first media user interface in a separate user interface during the first mode of presentation provides an efficient way of accessing and interacting with such user interface elements during the first mode of presentation, thereby reducing cognitive burden on the user when engaging with the first media user interface and when modifying playback of the first media user interface.

In some embodiments, while the content is being displayed in the first mode of presentation in the first media user interface (e.g., in some embodiments, the content is being presented in the first mode of presentation if the content is not being presented in a picture-in-picture presentation mode. In some embodiments, the content is being presented in the first presentation mode, if the content/first media user interface is being presented with a display size that is larger than a display size of the content/first media user interface during the second presentation mode. In some embodiments, the content is being presented in the first mode of presentation when the content is being presented in a default presentation mode (e.g., natively playing in a video player application associated with the first media user interface).) and while concurrently displaying the first media user interface with a first respective user interface element that is selectable to transition the content from the first mode of presentation to the second mode of presentation (e.g., a user interface element is displayed that is selectable to transition the content from being presented in the first mode of presentation to a second mode of presentation (e.g., a picture-in-picture presentation mode)), the electronic device 101 receives (1010a), via the one or more input devices, a first input corresponding to a selection of the first respective user interface element, such as the selection of user interface element 908b in FIG. 9B.

In some embodiments, in response to receiving the first input (1010b), (e.g., ceasing presentation of the content in the media user interface;) the electronic device displays (1010c), via the display generation component, a second media user interface (e.g., different from the first media user interface) that is presenting the content in the second mode of presentation. For example, in response to the electronic device 101 detecting the selection of user interface element 908b in FIG. 9B, the electronic device 101 transitions the display of TV Show A from the user interface 906 to the picture-in-picture user interface 934 in FIG. 9C. For example, after receiving the first input, the content transitions from playing in the first media user interface of the media application to the second media user interface (e.g., a picture-in-picture user interface). In some embodiments, the second media user interface is smaller in size (e.g., in the three-dimensional environment) than the first media user interface (e.g., has a width and/or height smaller than the first media user interface in the three-dimensional environment). In some embodiments, the portion of the field of view of the user occupied by the second media user interface is smaller than the portion of the field of view of the user occupied by the first media user interface.

In some embodiments, in response to receiving the first input (1010b), the electronic device displays (1010d), in the first media user interface, one or more selectable representations of one or more content items, including a first selectable representation of a first content item that is selectable to cause playback of the first content item at the first or second media user interfaces, such as the representations 940-958 in FIG. 9C. For example, after receiving the first input, the first media user interface (e.g., that was presenting the content before the content started playing in the second media user interface) starts displaying representations of content items that are selectable to cause playback of a corresponding content item (e.g., within the first media user interface or within the second media user interface). In some embodiments, the content items corresponding to the one or more selectable representations correspond to content items that are being recommended based on a user's content consumption history. In some embodiments, the content items corresponding to the one or more selectable representations correspond to content items that are trending, popular, and/or newly released.

Updating the first media user interface to include representations of additional content items when content that was being presented in the first media user interface starts being displayed in a different user interface provides an efficient way of accessing additional content items at the same time the content is being presented in the second presentation mode (and without the need for additional input), thereby reducing cognitive burden on the user when engaging with the first media user interface and when modifying presentation of content being presented in the first media user interface.

In some embodiments, in response to receiving the first input and before presenting the content in the second mode of presentation at the second media user interface, the electronic device displays (1012a) an animation of the content transitioning from the first mode of presentation at the first media user interface to the second mode of presentation at the second media user interface. For example, an animation is displayed as the electronic device 101 is transitioning presentation of TV Show A from the expanded presentation mode illustrated in FIG. 9B to the picture-in-picture presentation mode illustrated in FIG. 9C. For example, after receiving the request to change the content from being presented in the first mode of presentation to the second mode of presentation, an animation is displayed indicating that the content is transitioning from the first mode of presentation to the second mode of presentation. In some embodiments, the animation includes the content being visually de-emphasized (e.g., fading out) at the first media user interface and/or the content being visually emphasized (e.g., fading in) at the second media user interface. In some embodiments, the animation includes visually highlighting the second media user interface to indicate that the content is now being presented at the second media user interface. In some embodiments, the second media user interface continues to be highlighted or visually emphasized until the content has been presented in the second media user interface for a threshold amount of time (e.g., 5, 10, 20, 40, 60, 120 seconds) or until the user's attention becomes directed towards the second media user interface (e.g., a gaze of the user becomes directed towards the second media user interface). In some embodiments, the animation includes the content shrinking and (or while) moving in the three-dimensional environment from the location of the first media user interface to the location of the to-be displayed second media user interface.

Displaying an animation as the content is transitioning from the first mode of presentation to the second mode of presentation provides an efficient way of indicating the current presentation mode associated the content, thereby reducing cognitive burden on the user when engaging with content being presented in the first media user interface.

In some embodiments, while presenting the content in the second mode of presentation at the second media user interface (e.g., while the content is being presented in a picture-in-picture user interface), the electronic device receives (1014a), via the one or more input devices, a second input corresponding to a request to change presentation of the content from the second mode of presentation to the first mode of presentation, such as the input for selecting user interface element 936 in FIG. 9D. In some embodiments, the request to transition presentation of the content from the second mode of presentation to the first mode of presentation is received when a user interface element that is displayed within or with the second media user interface is selected as previously described above. In some embodiments, in response to receiving the second input (1014b), the electronic device ceases (1014c) displaying the second media user interface and the one or more selectable representations in the second media user interface. For example, the second user interface (e.g., the picture-in-picture user interface) stops being displayed in the three-dimensional environment when the presentation mode associated with the content switches from the second mode of presentation to the first mode of presentation. In some embodiments, the electronic device presents (1014d), at the first media user interface, the content, wherein the content is being presented in the first mode of presentation while the content is being displayed at first the media user interface. For example, if the electronic device 101 detected a request to transition playback of TV Show A from the picture-in-picture presentation mode to the expanded presentation mode, the electronic device 101 replaces the representations 940-958 at user interface 906 with the playback of TV Show A. For example, the first media user interface in the three-dimensional environment starts presenting the content when the presentation mode associated with the content switches to the first mode of presentation. In some embodiments, when the presentation mode of the content switches to the first mode of presentation, the location of the content in the three-dimensional environment changes from a location corresponding to the second media user interface (e.g., the picture-in-picture user interface) to a location in the three-dimensional environment that corresponds to a location of an application that is now facilitating playback of the content. In some embodiments, when the content is being presented in the first mode of presentation, the content is being presented in a first media user interface that is larger in size compared to the second media user interface (e.g., and thus the content is displayed at a larger size compared with the size at which it was presented in the second media user interface). In some embodiments, if the second input was received while the content was at a first playback position, the electronic device starts presenting the content in the first media user interface from the first playback position.

Presenting content at different media user interfaces based on the presentation mode of that content provides an efficient way of indicating the current presentation mode associated the content, thereby reducing cognitive burden on the user when engaging with content being presented in the first media user interface.

In some embodiments, in response to receiving the second input and before presenting, at the first media user interface, the content in the first mode of presentation, the electronic device displays (1016a) an animation of the content transitioning from the second mode of presentation at the second media user interface to the first mode of presentation at the first media user interface. For example, an animation is displayed as the electronic device 101 is transitioning presentation of TV Show A from the picture-in-picture presentation mode illustrated in FIG. 9D to the expanded presentation mode in response to the selection of user interface element 936. For example, in response to receiving the request to change the content from being presented in the second mode of presentation to the first mode of presentation, an animation is displayed indicating that the content is transitioning from the second mode of presentation to the first mode of presentation. In some embodiments, the animation includes the content fading out (e.g., being visually deemphasized) at the second media user interface and/or the content fading in (e.g., being visually emphasized) at the first media user interface. In some embodiments, the animation includes visually highlighting the first media user interface to indicate that the content is now being presented at the first media user interface (and not the second media user interface). In some embodiments, the first media user interface continues to be highlighted or visually emphasized until the content has been presented in the first media user interface for a threshold amount of time (e.g., 5, 10, 20, 40, 60, 120 seconds) or until the user's attention becomes directed towards the second media user interface (e.g., a gaze of the user becomes directed towards the first media user interface). In some embodiments, the animation includes the content enlarging and (or while) moving in the three-dimensional environment from the location of the second media user interface to the location of the first media user interface. Displaying an animation as the content is transitioning from the second mode of presentation to the first mode of presentation provides an efficient way of indicating the current presentation mode associated the content, thereby reducing cognitive burden on the user when engaging with content being presented in the first media user interface.

In some embodiments, while presenting the content in the first mode presentation at the first media user interface (e.g., in some embodiments, the content is being presented in the first mode of presentation if the content is not being presented in a picture-in-picture presentation mode. In some embodiments, the content is being presented in the first presentation mode, if the content is being presented with a display size that is larger than a display size of the content during the second presentation mode. In some embodiments, the content is being presented in the first mode of presentation when the content is being presented in a default presentation mode (e.g., natively playing in a video player application associated with the first media user interface).), the electronic device receives (1018a), via the one or more input devices, a first input corresponding to a request to display a first user interface of a first application (e.g., a request to launch a new application in the three-dimensional environment is received). In some embodiments, in response to receiving the first input (1018b), the electronic device displays (1018c), in the three-dimensional environment, the first user interface of the first application; For example, a user interface of the first application is displayed in the three-dimensional environment when the electronic device receives a request to open/launch the first application in the three-dimensional environment. In some embodiments, in response to receiving the first input (1018b), the electronic device ceases (1018d) to present the content in the first mode of presentation at the first media user interface. For example, when an application in the three-dimensional environment is launched while content is being presented in the first mode of presentation, the content stops being presented in the first mode of presentation. In some embodiments, the first media user interface also ceases display in the three-dimensional environment. In some embodiments, in response to receiving the first input (1018b), the electronic device displays (1018e), in the three-dimensional environment, a second media user interface that is presenting the content, wherein the content is being presented in the second mode of presentation while the content is being presented at the second media user interface. For example, in FIG. 9A, if the electronic device 101 receives a request to launch a new application in the three-dimensional environment 904, the electronic device 101 automatically transitions presentation of TV Show A from the expanded presentation mode to the picture-in-picture presentation mode. In some embodiments, the second media user interface is displayed concurrently the first user interface of the first application. For example, when a request to launch a new application in the three-dimensional environment is received while content is being presented in the first mode of presentation, the content starts playing in a different user interface (e.g., a picture-in-picture user interface) and in a different mode of presentation (e.g., the second mode of presentation). In some embodiments, the launching of the first application in the three-dimensional environment causes the content to transition from the first mode of presentation to the second mode of presentation because a default launch location of the first application corresponds to the current location of the first media user interface in the three-dimensional environment. In some embodiments, the launching of the first application in the three-dimensional environment causes the content to transition from the first mode of presentation to the second mode of presentation because the display location of the first user interface would occlude (or partially occlude) the first media user interface. In some embodiments, the content being presented in the second user interface is not being occluded by the first user interface of the first application.

Switching the presentation mode of the content from the first mode of presentation to the second mode of presentation when a request to launch a new application in the three-dimensional environment is received provides an efficient way continuing to display content in the three-dimensional environment when displaying new user interfaces in the three-dimensional environment, thereby reducing cognitive burden on the user when engaging with content being presented in the first media user interface.

In some embodiments, the electronic device detects (1020a) that playback of the content has reached a predetermined playback threshold (e.g., that playback has completed, that playback of content item is within a threshold amount of time from concluding (e.g., the playback of the content will end in 0.5, 1, 1.5, 3, 5, 10, 20 minutes)). In some embodiments, in response to detecting that the playback of the content has reached the predetermined playback threshold, the electronic device displays (1020b), in the three-dimensional environment, a second user interface that includes one or more representations of recommended content that, when selected, cause a corresponding content to start playback at the first media user interface. For example, in FIG. 9E, the electronic device 101 is displaying the user interface 946 in response to the electronic device 101 detecting that the playback of TV Show A has completed. For example, when the playback of the content has reached the predetermined playback threshold, a second media user interface is displayed in the three-dimensional environment that includes one or more representation of content that is selectable to start playback of new content in the first media user interface. In some embodiment, the second user interface is displayed if the content is being presented in the first mode of presentation and is not displayed if the content is not being presented in the first mode of presentation. In some embodiments, the content corresponding to the one or more representations correspond to content that is being recommended based on content consumption history of the user of electronic device and/or because the user previously saved/favorited the content. In some embodiments, the playback controls user interface is displayed concurrently with the first media user interface and/or is displayed underneath the first media user interface that is presenting the content.

Displaying a second user interface that includes selectable representation of recommended content when content playing in the first media user interface reaches a predetermined playback position provides an efficient way of providing access to other content that can be played back at the first media user interface, thereby reducing cognitive burden on the user when engaging with content being presented in the first media user interface.

In some embodiments, the one or more representations of recommended content include a first respective representation of a first recommended content (1022a) (e.g., a representation corresponding to a first content item is being displayed when the content reaches the predetermined playback threshold as described above). In some embodiments, while a gaze of the user is directed towards the first respective representation (1022b), in accordance with a determination that the gaze of the user (e.g., and optionally without considering any other inputs/gestures being performed by the user of the electronic device, such as without detecting input from a hand of the user directed to the first respective representation and/or any other element in the three-dimensional environment) has been directed towards the first respective representation for more than a threshold amount of time, the electronic device 101 initiates (1022c) playback of the first recommended content (e.g., in the first media user interface). For example, if the gaze of the user has been directed towards the first respective representation for more than a threshold amount of time (e.g., 5, 7, 9, 10, 20, 30, 60 seconds), the content corresponding to the first respective representation—the first recommended content—starts playing in the three-dimensional environment. In some embodiments, while a gaze of the user is directed towards the first respective representation (1022b), in accordance with a determination that the gaze of the user has not been directed towards the first respective representation for more than the threshold amount of time, the electronic device forgoes (1022d) initiating playback of the first recommended content (e.g., in the first media user interface). For example, electronic device 101 initiates playback of Item A if the user's gaze 914 has been directed towards the corresponding representation 946 for the above mentioned threshold amount of time, and does not initiate playback of Item if the user's gaze 914 has not been directed towards the corresponding representation 946 for the above mentioned threshold amount of time. For example, if the gaze of the user has not been directed towards the first respective representation for more than the threshold amount of time (e.g., 5, 7, 9, 10, 20, 30, 60 seconds), the content corresponding to the first respective representation—the first recommended content—does not start playing in the three-dimensional environment until the user's gaze has been directed towards the first respective representation for the above-mentioned threshold amount of time. Initiating playback of content based on an amount of time a user's gaze has been directed towards a corresponding representation being displayed in the three-dimensional environment provides an efficient way of starting playback of content in the three-dimensional environment without requiring the user to perform additional gestures (e.g., a hand gesture), thereby reducing cognitive burden on the user when engaging with content being presented in the second first media user interface.

In some embodiments, while the gaze of the user is directed towards the first respective representation (e.g., and while the gaze of the user has not been directed towards the first respective representation for more than the threshold amount of time), the electronic device displays (1024a) a visual indication in association with the first respective representation, wherein the visual indication updates as the gaze of the user remains directed towards the first respective representation to indicate a progress toward reaching the threshold amount of time, such as visual indication 915 in FIG. 9E. For example, a visual indication is displayed indicating the amount of time remaining until the gaze of the user has been directed towards the first respective representation for at least the above described threshold amount of time (e.g., 5, 7, 9, 10, 20, 30, 60 seconds). In some embodiments, the progress indicator is displayed overlaid on the first respective presentation when the user's gaze is directed towards the first respective representation and is not displayed when the user's gaze is not directed towards the first respective representation. In some embodiments, in accordance with a determination that the gaze of the user has been directed towards the first respective representation for at least the threshold amount of time, the visual indication stops being updated, and the content corresponding to the first respective representation (e.g., the first recommended content) starts being played in the three-dimensional environment. In some embodiment, the visual indication is a symbol (e.g., arrow) that extends in a circular manner as the user's gaze is directed towards the first respective representation).

Providing an indication of when new content will start playing in the three-dimensional environment based on an amount of time a user's gaze has been directed towards a corresponding representation of the content provides an efficient way of indicating when playback of the new content will occur, thereby reducing cognitive burden on the user when engaging with content being presented in the second media user interface.

In some embodiments, while presenting the content in the second mode of presentation, the pose of the first media user interface at the first respective location relative to the first viewpoint is the same as the pose of the first media user interface at the second respective location relative to the second viewpoint of the user (1026a). For example, the first media user interface is displayed at a predetermined portion (e.g., lower right, upper right, lower left, upper left, or lower center) of the user's field of view regardless of the user's current viewpoint of the three-dimensional environment. In some embodiments, the first media user interface is (e.g., always) displayed at the same relative position and/or orientation relative a user's viewpoint of the three-dimensional environment.

Displaying the first media user interface with a same pose (e.g., position and/or orientation) relative to the user's viewpoint provides an efficient way of displaying the first media user interface in a uniform manner regardless of the user's viewpoint of the three-dimensional environment, thereby reducing cognitive burden on the user when engaging with the first media user interface.

In some embodiments, the first viewpoint of the user corresponds to a first location in a physical environment of the electronic device, and the second viewpoint of the user corresponds to a second location, different from the first location, in the physical environment (1028a). In some embodiments, the electronic device displays the three-dimensional environment from the viewpoint of the user at a location in the three-dimensional environment corresponding to the physical location of the electronic device in the physical environment of the electronic device. In some embodiments, detecting movement of the viewpoint of the user includes detecting movement of at least a portion of the user (e.g., the user's head, torso, or hand) in the physical environment. In some embodiments, detecting movement of the viewpoint of the user includes detecting movement of the electronic device or display generation component in the physical environment. In some embodiments, displaying the three-dimensional environment from the viewpoint of the user includes displaying the three-dimensional environment from a perspective associated with the location of the viewpoint of the user in the three-dimensional environment. In some embodiments, updating the viewpoint of the user causes the electronic device to display the plurality of virtual objects from a perspective associated with the location of the updated viewpoint of the user. For example, if the electronic device detects leftward movement in the physical environment, the viewpoint of the user moves to the left in the three-dimensional environment, and the electronic device updates the position of the plurality of virtual objects displayed via the display generation component to move to the right.

Displaying the three-dimensional environment from a viewpoint that is based on a user's physical location provides an efficient way of interacting with the three-dimensional environment based on an actual user's pose and/or location in a physical environment, thereby reducing cognitive burden on the user when engaging with the three-dimensional environment.

In some embodiments, while the content is being presented in the second mode of presentation in the first media user interface and while a second media user interface is being displayed at a third respective location in the three-dimensional environment (e.g., while content in the first media user interface is being presented in a picture-in-picture user interface in the three-dimensional environment and the second media user interface is displaying representations of content recommendations), the electronic device receives (1030a), via the one or more input devices, a second input corresponding to a request to change presentation of the content from the second mode of presentation to the first mode of presentation. In some embodiments, the electronic device receives the input because a user selected a user interface element associated with changing the presentation mode of the content from the second mode of presentation to the first mode of presentation, as previously described above. In some embodiments, in response to receiving the second input (1030b), the electronic device ceases (1032c) displaying the first media user interface. In some embodiments, in response to receiving the second input (1030b), in accordance with a determination that the second media user interface is in a second respective range of poses relative to the second viewpoint of the user, the electronic device presents (1032d) the content in the second media user interface at the third respective location. For example, if the electronic device 101 receives the request to transition playback of TV Show A at FIG. 9C, the location of the user interface 906 does not change because the user interface 906 is currently in the field of view from the user's 922 current viewpoint of the three-dimensional environment. For example, if the request to transition the content from the second mode of presentation to the first mode of presentation is received while the second media user interface (e.g., a user interface of a video player/video application) is in a field of view of the user, the content starts playing in the second media user interface without the location of the second media user interface in the three-dimensional environment changing. In some embodiment, the second respective range of poses relative to the second viewpoint of the user includes all of (or a subset of) of the poses in the three-dimensional environment that are in the user's field of view from the second viewpoint of the user. In some embodiments, in accordance with a determination that that the second media user interface is not in the second respective range of poses relative to the second viewpoint of the user (1032e) (e.g., in some embodiments, the second media user interface is not in the second respective range of poses relative to the second viewpoint of the user if the second media user interface is not at a location in the three-dimensional environment that is in the user's field of view from the second viewpoint), the electronic device displays (1032f) the second media user interface at a fourth respective location, different from the third respective location, in the three-dimensional environment, wherein displaying the second media user interface at the fourth respective location causes the second media user interface to be displayed in a respective pose that is in the second respective range of poses relative to the second viewpoint, wherein the second media user interface includes the content. For example, if the electronic device 101 detects the request to transition playback of TV Show from the picture-in-picture presentation mode to the expanded presentation mode, the electronic device 101 updates the location of the user interface 906 to be within the field of view from the user's current viewpoint of the three-dimensional environment 904 and presents TV Show A at the new location of the user interface 906 in the three-dimensional environment 904. For example, if the request to transition the content from the second mode of presentation to the first mode of presentation is received while the second media user interface (e.g., a user interface of a video player/video application) is not in a user's field of view from the second viewpoint, the location of the media user interface moves to a location that is within the user's field of view from the user's second viewpoint. Moving the location of the second media user interface in the three-dimensional environment if the second user interface is not in a user's field of view provides an efficient way of moving the second media user interface in the user's field of view when a request to present content in the second user interface is received (if the first media user interface is not currently in the user's field of view), thereby reducing cognitive burden on the user when engaging with the second media user interface.

FIGS. 11A-11E illustrate examples of how an electronic device enhances navigation to a respective playback position of a content item in accordance with some embodiments.

FIG. 11A illustrates an electronic device 101 displaying, via a display generation component 120, a three-dimensional environment 1102. It should be understood that, in some embodiments, electronic device 101 utilizes one or more techniques described with reference to FIGS. 11A-11E in a two-dimensional environment without departing from the scope of the disclosure. As described above with reference to FIGS. 1-6, the electronic device 101 optionally includes a display generation component 120 (e.g., a touch screen) and a plurality of image sensors 314. The image sensors optionally include one or more of a visible light camera, an infrared camera, a depth sensor, or any other sensor the electronic device 101 would be able to use to capture one or more images of a user or a part of the user while the user interacts with the electronic device 101. In some embodiments, display generation component 120 is a touch screen that is able to detect gestures and movements of a user's hand. In some embodiments, the user interfaces shown below could also be implemented on a head-mounted display that includes a display generation component that displays the user interface to the user, and sensors to detect the physical environment and/or movements of the user's hands (e.g., external sensors facing outwards from the user), and/or gaze of the user (e.g., internal sensors facing inwards towards the face of the user).

In FIG. 11A, the electronic device 101 presents a content item 1104 in a three-dimensional environment 1102. In some embodiments, the content item 1104 is an item of video content. In addition to the content item 1104, the three-dimensional environment 1102 includes representations of real objects in the physical environment of the electronic device 101, such as a representation 1108a of a wall, a representation 1108b of a ceiling, a representation 1106a of a table, and a representation 1106b of a sofa. The electronic device 101 displays the content item 1104 with increased visual emphasis relative to the rest of the three-dimensional environment 1102, such as displaying regions of the three-dimensional environment 1102 not including the content item 1104 with a greater amount of blur and/or darkening than the content item 1104, and displays virtual lighting effects 1110a-d to simulate a light spill emanating from the content item 1104 according to one or more steps of method 800.

As shown in FIG. 11A, the gaze 1113a of the user is directed to the content item 1104 while the content item plays. The playback position 1106 of the content item 1104 in FIG. 11A advances as playback of the content item continues. In some embodiments, if the user directs their attention away from the content item 1104, the electronic device 101 continues to play the content item. In some embodiments, once the user returns their attention to the content item 1104 after having directed their attention away from the content item 1104, the electronic device 101 presents a selectable option, that, when selected, causes the electronic device 101 to update the playback position to a playback position associated with the playback position playing at the time at which the user directs their attention away from the content item 1104.

For example, in FIG. 11B, the user directs their attention away from the content item 1104 while the playback position 1106 of the content item is the playback position illustrated in the Figure. In some embodiments, detecting the user direct their attention away from the content item 1104 includes detecting the gaze 1113b of the user directed to a location in the three-dimensional environment 1102 other than the content item 1104. In some embodiments, in response to detecting the gaze 1113b of the user directed away from the content item 1104, the electronic device 101 decreases the amount of visual emphasis of the content item 1104 relative to the rest of the three-dimensional environment 1102. In some embodiments, the gaze 1113b of the user has to be directed away from the content item 1104 for a threshold period of time (e.g., 1, 2, 3, 5, 10, 15, 30, or 45 seconds, 1, 2, 3, or 5 minutes) for the electronic device 101 to determine that the user's attention is directed away from the content item 1104. In some embodiments, the instant the user's gaze 1113b is directed away from the content item 1104, the electronic device 101 determines that the user's attention is directed away from the content item 1104. In some embodiments, detecting the user direct their attention away from the content item 1104 includes detecting the user close their eyes, as illustrated in legend 1123, optionally for at least a threshold period of time (e.g., 0.1, 0.2, 0.3, 0.5, 1, 2, 3, 5, 10, 15, 30, or 45 seconds, 1, 2, 3, or 5 minutes) corresponding to the user falling asleep, for example. In some embodiments, the electronic device 101 continues to play the content item 1104 after detecting the attention of the user directed away from the content item 1104, causing the playback position 1106 to advance past the point illustrated in FIG. 11B, which is the playback position of the content item at the time the electronic device 101 determined that the user's attention was directed away from the content item 1104.

FIG. 11C illustrates the electronic device 101 presenting selectable options 1112a and 1112b that, when selected, cause the electronic device 101 to resume playback of the content item 1104 from a playback position 1106 corresponding to the moment the user directed their attention away from the content item 1104. In some embodiments, the electronic device 101 presents selectable option 1112a and/or selectable option 1112b in response to detecting the user's attention directed to the content item 1104 and/or the hand 1103b of the user in the ready state pose. In some embodiments, detecting the user's attention directed to the content item 1104 includes detecting the gaze 1103d of the user directed to the content item 1104. In some embodiments, in response to detecting the gaze 1103d directed to the content item 1104, the electronic device 101 increases the visual emphasis of the content item 1104 relative to the rest of the three-dimensional environment 1102. In some embodiments, detecting the hand 1103b in the ready state pose includes detecting the hand 1103b in a pre-pinch hand shape in which the thumb is within a threshold distance (e.g., 0.1, 0.2, 0.3, 0.5, 1, 2, 3, or 5 centimeters) of, but not touching, another finger of the hand 1103b or detecting the hand 1103b in a pointing hand shape in which one or more fingers are extended and one or more fingers are curled towards the palm. As shown in FIG. 11C, the electronic device 101 also displays options 1114a and 1114b and user interface element 1116 including additional options for modifying playback of the content item 1104 in response to detecting gaze 1103d directed to the content item 1104 and/or the hand 1103b in the ready state pose, as described in more detail above with reference to method 800.

In some embodiments, the electronic device 101 presents both options 1112a and 1112b. In some embodiments, the electronic device 101 presents option 1112a or option 1112b, but not both. Option 1112a is displayed outside of user interface element 1116 overlaid on the content item 1104. Option 1112b is displayed as part of scrubber bar 1111 included in user interface element 1116. The scrubber bar 1111 includes an indication 1113 of the current playback position of the content item 1104 (which optionally continues to play while the options 1112a and/or 1112b are displayed). The electronic device 101 displays option 1112b at a location of scrubber bar 1111 corresponding to the playback position at which playback of the content item 1104 will resume in response to selection of option 1112b. In some embodiments, the playback position at which the playback of the content item 1104 will resume is the playback position at which the user directed their attention away from the content item 1104 in FIG. 11B. In some embodiments, the playback position at which the playback of the content item 1104 will resume is the playback position a predetermined time (e.g., 1, 2, 3, 5, 10, 15, or 30 seconds) before or after the playback position at which the user directed their attention away from the content item 1104 in FIG. 11B.

As shown in FIG. 11C, the user selects option 1112a with gaze 1103c and hand 1103a via an indirect input, for example. In some embodiments, detecting selection of option 1112a via indirect input includes detecting the hand 1103a make a pinch gesture in which the thumb of the hand 1103a touches another finger of the hand while the gaze 1103c is directed to the option 1112a. Although FIG. 11C illustrates a first input state of hand 1103a and gaze 1103d and a second input state of hand 1103b and gaze 1103c, it should be understood that, in some embodiments, these input states are detected at different times. In some embodiments, other selection inputs are possible. As will be described in more detail below with reference to FIG. 11E, in response to detecting selection of option 1112a, the electronic device 101 updates the playback position 1106 of the content item to the playback position associated with the time at which the user directed their attention away from the content item 1104.

FIG. 11D illustrates selection of selectable option 1112b via direct input, for example. In some embodiments, detecting selection of selectable option 1112b via direct input includes detecting the hand 1103a of the user within a predetermined threshold distance of the option 1112b while the hand 1103a is in a predetermined shape. In some embodiments, the predetermined shape is a pinch hand shape in which the thumb touches another finger of the hand. In some embodiments, the predetermined shape is a pointing hand shape in which one or more fingers are extended and one or more fingers are curled towards the palm. In some embodiments, the direct input includes detecting the gaze 1103e of the user directed to the option 1112b and in some embodiments, the direct input does not include detecting the gaze 1103e of the user directed to the option 1112b. In some embodiments, the electronic device 101 detects an indirect input selecting option 1112b similar to the indirect input described above with reference to FIG. 11C or another type of selection input. In response to the input illustrated in FIG. 11D, the electronic device 101 updates the playback position 1106 of the content item 1104 to the playback position associated with the time at which the user directed their attention away from the content item 1104, as shown in FIG. 11E.

FIG. 11E illustrates the electronic device 101 resuming playback of the content item 1104 from the playback position 1106 corresponding to the time at which the user directed their attention away from the content item 1104 in FIG. 11B. In some embodiments, the electronic device 101 updates the playback position 1106 in response to the input illustrated in FIG. 11C. In some embodiments, the electronic device 101 updates the playback position 1106 in response to the input illustrated in FIG. 11D. In some embodiments, the attention (e.g., gaze 1103f) of the user is directed to the content item 1104 and the electronic device 101 visually emphasizes the content item 1104 relative to the rest of the three-dimensional environment 1102 in response to the attention of the user being directed to the content item 1104.

Additional or alternative details regarding the embodiments illustrated in FIGS. 11A-11E are provided below in description of method 1200 described with reference to FIGS. 12A-12C.

FIGS. 12A-12C is a flowchart illustrating a method of enhancing navigation to a respective playback position of a content item in accordance with some embodiments. In some embodiments, the method 1200 is performed at a computer system (e.g., computer system 101 in FIG. 1) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1200 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1200 are, optionally, combined and/or the order of some operations is, optionally, changed.

In some embodiments, such as in FIG. 11A, method 1200 is performed at an electronic device (e.g., 101) in communication with a display generation component (e.g., 120) and one or more input devices (e.g., 314) (e.g., a mobile device (e.g., a tablet, a smartphone, a media player, or a wearable device), or a computer). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, such as in FIG. 11B, while presenting a content item (e.g., 1104) that changes over time (e.g., a video or other media item with a duration) and while displaying, via the display generation component (e.g., 120), a user interface associated with the content item (e.g., 1104) (e.g., such as the user interfaces described with reference to methods 800, 1000 and/or 1400) (1202a), while a playback position (e.g., 1106) within the content item (e.g., 1104) is a first playback position, the electronic device (e.g., 101) detects (1202b), via the one or more input devices (e.g., 314) (e.g., via an eye tracking device), that one or more criteria are satisfied, including a criterion that is satisfied when an attention (e.g., gaze 1113b) of a user of the electronic device is not directed to the user interface associated with the content item (e.g., 1104). In some embodiments, the one or more criteria are satisfied when the user is not paying attention to the content item or has not been paying attention to the content item for at least a predetermined threshold amount of time (e.g., 1, 2, 3, 5, 10, 15, 30, or 60 seconds), and the one or more criteria are not satisfied when the user has been paying attention to the content item for at least the predetermined threshold amount of time. In some embodiments, the one or more criteria include a criterion that is satisfied when the user is looking away from the content item (e.g., based on detecting the location of the user's gaze via an eye tracking device of the one or more input devices) and is satisfied when the user has not been looking at the content item (e.g., based on detecting the location of the user's gaze or that the user's eyes are closed via the eye tracking device) for a predetermined threshold amount of time (e.g., 1, 2, 3, 5, 10, 15, 30, or 60 seconds). In some embodiments, the one or more criteria include a criterion that is satisfied when a predefined portion (e.g., the head) of the user is oriented away from the content item (e.g., based on detecting the orientation of the user's head via a head tracking device of the one or more input devices) and is not satisfied when the predefined portion (e.g., the head) of the user is oriented towards the content item (e.g., based on detecting the orientation of the user's head via the head tracking device) for a predetermined threshold amount of time (e.g., 1, 2, 3, 5, 10, 15, 30, or 60 seconds). In some embodiments, the one or more criteria are satisfied the moment the user's attention is not directed to the content item irrespective of how long the user's attention has been directed away from the content item (e.g., there is no time threshold). In some embodiments, the content item and user interface associated with the content item are displayed in a three dimensional-environment. In some embodiments, the three-dimensional environment includes virtual objects, such as application windows, operating system elements, representations of other users, and/or content items and/or representations of physical objects in the physical environment of the electronic device. In some embodiments, the representations of physical objects are displayed in the three-dimensional environment via the display generation component (e.g., virtual or video passthrough). In some embodiments, the representations of physical objects are views of the physical objects in the physical environment of the electronic device visible through a transparent portion of the display generation component (e.g., true or real passthrough). In some embodiments, the electronic device displays the three-dimensional environment from the viewpoint of the user at a location in the three-dimensional environment corresponding to the physical location of the electronic device in the physical environment of the electronic device. In some embodiments, the three-dimensional environment is generated, displayed, or otherwise caused to be viewable by the device (e.g., a computer-generated reality (XR) environment such as a virtual reality (VR) environment, a mixed reality (MR) environment, or an augmented reality (AR) environment, etc.). In some embodiments, the content item is video content, such as a video clip, an episode in a series of episodic content (e.g., a television show), or a movie. In some embodiments, the user interface associated with the content item includes a plurality of selectable options for modifying playback of the content item (e.g., play/pause, skip ahead, skip back, audio options, subtitle options, picture-in-picture option, full screen/immersive option, etc.).

In some embodiments, such as in FIG. 11C, while presenting a content item (e.g., 1104) that changes over time (e.g., a video or other media item with a duration) and while displaying, via the display generation component (e.g., 120), a user interface associated with the content item (e.g., such as the user interfaces described with reference to methods 800, 1000 and/or 1400) (1202a), after detecting that the one or more criteria are satisfied (e.g., and after having continued playback of the content item since the one or more criteria were not satisfied; in response to detecting that the one or more criteria are not satisfied) (1202c), while the playback position (e.g., 1106) of the content item (e.g., 1104) is a second playback position different from the first playback position (e.g., after having continued playback of the content item since the one or more criteria were not satisfied), the electronic device (e.g., 101) detects (1202d), via the one or more input devices (e.g., 314), that attention (e.g., gaze 1103d) of the user is directed to the user interface associated with the content item (e.g., 1104). In some embodiments, an eye tracking device of the one or more input devices detects that the gaze of the user is directed to the content item. In some embodiments, a head tracking device of the one or more input devices detects that the head of the user is oriented towards the content item.

In some embodiments, such as in FIG. 11C, while presenting a content item (e.g., 1104) that changes over time (e.g., a video or other media item with a duration) and while displaying, via the display generation component (e.g., 120), a user interface associated with the content item (e.g., 704) (e.g., such as the user interfaces described with reference to methods 800, 1000 and/or 1400) (1202a), after detecting that the one or more criteria are satisfied (e.g., and after having continued playback of the content item since the one or more criteria were not satisfied; in response to detecting that the one or more criteria are not satisfied) (1202c), in response to detecting that attention of the user is directed to the user interface associated with the content item (e.g., 1104) after the one or more criteria were satisfied, the electronic device (e.g., 101) displays (1202e), via the display generation component (e.g., 120), a selectable option (e.g., 1112a, 1112b) that, when selected, causes the electronic device (e.g., 101) to present the content item (e.g., 1104) from a respective playback position associated with the first playback position. In some embodiments, the electronic device presents a selectable option that, when selected, causes the electronic device to present the content item from a playback position that is a predetermined time (e.g., 1, 2, 3, 5, 10, or 15 seconds) before or after the first playback position. In some embodiments, the electronic device presents a selectable option that, when selected, causes the electronic device to present the content item from the first playback position. In some embodiments, the first playback position corresponds to the portion of the content item that was playing when the one or more criteria were last not satisfied (e.g., the electronic device detected that the user stopped paying attention to the content item).

In some embodiments, such as in FIG. 11C, while presenting a content item (e.g., 1104) that changes over time (e.g., a video or other media item with a duration) and while displaying, via the display generation component (e.g., 120), a user interface associated with the content item (e.g., such as the user interfaces described with reference to methods 800, 1000 and/or 1400) (1202a), after detecting that the one or more criteria are satisfied (e.g., and after having continued playback of the content item since the one or more criteria were not satisfied; in response to detecting that the one or more criteria are not satisfied) (1202c), while displaying the selectable option (e.g., 1112a, 1112b), the electronic device (e.g., 101) detects (1202f), via the one or more input devices, an input corresponding to selection of the selectable option.

In some embodiments, such as in FIG. 11E, while presenting a content item (e.g., 1104) that changes over time (e.g., a video or other media item with a duration) and while displaying, via the display generation component (e.g., 120), a user interface associated with the content item (e.g., 1104) (e.g., such as the user interfaces described with reference to methods 800, 1000 and/or 1400) (1202a), after detecting that the one or more criteria are satisfied (e.g., and after having continued playback of the content item since the one or more criteria were not satisfied; in response to detecting that the one or more criteria are not satisfied) (1202c), in response to detecting the input, the electronic device (e.g., 101) updates (1202g) the playback position (e.g., 1106) of the content item (e.g., 1104) to the respective playback position associated with the first playback position (e.g., and continuing playback of the content item from the playback position associated with the first playback position).

Resuming playback of the content item from the playback position associated with the first playback position in response to detecting selection of the selectable option displayed in response to detecting that the one or more criteria were satisfied provides an efficient way of continuing playback of the content item from a playback position at which the user stopped paying attention to the content item thereby providing enhanced user interface elements for user interaction.

In some embodiments, such as in FIG. 11B, the one or more criteria include a criterion that is satisfied when the electronic device (e.g., 101) detects, via the one or more input devices (e.g., 314) (e.g., an eye tracking device), that one or more eyes of the user (e.g., 1123) are closed for more than a predefined threshold period of time (e.g., 1, 2, 3, 5, 10, 15, or 30 seconds or 1, 2, 3, 5, or 10 minutes) (1204). In some embodiments, the one or more criteria correspond to the user falling asleep and include a criterion that is satisfied when the user closes one or more eyes for the predefined threshold period of time.

Including a criterion that is satisfied when the user closes one or more eyes for the predefined threshold period of time in the one or more criteria for display of the selectable option provides an efficient way of resuming playback of the content item from a playback position at which the user fell asleep, thereby reducing the time and input needed to resume content playback after falling asleep.

In some embodiments, such as in FIG. 11B, the one or more criteria include a criterion that is satisfied when the electronic device (e.g., 101) detects, via the one or more input devices (e.g., 314) (e.g., an eye tracking device), that a gaze (e.g., 1113b) of the user is directed away from the user interface associated with the content item (e.g., 1104) (e.g., for at least a predetermined time threshold, such as 5, 10, 15, or 30 seconds or 1, 2, 3, 5, or 10 minutes) (1206). In some embodiments, the gaze of the user is directed to another object in the three-dimensional environment. In some embodiments, the gaze of the user is directed away from the display generation component.

Including a criterion that is satisfied when the user looks away from the user interface associated with the content item for the predefined threshold period of time in the one or more criteria for display of the selectable option provides an efficient way of resuming playback of the content item from a playback position at which the user stopped looking at the content item, thereby reducing the time and input needed to resume content playback after looking away.

In some embodiments, such as in FIG. 11C, the user interface (e.g., 1116) associated with the content item (e.g., 1104) includes a scrubber bar (e.g., 1111) that corresponds to playback of the content item (e.g., 1104), and the selectable option (e.g., 1112b) is displayed, via the display generation component (e.g., 120), at a location in the scrubber bar (e.g., 1111) that corresponds to the respective playback position associated with the first playback position (1208). In some embodiments, the scrubber bar includes an indication of the current playback position of the content item that moves as the playback position of the content item progresses during playback. In some embodiments, in response to a user input to move the indication, the electronic device resumes playback of the content item from a playback position corresponding to the location to which the indication was moved. In some embodiments, the selectable option is displayed overlaid on the scrubber bar at a location corresponding to the respective playback position from which playback will resume in response to detecting selection of the selectable option. In some embodiments, the selectable option is displayed in addition to the indication of the current playback position in the scrubber bar.

Presenting the selectable option in the scrubber bar provides an efficient way of indicating to the user the playback position from which content playback will resume in response to detecting selection of the selectable option, thereby reducing cognitive burden on the user when resuming playback of the content item after the attention of the user was directed away from the content item.

In some embodiments, such as in FIG. 11C, detecting that the attention (e.g., gaze 1103d) of the user is directed to the user interface associated with the content item (e.g., 1104) after the one or more criteria were satisfied includes detecting, via the one or more input devices (e.g., a hand tracking device), a predefined portion (e.g., hand 1103b) of the user in a pose that satisfies one or more second criteria (1210a). In some embodiments, the pose that satisfies one or more second criteria includes a pre-pinch hand shape in which the thumb is within a threshold distance (e.g., 0.1, 0.2, 0.5, 1, 2, 3, or 5 centimeters) of another finger of the hand without touching the finger or a pointing hand shape in which one or more fingers are extended and one or more fingers are curled towards the palm.

In some embodiments, after detecting that the one or more criteria are satisfied, in response to detecting that the predefined portion of the user is in a pose that does not satisfy the one or more second criteria (e.g., or not detecting the predefined portion of the user because the predefined portion of the user is outside of a sensing range of the one or more input devices), the electronic device (e.g., 101) forgoes (1210b) display of the selectable option, such as in FIG. 11A. In some embodiments, even if the gaze of the user is directed to the content item, the electronic device does not display the selectable option unless and until the electronic device detects the predefined portion of the user in the pose that satisfies the one or more second criteria. In some embodiments, the electronic device forgoes display of the user interface associated with the content item (while presenting the content item) unless and until the electronic device detects the predefined portion of the user in the pose that satisfies the one or more second criteria according to one or more steps of method 800.

Forgoing display of the selectable option unless and until the electronic device detects the predefined portion of the user in the pose that satisfies the one or more second criteria provides reduced distraction until the user is about to interact with the content item and an efficient way of facilitating interaction with the content item when the user is ready to interact, thereby reducing cognitive burden on the user through enhanced display of the user interface.

In some embodiments, such as in FIG. 11C, in response to detecting that the attention (e.g., gaze 1103d) of the user is directed to the user interface associated with the content item (e.g., 1104) after the one or more criteria were satisfied, concurrently displaying via the display generation component (e.g., 120) one or more selectable elements (e.g., in user interface element 1116) for controlling playback of the content item with the selectable option (e.g., 1112a, 1112b) (1212). In some embodiments, detecting that the attention of the user is directed to the user interface associated with the content item includes detecting the predefined portion (e.g., hand) of the user in a pose that satisfies one or more criteria, as described in more detail above. In some embodiments, the one or more selectable elements include options for playing, pausing, skipping ahead, or skipping back in the content item, options to view subtitle or audio options for the content item, an option to toggle virtual lighting effects according to one or more steps of method 800, an option to toggle presentation of the content item in a picture-in-picture element according to one or more steps of method 1000, and an option to toggle presenting the content item in an immersive mode according to one or more steps of method 1400. In some embodiments, the one or more selectable elements are presented in a user interface element (e.g., container, window, platter, etc.). In some embodiments, the selectable option is presented in the user interface element. In some embodiments, the selectable option is presented outside of the user interface element.

Concurrently displaying the one or more selectable elements with the selectable option in response to the attention of the user being directed to the user interface associated with the content item provides an efficient way of facilitating a plurality of possible user interactions with the content item, thereby reducing the time and number of inputs to interact with the content item when the user's attention returns to the content item.

In some embodiments, such as in FIG. 11C, while displaying the selectable option (e.g., 1112a) and before detecting the selection of the selectable option (e.g., 1112a), the electronic device (e.g., 101) continues (1214) to play the content item (e.g., 1104) from the second playback position. In some embodiments, the playback position of the content item continues to advance but the selectable option remains associated with the respective playback position. In some embodiments, in response to an input to pause the content item that is received while the selectable option is displayed, the electronic device pauses the content item and continues to display the selectable option. In some embodiments, in response to an input to pause the content item that is received while the selectable option is displayed, the electronic device pauses the content item and ceases display of the selectable option.

Continuing to play the content while displaying the selectable option provides an efficient way of presenting the content item when the user's attention returns to the content item without requiring additional input to do so, thereby enabling the user to use the electronic device quickly and efficiently.

In some embodiments, such as in FIG. 11D, detecting the input corresponding to selection of the selectable option (e.g., 1112b) includes detecting, via the one or more input devices (e.g., 314) (e.g., an eye tracking device), a gaze (e.g., 1103e) of the user directed to the selectable option (e.g., 1112b) while a predefined portion (e.g., a hand 1103a) of the user performs a respective gesture (1218). In some embodiments, the respective gesture is a pinch gesture in which the user touches the thumb of the hand to another finger of the hand. In some embodiments, the respective gesture is a tap gesture in which the user touches a finger of the hand to a location corresponding to a respective user interface element (e.g., the selectable option or an input user interface element other than the selectable option).

Selecting the selectable option in response to detecting the gaze of the user directed to the option while the predefined portion of the user performs the respective gesture provides an efficient way of facilitating user interaction with the selectable option, thereby reducing the time and cognitive burden needed to provide inputs to the electronic device.

FIGS. 13A-13E illustrate exemplary ways of presenting media content in an immersive and non-immersive presentation mode in accordance with some embodiments of the disclosure.

FIG. 13A illustrates a three-dimensional environment 1304 that is being displayed by the display generation component 120 of the electronic device 101 and an overhead view 1327 of the three-dimensional environment 1304. As described above with reference to FIGS. 1-6, the electronic device 101 optionally includes a display generation component (e.g., a touch screen) and a plurality of image sensors (e.g., image sensors 314 of FIG. 3). The image sensors optionally include one or more of a visible light camera, an infrared camera, a depth sensor, or any other sensor the electronic device 101 would be able to use to capture one or more images of a user or a part of the user while the user interacts with the electronic device 101. In some embodiments, the user interfaces shown below could also be implemented on a head-mounted display that includes a display generation component that displays the user interface to the user and sensors to detect the physical environment, movements of the user's hands (e.g., external sensors facing outwards from the user), and/or gaze of the user (e.g., internal sensors facing inwards towards the face of the user).

In FIG. 13A, the electronic device 101 is displaying a three-dimensional environment 1304 that includes a media user interface 1306, a playback controls user interface 1312, a representation 1308 of a first wall photo (a physical object in physical environment 1302), a representation 1310 of a second wall photo (a physical object in physical environment 1302), a representation 1314 of a coffee table (a physical object in physical environment 1302), and a representation 1324 of a desk (a physical object in physical environment 1302). In some embodiments, the user interfaces 1306 and 1312 and the representations 1308, 1310, 1314, and 1324 are being displayed by the electronic device 101 because these objects are in a field of view from the user's 1322 current viewpoint of the three-dimensional environment 1304.

For example, as shown in overhead view 1327 in FIG. 13A, the user 1322 is currently viewing the three-dimensional environment 1304 from a position that corresponds to the center of the three-dimensional environment 1304 and with a pose that is oriented towards the back of the three-dimensional environment 1304. For ease of description in the remaining parts of the disclosure, the position/pose from which the user 1322 is viewing the three-dimensional environment 1304 will be referred to as the user's 1322 current viewpoint of the three-dimensional environment 1304, or more simply, the user's 1322 viewpoint indicated in overhead view 1327. Accordingly, the electronic device 101 displays, via the display generation component 120, the representations 1308, 1310, 1314, and 1324 and the user interfaces 1306 and 1312 because these objects are in the field of view from the user's current viewpoint of the three-dimensional environment 1304. Conversely, the electronic device 101 is not displaying, via the display generation component 120, the representation 1325 of a sofa (a physical object in physical environment 1302), the representation 1328 of a corner table (a physical object in physical environment 1302), and the user interfaces 1326 and 1330 because these objects are not in the field of view from the user's current viewpoint of the three-dimensional environment 1304.

In some embodiments, the user's 1322 viewpoint of the three-dimensional environment 1304 corresponds to the physical location of the user 1322 in a physical environment 1302 of the electronic device 101 (e.g., operating environment 100). For example, the user's 1322 viewpoint is optionally the viewpoint illustrated in overhead view 1327 because the user 1322 is currently oriented towards a back wall in the physical environment 1302 and is located in the center of physical environment 1302 while holding the electronic device 101 (e.g., or wearing device 101 if device 101 were a head-mounted device).

As shown in FIG. 13A, the media user interface 1306 is currently presenting media item 1323 (e.g., a TV Show, movie, live sports game, etc.). In some embodiments, as will be described in greater detail below, the electronic device 101 can present the media item 1323 in an immersive presentation mode and in a non-immersive presentation. In the example, illustrated in FIG. 13A, the electronic device 101 is presenting media item 1323 in a non-immersive presentation mode. In some embodiments, when the media item 1323 is being presented in the non-immersive presentation mode, the media user interface 1306 defines a boundary in an X, Y, and/or Z direction within which portions of the media item 1323 are displayed. In some embodiments, one or more portions of the media item 1323 are not displayed while the content is being presented in the non-immersive presentation mode. For example, in FIG. 13A, the user interface 1306 is presenting a portion of the media item 1323 that includes a first object 1318 (e.g., a soccer goal) and a second object 1320 (e.g., a soccer ball), but the media item 1323 may also include other portions that are not being displayed at the user interface 1306 (e.g., such as portions of the media item 1323 that include the opponent's soccer goal, additional parts of the soccer field, representations of fans watching the soccer game, etc.).

In some embodiments, the media item 1323 is optionally presented as two-dimensional content during the non-immersive presentation mode. For example, while the electronic device is presenting the media item 1323 in the non-immersive presentation mode, the media item 1323 (including the first object 1318 and the second object 1320) may be displayed in a plane that does not extend beyond the X and/or Y boundaries defined by the media user interface 1306. Conversely, in some embodiments, the media item 1323 is optionally presented as three-dimensional content during the non-immersive presentation mode. For example, while the electronic device is presenting the media item 1323 in the non-immersive presentation mode, the media item 1323 (including the first object 1318 and the second object 1320) may be displayed as three-dimensional content within the X, Y, and/or Z boundaries defined by the media user interface 1306. In some embodiments, the size of the media item 1323 (and the size of the objects of media item 1323) during the non-immersive presentation mode are defined by the content creator of media item 1323 and/or are scaled to fit within the boundaries defined by the media user interface 1306.

In some embodiments, when the media item 1323 is being presented in the non-immersive presentation mode, the media user interface 1306 occupies less than a threshold amount of space in the user's field of view (e.g., less than 75%, 60%, 50%, 40%, 30%, 20%, 10%, or 5% of space in the user's field of view). For example, as shown in FIG. 13A, the media user interface object 1306 is occupying less than the above-mentioned threshold amount of space in the user's field of view, and as a result, other portions of the three-dimensional environment 1304 are not being occluded/obscured by the media user interface 1306 in the user's field of view.

As also shown in overhead view 1327, the electronic device 101 is displaying, in the three-dimensional environment 1304, the playback controls user interface 1312 at a location indicated in overhead view 1327. In some embodiments, the electronic device 101 displays the playback controls user interface 1312 at the location indicated in overhead view 1327 because of (e.g., based on) a location of a corresponding media user interface in the three-dimensional environment 1304 (e.g., media user interface 1306). For example, the electronic device 101 is displaying the playback controls user interface 1312 at the location in the three-dimensional environment 1304 indicated in overhead view 1327 because that location is at or within a threshold distance (e.g., 0.5, 1, 3, 5, 7, 15, 30, 90, 100, or 500 inches) of the media user interface 1306 (e.g., the media user interface to which it corresponds).

In some embodiments, the playback controls user interface 1312 is being displayed in the three-dimensional environment 1304 in response to the electronic device 101 detecting a request to display the playback controls user interface 1312. In some embodiments, detecting the request to display the playback controls user interface 1312 includes detecting that the user's gaze was directed towards media user interface 1306 while the hand 1331 of the user 1322 was in a “pointing” pose (e.g., one or more fingers of hand 1331 are extended and one or more fingers of hand 1331 are curled towards the palm of hand 1331) or in “pre-pinch” pose (e.g., the thumb of hand 1331 is within a threshold distance (e.g., 0.1, 0.2, 0.3, 0.5, 1, 2, 3, or 5 centimeters) of, but not touching, another finger of the hand 1331). Additionally, in some embodiments, the playback controls user interface 1312 and the media user interface 1306 are displayed at different viewing angles relative to the user's viewpoint of the three-dimensional environment 1304. For example, as shown in the side view 1333 of the three-dimensional environment 1304, the electronic device 101 is displaying the media user interface 1306 normal to the user's viewpoint of the three-dimensional environment 1304, and the playback controls user interface 1312 is angled (e.g., tilted) upwards relative to the user's viewpoint of the three-dimensional environment 1304. Additionally, as illustrated in side view 1333, electronic device 101 optionally displays the playback controls user interface 1312 at a lower height in the three-dimensional environment 1304 than the media user interface 1306, as will be described in more detail below.

As also shown in FIG. 13A, the playback controls user interface 1312 includes user interface elements 1312a-1312j. The user interface element 1312a, when selected, causes the electronic device 101 to present the media item 1323 in an immersive presentation mode (as will be described in FIGS. 13C and 13D). In some embodiments, the user interface element 1312a is displayed when the electronic device 101 is able to display the media item 1323 in the immersive presentation mode (e.g., the media item 1323 is capable of being presented in three-dimensions), and is not displayed when the media item 1323 cannot be presented in the immersive presentation (e.g., the media item 1323 is not capable of being presented in three-dimensions). The user interface element 1312b, when selected, causes the electronic device 101 to display the media item 1323 in a picture-in-picture presentation mode, as described in FIGS. 9A-9E and method 1000. The user interface element 1312c, when selected, causes the electronic device 101 to replace the content being presented in user interface 1306 with a content playback queue that includes one or more representations of content items that, when selected, cause a corresponding content item to playback. The user interface element 1312d, when selected, causes the electronic device 101 to rewind media item 1323 by a predetermined amount (e.g., by 10, 15, 20, 30, 40, or 60 seconds). The user interface element 1312e, when selected, causes the electronic device 101 to pause playback of the media item 1323 (e.g., if media item 1323 is currently playing in media user interface 1306) or start playback of the media item 1323 (e.g., if media item 1323 is currently paused in media user interface 1306). The user interface element 1312e, when selected, causes the electronic device to fast forward media item 1323 by a predetermined amount (e.g., by 10, 15, 20, 30, 40, or 60 seconds). The user interface element 1312g, when selected, causes the electronic device 101 to display a subtitles menu associated with media item 1323. The user interface element 1312h, when selected, causes the electronic device 101 to adjust the virtual lighting effects of the three-dimensional environment 1304, as described in method 800. The user interface element 908i, when selected, causes the electronic device 101 to modify the playback volume of media item 1323. Lastly, as illustrated in FIG. 13A, the playback controls user interface 1312 also includes a scrubber bar 1312j that includes a visual indication 1312k of the current scrubbing position in the scrubber bar 1312j.

Additionally, as shown in FIG. 13A, the scrubber bar 1312j has been scrubbed from a previous scrubbing position (indicated by the dashed vertical line) to a new scrubbing position (indicated by visual indication 1312k). In some embodiments, the electronic device 101 detected the request to scrub from the previous scrubbing position to the new scrubbing position because the hand 1331 selected (e.g., with the “pointing” pose or “pinching” pose, as described above) the visual indication 1312k while the visual indication 1312k was displayed at the previous scrubbing position, and after selecting the visual indication 1312k (and optionally while maintaining the pose used to select visual indication 1312k), the hand 1331 physically moved to a location corresponding to the current scrubbing position indicated by visual indication 1312k. Although FIG. 13A illustrates the user's hand 1331 moving to the right after the selection of visual indication 1312k, it is understood than when the user's hand moves to the left, the media item 1322 may be scrubbed in an analogous manner (but with the scrubbing position being moved backwards in time).

In some embodiments, if electronic device 101 is presenting the media item 1322 in the non-immersive presentation mode when the scrubber bar 1312j is being scrubbed, the media user interface 1306 is updated (e.g., in real time) to correspond to the current scrubbing position in the scrubber bar 1312j. For example, in FIG. 13A, the electronic device 101 is presenting the first object 1318 and the second object 1320 of the media item 1323 (e.g., content of media item 1323) because this content corresponds to the current scrubbing position in the scrubber bar 1312j (indicated by visual indication 1312k). If the electronic device 101 detected further movement of the scrubbing position at the scrubber bar 1312j (e.g., was scrubbed forwards or backwards from the scrubbing position indicated at visual indication 1312k), it is understood that the electronic device 101 would update the media user interface 1306 with content of the media item 1323 that corresponds to the updated scrubbing position in the scrubber bar 1312j.

In FIG. 13B, the electronic device 101 has detected that the user's viewpoint of the three-dimensional environment 1304 has moved from the viewpoint indicated in FIG. 13A to the viewpoint indicated in FIG. 13B. In some embodiments, the user's viewpoint of the three-dimensional 1304 moved to the viewpoint indicated in FIG. 13B because the user 1322 moved to a corresponding pose and/or location in the physical environment 1302. In response to detecting that the user's viewpoint of the three-dimensional environment 1304 has moved to the viewpoint indicated in FIG. 13B, the electronic device 101 displays the three-dimensional environment 1304 from the user's new viewpoint of the three-dimensional environment 1304. In particular, the display generation component 120 of device 101 is now displaying the user interfaces 1326 and 1330 and the representations 1325 and 1328 because these objects are now in the field of view from the user's viewpoint indicated in FIG. 13B.

In some embodiments, if a media item is being presented in a non-immersive presentation, the locations of associated media user interface(s) and/or playback controls user interface(s) do not change in the three-dimensional environment 1304 as the user's viewpoint of the three-dimensional 1104 changes. For example, because media item 1323 was being presented in the non-immersive presentation mode when the user's 1322 viewpoint of the three-dimensional environment 1304 moved from the viewpoint illustrated in overhead view 1327 in FIG. 13A to the viewpoint illustrated in overhead view 1327 in FIG. 13B, the locations of media user interface 1306 and playback controls user interface 1312 in the three-dimensional environment 1304 did not change (as indicated in overhead view 1327 in FIGS. 13A and 13B).

FIG. 13C illustrates the electronic device 101 presenting media item 1323 in an immersive presentation mode. In some embodiments, the electronic device 101 is displaying the media 1323 in the immersive presentation mode because the electronic device detected a selection of the user interface element 1312a in FIG. 13A (e.g., selection of user interface element 1312a with the “pointing” or “pinching” pose while the gaze 1334 of the user 1322 was directed towards the user interface element 1312a).

In some embodiments, during the immersive presentation mode, the media item 1323 occupies a larger amount of space in the three-dimensional 1304 as compared to the presentation of the media item 1323 in the non-immersive presentation mode. For example, in FIG. 13C, in response to receiving the request to transition presentation of the media item 1323 from the non-immersive presentation mode to the immersive presentation mode, the electronic device 101 expands the media item 1323 to occupy portions outside of the boundaries of media user interface 1306 and span 180 degrees (or 90, 120, 150, 210, 240, 270, 300, 330 or 360 degrees) of space around the user's current viewpoint of the three-dimensional environment 1304. In some embodiments, during the immersive presentation mode, the media item 1323 expands beyond the boundaries of the physical environment 1302 and replaces portions of the three-dimensional environment 1304 with portions of the media item 1323, as indicated in overhead view 1327. Although the media item 1323 in FIG. 13C is illustrated as occupying 180 degrees of space around the user's viewpoint of the three-dimensional environment 1304, it is understood that the media item 1323 could optionally surround 45, 90, 125, 250, or 360 degrees of space around the user's viewpoint. It is also understood, as the playback of media item 1323 advances, new objects of the media item 1323 may be presented in the three-dimensional environment 1304 in addition to the objects currently being displayed or as a replacement for the objects currently being displayed.

Accordingly, because the media item 1323 optionally spans 180 degrees around the user's viewpoint of the three-dimensional environment 1304 during presentation of the media item 1323 in the immersive presentation mode, the media item 1323 optionally extends to one or more edges (e.g., boundaries) in the field of view of the user's current viewpoint of the three-dimensional environment 1304, and also optionally occupies portions of the three-dimensional environment 1304 that are not in the field of view of the user's current viewpoint of the three-dimensional environment 1304.

In some embodiments, during the immersive presentation mode, one or more portions of the media item 1323 that were not presented in the three-dimensional environment 1304 during the non-immersive presentation mode are presented during the immersive presentation mode. For example, as indicated in overhead view 1327, the three-dimensional environment 1304 now includes portions of the media item 1323 that include a third object 1332 and a fourth object 1341 (which were not being presented in the three-dimensional environment 1304 during the non-immersive presentation mode as shown in FIG. 13A). In some embodiments, during the immersive presentation mode, the portions of the media item 1323 are no longer scaled to fit within the boundaries of the media user interface and are displayed with a larger length, width, and/or depth. For example, during the immersive presentation mode, the portions/objects of the media item 1323 (e.g., such as the first object 1318 (e.g., soccer goal) and the second object 1320 (e.g., soccer ball)) are optionally increased in size when compared to the non-immersive presentation mode in FIG. 13A, are optionally displayed with “life-size” dimensions and/or are displayed at different locations relative to the viewpoint of user 1322 (e.g., closer to the viewpoint, or further from the viewpoint). In some embodiments, the size of objects and the spatial arrangement of the objects during the immersive presentation mode is defined by a content creator of the media item 1323.

Additionally, in FIG. 13C, the electronic device 101 detects that the user's hand 1331 is in the “pointing” pose. In response to the electronic device 101 detecting that the user's hand 1331 is in the “pointing” pose, the electronic device displays the playback controls user interface 1312 (as illustrated in FIG. 13C). In some embodiments, the electronic device 101 may also display the playback controls user interface 1312 when the electronic device 101 detects that the user's hand 1331 is in the “pre-pinch” pose.

In some embodiments, the user interface elements 1312a-1312j perform different functions during the immersive presentation when compared to the non-immersive presentation mode. For example, when the user interface element 1312a is selected during the immersive presentation mode, the electronic device 101 optionally transitions presentation of the media item 1323 from the immersive presentation mode (as illustrated in FIG. 13C) to the non-immersive presentation mode (as illustrated in FIG. 13A). The user interface elements 1312b-1312j during the immersive presentation optionally have one or more similar characteristics as described previously with respect to the non-immersive presentation mode in FIG. 13A.

In some embodiments, during the immersive presentation mode, the playback controls user interface 1312 is displayed closer to the viewpoint of the user than compared to the non-immersive presentation mode. For example, in FIGS. 13A and 13C, the user's viewpoint of the three-dimensional 1304 environment is equivalent. However, during the immersive presentation mode in FIG. 13C, the playback controls user interface 1312 is displayed at a location in the three-dimensional environment 1304 (as indicated in the overhead view 1327 in FIG. 13C) that is closer to the user's viewpoint than the location of the playback controls user interface 1312 during the non-immersive presentation mode in FIG. 13A (indicated in the overhead view 1327 in FIG. 13A).

In some embodiments, during the immersive presentation mode, the playback controls user interface 1312 is displayed at a location in three-dimensional environment 1304 based on the user's viewpoint of the three-dimensional environment 1304 (e.g., and not based on the location of a media user interface that is presenting the media item in the non-immersive presentation mode). For example, in FIG. 13C, the electronic device 101 is optionally displaying the playback controls user interface 1312 at the location indicated in overhead view 1327 because that location corresponds to a predetermined portion in the field of view (e.g., a predetermined orientation) from the user's current viewpoint of the three-dimensional environment 1327 (e.g., bottom-center, bottom-right, top-right, top-left, etc.) and/or because that location is a threshold distance (e.g., 0.1, 0.2, 0.5, 1, 1.5, 2, 4, or 8 feet) from the user's current viewpoint of the three-dimensional environment 1304.

In some embodiments, while the electronic device 101 is presenting a media item in the immersive presentation mode, the electronic device 101 optionally displays different portions of the media item 1323 as the user's viewpoint of the three-dimensional environment 1304 changes. For example, in FIG. 13D, the user's viewpoint of the three-dimensional environment 1304 has moved from the viewpoint illustrated in overhead view 1327 in FIG. 13C to the viewpoint illustrated in overhead view 1327 in FIG. 13D. In some embodiments, the user's viewpoint of the three-dimensional environment 1304 moved to the viewpoint indicated in FIG. 13D because the user 1322 rotated (e.g., optionally concurrently with the electronic device 101) in the physical environment 1302 from the pose indicated in overhead view 1327 in FIG. 13C to the pose indicated in overhead view 1327 in FIG. 13D. As a result of the movement of the user's viewpoint in the three-dimensional environment 1304, the electronic device 101 displays portions of the three-dimensional environment 1304 and media item 1323 that are now in the field of view from the user's current viewpoint of the three-dimensional environment 1304.

In particular, the display generation component 120 is now presenting a portion of the media item 1323 that includes a third object 1344 (a stadium) and a fourth object 1346 (a corner flag) and portions of the three-dimensional environment 1304 outside of media item 1323 because these portions are now in the field of view from the user's viewpoint of the three-dimensional environment 1304 indicated in overhead view 1327. The portion of the media item 1323 including the first object 1318 and the second object 1320 is no longer displayed via the display generation component 120 because these objects are optionally no longer in the field of view of the user 1322 from the user's current viewpoint of the three-dimensional environment 1304, as indicated in overhead view 1327 in FIG. 13D. As mentioned before, in some embodiments, the third object 1344 and fourth object 1346 are displayed as three-dimensional content during the immersive presentation mode and/or are optionally displayed with “real-life” dimensions. It should be understood that if the media item 1323 occupied 360 degrees of space around the user's viewpoint of the three-dimensional environment 1304 in FIG. 13C instead of 180 degrees of space as illustrated in FIG. 13C, portions of the three-dimensional environment 1304 outside of media item 1323 would optionally not be displayed when the user's viewpoint moved to the viewpoint indicated in FIG. 13D,

In some embodiments, representations of the physical environment 1302 in the three-dimensional environment 1304 are visually deemphasized while the electronic device is presenting media item 1323 in the immersive presentation mode. For example, in FIG. 13D, because the electronic device 101 is presenting media item 1323 in the immersive presentation mode, the representations of the sofa 1324 and of the walls in the physical environment 1302 are optionally less opaque, more transparent, displayed with less contrast, and/or displayed with less color during the immersive presentation mode than if these representations were being displayed while the media item 1323 was being presented in the non-immersive presentation mode.

FIG. 13D also illustrates the electronic device 101 receiving a request to scrub the media item 1323 from a previous scrubbing position (indicated by the dashed vertical line in scrubber bar 1312j) to the current scrubbing location (indicated by visual indication 1312k). In some embodiments, the electronic device 101 received the request to scrub to the scrubbing position indicated in FIG. 13D because the electronic device 101 detected that hand 1331 selected (e.g., with the “pointing” or “pinching” pose described previously) the visual indication 1312k (e.g., when it was displayed at the location indicated by the dashed vertical line), and because the hand 1331 subsequently moved to a location corresponding to the scrubbing position indicated by visual indication 1312k.

In some embodiments, the electronic device pauses the playback of media item 1323 while the media item 1323 is being scrubbed in the immersive presentation mode. For example, in FIG. 13D, because the electronic device 101 received the request to scrub the media item 1323 from a previous scrubbing position (indicated by the dashed vertical line) to the current scrubbing location (indicated by visual indication 1312k), the electronic device 101 has paused playback of media item 1323 (indicated by the visual appearance of user interface element 1312e changing from the “paused” state to the “play” state to indicate that selection of 1312e will now cause the electronic device to start playing media item 1323).

Additionally, while the media item 1323 is being scrubbed in the immersive presentation mode, the electronic device 101 optionally displays a (e.g., still photo or video) preview 1346 of content in the media item 1323 that corresponds to the current scrubbing position in the scrubber bar 1312j (indicated by the visual indication 1312k). As the scrubbing position in the scrubber bar 1312k changes in accordance with the (e.g., speed, distance, direction, etc. of the) movement of the hand 1331, the content displayed in the preview 1346 optionally changes to correspond with the current scrubbing position in the scrubber bar 1312k. In some embodiments, the larger view of media item 1323 being displayed in the immersive mode is not changed during the scrubbing described above.

In some embodiments, when the electronic device 101 detects the end of the scrubbing request, the electronic device 101 starts playback of media item 1223 at the playback position where the media item 1323 was scrubbed to in scrubber bar 1312j. For example, in FIG. 13D, after receiving the request to scrub the media item 1323 to the scrubbing position indicated by visual indication 1312k, the electronic device 101 optionally starts playback of the media item 1323 from the scrubbing position indicated by visual indication 1312k when the electronic device 101 detects that hand 1331 is in a “de-selection” pose. Device 101 optionally starts playback of the media item 1323 within the larger view of media item 1323 being displayed in the immersive mode. In some embodiments, the electronic device 101 detects that hand 1331 is in the “de-selection” pose when the thumb of hand 1331 moves a threshold distance away from another finger of hand 1331 (e.g., 0.1, 0.2, 0.3, 0.5, 1, 2, 3 or 5 centimeters) after having been within the above mentioned threshold distance and/or the electronic device 101 detects that hand 1331 is no longer in the “pointing” pose after having previously been in the “pointing” pose.

In some embodiments, during the non-immersive presentation mode, the portions of the media item 1323 that are presented in media user interface 1306 are based on the user's viewpoint of the three-dimensional environment 1304. For example, in FIG. 13E, while media item 1323 is being presented in the non-immersive presentation mode, the user's 1322 viewpoint has moved from the viewpoint indicated in FIG. 13A to the viewpoint indicated in FIG. 13E. As a result of the movement of the user's viewpoint in the three-dimensional environment 1304, the media item 1323 is displayed based on the user's new viewpoint of the three-dimensional environment 1304 (e.g., from the viewpoint indicated in overhead view 1327). Specifically, because the user 1322 is now viewing the media item 1323 from the viewpoint indicated in overhead view 1327 in FIG. 13E, more portions of the media item 1323 that are to the left of the portions of the media item 1323 illustrated in FIG. 13A are now displayed in user interface 1306. Conversely, because the user 1322 is now viewing the media item 1323 from the viewpoint indicated in overhead view 1327 in FIG. 13E, less portions of the media item 1323 that are to the right of the portions of the media item 1323 illustrated in FIG. 13A are now displayed in media user interface 1306. It is understood, if the user's viewpoint of the three-dimensional environment 1304 moves from the viewpoint indicated in FIG. 13E to the viewpoint indicated in FIG. 13A, the portions of the media item 1323 displayed in user interface 1306 would optionally revert to those shown in FIG. 13A (if the playback position of the media item 1323 did not change (e.g., media item 1323 was paused)). In some embodiments, the orientation of the playback controls user interface 1312 is based on the user's 1322 viewpoint of the three-dimensional environment 1304. For example, as shown in overhead view 1327 in FIGS. 13A and 13E, even though the electronic device 101 is displaying the three-dimensional environment from different viewpoints of the three-dimensional environment 1304 (as described previously), the playback controls user interface 1312 remains oriented towards the user's 1322 viewpoint of the three-dimensional environment 1304. Thus, as the user's 1322 viewpoint of the three-dimensional environment 1304 moves, the electronic device 101 optionally updates the orientation of the playback controls user interface 1312 such that the playback controls user interface 1312 is oriented towards the user's 1322 viewpoint of the three-dimensional environment.

Additional or alternative details regarding the embodiments illustrated in FIGS. 13A-13E are provided below in description of method 1400 described with reference to FIGS. 14A-14J.

FIGS. 14A-14J is a flowchart illustrating a method of presenting media content in an immersive and non-immersive presentation mode in accordance with some embodiments. In some embodiments, the method 1400 is performed at a computer system (e.g., computer system 101 in FIG. 1) including a display generation component (e.g., display generation component 120 in FIGS. 1, 3, and 4) (e.g., a heads-up display, a display, a touchscreen, a projector, etc.) and one or more cameras (e.g., a camera (e.g., color sensors, infrared sensors, and other depth-sensing cameras) that points downward at a user's hand or a camera that points forward from the user's head). In some embodiments, the method 1400 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 1400 are, optionally, combined and/or the order of some operations is, optionally, changed.

In some embodiments, method 1400 is performed at an electronic device in communication with a display generation component and one or more input devices (e.g., a mobile device (e.g., a tablet, a smartphone, a media player, or a wearable device), or a computer). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, the one or more input devices include an electronic device or component capable of receiving a user input (e.g., capturing a user input, detecting a user input, etc.) and transmitting information associated with the user input to the electronic device. Examples of input devices include a touch screen, mouse (e.g., external), trackpad (optionally integrated or external), touchpad (optionally integrated or external), remote control device (e.g., external), another mobile device (e.g., separate from the electronic device), a handheld device (e.g., external), a controller (e.g., external), a camera, a depth sensor, an eye tracking device, and/or a motion sensor (e.g., a hand tracking device, a hand motion sensor), etc. In some embodiments, the electronic device is in communication with a hand tracking device (e.g., one or more cameras, depth sensors, proximity sensors, touch sensors (e.g., a touch screen, trackpad). In some embodiments, the hand tracking device is a wearable device, such as a smart glove. In some embodiments, the hand tracking device is a handheld input device, such as a remote control or stylus.

In some embodiments, the electronic device displays (1402), via the display generation component, a three-dimensional environment (e.g., the three-dimensional environment is a computer-generated reality (XR) environment, such as a virtual reality (VR) environment, a mixed reality (MR) environment, or an augmented reality (AR) environment, etc.), including in accordance with a determination that one or more criteria are satisfied, concurrently displaying a media user interface object (e.g., such as a video player or multi-media application) that includes a first content item being presented in a first (e.g., non-immersive) presentation mode (e.g., a mode of presentation that causes the media user interface to present the first content item in two-dimensions (e.g., does not occupy space in the three-dimensional environment, that is displayed in the X and Y dimensions but not the Z dimension, etc.) or three-dimensions (e.g., occupies space in the three-dimensional environment, is displayed in the X, Y, and Z dimensions, etc.) and a first user interface element for transitioning presentation of the first content item to a second presentation mode, wherein the one or more criteria include a requirement that the first content includes immersive content, wherein during presentation of the first content item in the first (e.g., non-immersive) presentation mode, the first content item occupies a first portion of a field of view from a viewpoint of a user of the electronic device while a second portion of the field of view from the viewpoint of the user is occupied by other elements of the three-dimensional environment (1402b) (e.g., while the first content item is in the user's field of view, the user's field of view also includes other content that is not hidden/obscured by the media user interface object). For example, in FIG. 13A, because media item 1323 is immersive content, the electronic device 101 concurrently displays the user interface 1306 and the selectable option 1312a.

For example, in some embodiments, the one or more criteria are satisfied when the first content item is a first type of content (e.g., a type of media content that is immersive, such as media content that includes three-dimensional information and/or is capable of being displayed in three-dimensions), and is not satisfied if the first content item is not the first type of content (e.g., is not a type of media content that is immersive, such as being two-dimensional content). In some embodiments, the first user interface element is displayed if the electronic device detects that the user's gaze is directed towards the media user interface object, and is not displayed if the electronic device does not detect that that the user's gaze is directed towards the media user interface (e.g., detects that the user's gaze is directed outside of the media user interface object). In some embodiments, the first user interface element is displayed if the electronic device detects that the user's gaze is directed towards the media user interface object while a hand of the user is performing a start of a pinch gesture. In some embodiments, the first user interface element is displayed in a playback controls user interface that is displayed separate from the media user interface object. In some embodiments, the playback controls user interface is displayed below the media user interface object. In some embodiments, the playback controls user interface includes additional user interface elements for modifying playback of the first content item, including user interface elements for playing the first content item, pausing the first content item, fast forwarding the first content item, rewinding the first content item, and/or for modifying display of subtitles and/or audio associated with the first content item. In some embodiments, the media user interface object is presenting playing or paused audio and/or video content. In some embodiments, the media user interface object is presenting movie content, a TV show, a video clip, a (e.g., live) sports game, etc. In some embodiments, if the first content item corresponds to two-dimensional content, the media user interface object is presenting the first content item in a planar fashion, such that elements/features of the first content item are displayed within a plane and do not occupy space outside of the plane in the three-dimensional environment. In some embodiments, if the first content item includes three-dimensional (3-D) content, the media user interface object displays elements/features of the first content item in a three-dimensional manner in accordance with a viewing size characteristic (e.g., constraint) defined by the media user interface object. In some embodiments, if the first content item is being presented in the first presentation mode, the first content item is displayed in a rectangular (e.g., planar) viewing area (or a cube or rectangular or other concave 3-D volume if the first content item includes 3-D content).

In some embodiments, if the user's viewpoint of the three-dimensional environment changes (e.g., if the electronic device and/or display generation component becomes oriented towards a new location in the physical environment) while the first content item is being presented in the first mode of presentation, the media user interface object and/or the first content item is optionally no longer in the user's field of view from the user's new viewpoint of the three-dimensional environment. In some embodiments, if the first content corresponds to three-dimensional content, the elements/features included in the first content item have a size, depth, and/or dimension larger than a size, depth, and/or dimension of the media user interface object. In some such embodiments, a (e.g., three-dimensional) portion/area of the first content item that satisfies viewing size criteria of the media user interface object (e.g., satisfies a size, depth, and/or dimension constraint of the media user interface object) is presented in the media user interface object. For example, a portion/area/volume of the first content item is selected for display in the media user interface object if that portion/area/volume of the first content item can be displayed within the constraints (e.g., size constraints) defined by the media user interface object. Additionally, or alternatively, a portion/area/volume of the first content item (including elements/features located in that portion/area/volume of the first content item) that do not satisfy the viewing size criteria of the media user interface object are optionally transformed (e.g., scaled, cropped, etc.) to satisfy the viewing size criteria of the media user interface object and subsequently displayed in the media user interface object.

In some embodiments, the presentation of the first content item (including the elements/features in the first content item) are constrained to the size of the media user interface object in the X-direction and/or Y-direction but not the Z-direction. Accordingly, in some embodiments, the portion of the first content item (and features/elements of the first content item) that is displayed in the media user interface object may extend in a Z-direction defined by the first content item but only extend in an X-direction and/or Y-direction by an amount defined by (e.g., size of) the media user interface object. In some embodiments, the portion/area of the first content item displayed in the media user interface object is constrained to the size of the media user interface object in any combination of the X-direction, Y-direction, and/or Z-direction. Thus, in some embodiments, if the first content item is being presented as three-dimensional content during presentation of the first content item in the first presentation mode, a size, depth, and/or dimension of the first content item is bounded in an X-direction, Y-direction, and/or Z-direction by an amount defined by the media user interface object (and portions of the first content item that exist outside of the bounded area are not displayed in the media user interface object or the three-dimensional environment). In some embodiments, while the first content item is being presented in the first presentation mode, the boundary (e.g., border) of the media user interface object is displayed. In some embodiments, the features/elements of the first content item replace (e.g., obscures/hides) portions of the three-dimensional environment in accordance with a size, depth, and dimension defined by the media user interface object.

For example, while the media user interface object is presenting the first content item in two-dimensions (e.g., the X-dimension and Y-dimension) or while the media user interface is presenting the first content in three-dimensions (e.g., the X, Y, and Z dimensions), the media user interface is not the only object appearing in the user's field of view (e.g., other areas of the three-dimensional environment and/or virtual elements (e.g., applications) are within the user's field of view). In some embodiments, while the media user interface object is being presented in the first presentation mode, the media user interface object is occluding less than a threshold amount of the user's field of view (e.g., occluding less than 75%, 60%, 50%, 40%, 30%, 20%, 10%, 5% of the user's field of view). In some embodiments, the elements included in the second portion of the field of view from the viewpoint of the user include virtual objects and/or representations of physical objects, such as application windows, representations of furniture in a physical environment of the electronic device, etc. In some embodiments, the first content item is centered within the user's field of view (e.g., and/or is not occupying portions of the user's field of view corresponding to the edges of the user's field of view). In some embodiments, if the user's viewpoint of the three-dimensional environment changes, the portion that the first content item occupies in the user's field of view optionally changes and/or the amount of space the first content item occupies in the user's field of view optionally changes.

In some embodiments, in accordance with a determination that the one or more criteria are not satisfied (e.g., if the first content item is not immersive), displaying the media user interface object (e.g., such as a video player or multi-media application) that includes the first content item being presented in the first (e.g., non-immersive) presentation mode (e.g., a mode of presentation that causes the media user interface to present the first content item in two-dimensions (e.g., does not occupy space in the three-dimensional environment, that is displayed in the X and Y dimensions but not the Z dimension, etc.) or three-dimensions (e.g., occupies space in the three-dimensional environment, is displayed in the X, Y, and Z dimensions, etc.) without displaying the first user interface element for transitioning presentation of the first content item to the second presentation mode (1402c). For example, if the media item 1323 in FIG. 13A was not immersive content, the electronic device 101 would not concurrently displays the user interface 1306 and the selectable option 1312a.

In some, while displaying the three-dimensional environment (e.g., three-dimensional environment 1304) that includes the media user interface and the first user interface element, the electronic device receives (1402d), via the one or more input devices, a first input that corresponds to selection of the first user interface element, such as the selection of user interface element 1312a in FIG. 13A. In some embodiments, the electronic device detects a selection of the first user interface element when a user performs a pinching gesture using the index finger and thumb of a hand of the user while the user's gaze is directed towards the first user interface element. In some embodiments, the electronic device detects a selection of the first user interface element when a user taps on a location of a touch screen of the electronic device that corresponds to the location of the first user interface element. In some embodiments the first user interface element is selected when a click operation on a mouse or touchpad is performed while the first user interface element has focus.

In some embodiments, in response to receiving the first input, the electronic device displays (1402e), in the three-dimensional environment, the first content item in the second (e.g., immersive) presentation mode, wherein during presentation of the first content item in the second presentation mode, the first content item extends to at least one edge of the field of view from the viewpoint of the user of the electronic device. For example, in FIG. 13C, after the electronic device 101 received the selection of user interface element 1312a in FIG. 13A, the electronic device 101 started presenting media item 1323 in the immersive presentation described in FIG. 13C. For example, after receiving the first input, the first content item expands in size (e.g., in three-dimensions) such that the first content item transitions from occupying the first portion of the user's field of view (e.g., the portion of the user's field of view that the first content item was occupying during presentation of the first content item in the first presentation mode) to occupying at least one respective edge of the user's field of view. In some embodiments, as the user's viewpoint of the three-dimensional environment changes, the first content item continues to extend to an edge of the user's (e.g., current) field of view from the user's new viewpoint of the three-dimensional environment. In some embodiments, after receiving the first input, the first content item expands in a circular manner (or spherical manner when considered in three-dimensions) and partially or completely curves around the user's field of view. In some embodiments, if the media user interface object was displaying the first content item as three-dimensional content during the first presentation mode, a size, dimension, or depth of the first content item and/or elements included in the first content increase when compared to the first mode of presentation. In some embodiments, while presenting the first content item in the second presentation mode, the area or elements of the first content item that were presented during the first presentation mode are centered in the user's field of view, and optionally additional portions/areas or elements of the first content item are also displayed (e.g., content that was not presented during the first presentation mode).

In some embodiments, transitioning presentation of the first content item from the first presentation mode to the second presentation mode includes expanding the first content item (e.g., features/elements of the first content item) in a linear manner (e.g., in a left, right, up, and/or down direction) and/or a non-linear manner (e.g., curving around the user's field of view by changing the depth of the first content item (e.g., in the Z-dimension)). In some embodiments, while the first content item is being presented in the second mode of the presentation, the elements/features of the first content item replace portions of the three-dimensional environment in accordance with a size, dimension, and/or depth defined by the first content item. In some embodiments, portions of the three-dimensional environment are displayed while the first content item is being presented in the second mode of presentation if the elements/features of the first content item do not extend to all edges of the user's field of view (e.g., do not completely occupy the user's field of view of the three-dimensional environment). In some embodiments, during the second mode of presentation, the first content item has a dimension that is larger than the three-dimensional environment, such as if the first content item includes a soccer field (e.g., a feature/element of the first content item) that is 136 yards wide×93 yards long and the three-dimensional environment is 10 feet wide×10 feet long. In some such embodiments, the first content item extends past the boundaries of the three-dimensional environment and replaces portions of the three-dimensional environment with portions of the first content item (e.g., as if portions (e.g., parts) of the three-dimensional environment have been transformed into elements/features of the first content item). In some embodiments, during presentation of the first content item in the second presentation mode, elements (e.g., features or objects) of the first content item consume space in the three-dimensional environment (e.g., are displayed with spatial dimensions in the three-dimensional environment defined by the first content item).

For example, if the first content item includes a soccer field, the soccer field is displayed as an object in the three-dimensional environment with a length, width, and/or depth defined by the first content item. In some embodiments, the features of the first content item (e.g., a soccer field, a soccer ball, etc. if the first content item includes soccer related content) are displayed in a separate (e.g., virtual) three-dimensional environment-optionally having one or more characteristics similar to the three-dimensional environment-located within or proximate to (e.g., superimposed, overlaying, etc.) the three-dimensional environment, such that the features of the first content item appear as if the user were located in/at the first content item (e.g., and optionally no longer located in the three-dimensional environment). In some embodiments, while the first content item is being displayed in the second presentation mode, the first content item is no longer being displayed within the media user interface object (e.g., the window/border of the media user interface object is no longer displayed). In some embodiments, when the first content item transitions to the second presentation mode, the first content item radially expands and curves around the user's field of view, such that the first content item occludes portions of a user's current field of view by more than the above-described threshold amount (e.g., more than 75%, 60%, 50%, 40%, 30%, 20%, 10%, 5% of the user's field of view). In some embodiments, when the first content item transitions to the second presentation mode, the first content item expands in a manner such that the first content item occupies more than a threshold amount of the three-dimensional environment (e.g., 50%, 60%, 70%, 80%, 90%, 100%)—optionally including portions of the three-dimensional environment not currently being displayed via the display generation component or within the user's current field of view.

Transitioning presentation of the first content item from a non-immersive presentation mode to an immersive presentation mode in response to a selection of a respective user interface element provides an efficient way of accessing different modes of presentation for the same content item, and doing so for content items that support such transition, thereby reducing cognitive burden on the user when engaging with the media user interface object.

In some embodiments, during the presentation of the first content item in the second presentation mode, the first content item extends to at least multiple respective edges (e.g., all edges) of the field of view from the viewpoint of the user of the electronic device (1404a). For example, in FIG. 13C, the media item 1323 is expanding to left and right edges in the field of view of the user 1322. For example, when the first content item is being presented in the second presentation mode (e.g., immersive presentation mode), the first content item is at least extending to all the edges of the user's field of view from the user's current viewpoint. In some embodiments, while the first content item is extending to at least multiple respective edges of the user's field of view, (e.g., all of the) the space/area within the user's field of view is occupied by portions of the first content item. In some embodiments, when the first content item extends to multiple respective edges of the user's field of view, the first content item (or elements/features of the first content item) occupies (e.g., all) the areas of the three-dimensional environment that are in the field of view from the viewpoint of the user. In some embodiments, as the user's viewpoint of the three-dimensional environment changes, the first content item continues to extend to at least multiple respective edges of the user's field of view from the user's new viewpoint of the three-dimensional environment.

Extending the first content item to multiple respective edges of the user's field of view during the second presentation provides an efficient way of displaying the first content item as if the user of the electronic device were located in the first content item (and optionally no longer located in the three-dimensional environment), thereby reducing cognitive burden on the user when engaging with the first content item during the second presentation mode.

In some embodiments, during presentation of the first content item in the second presentation mode, the first content item extends past at least one edge of the field of view from the viewpoint of the user of the electronic device (1406a). For example, as shown in overhead view 1327 in FIG. 13C, the media item 1323 is occupying additional areas in the three-dimensional environment 1304 that are outside of the field of view of the user 1322 from the user's 1322 current viewpoint of the three-dimensional environment 1304. For example, when the presentation of the first content item transitions from the first presentation mode to the second presentation mode, first content item not only extends (e.g., expands) to a respective edge of the user's field of view but also extends (e.g., expands) past the respective edge of the user's field of view. Thus, in some embodiments, if the user's viewpoint of the three-dimensional environment shifts/changes, additional and/or different portions of the first content item are displayed from the user's new viewpoint of the three-dimensional environment.

Displaying the first content item at locations in the three-dimensional environment that extend past an edge of the user's field of view provides an efficient way of continuing to present the first content item as if the user of the electronic was located in the first content item as the user's viewpoint of the three-dimensional environment changes, thereby reducing cognitive burden on the user when engaging with the first content item during the second presentation mode.

In some embodiments, while the media user interface object is presenting the first content item in the first presentation mode, the electronic device displays (1408a), in the three-dimensional environment, a playback controls user interface that includes one or more user interface elements, including the first user interface element, for modifying playback of the first content item, wherein the playback controls user interface is displayed at a first location in the three-dimensional environment based on (e.g., that is a threshold distance e.g., 0.5, 1, 3, 5, 7, 15 inches from) a location of the media user interface object. For example, in FIG. 13A, while the electronic device 101 is displaying the media item 1323 in the non-immersive presentation mode, the electronic device 101 displays the playback controls user interface 1312a below the media user interface 1306 (and within the above-mentioned threshold distance from the media user interface 1306). For example, when the first content item is being presented in the first presentation mode, user interface elements for modifying playback of the first content are displayed based a location of the media user interface object in the three-dimensional environment. In some embodiments, the playback controls user interface is displayed at a first respective location in the three-dimensional environment if the media user interface object is at a first location in the three-dimensional environment. Similarly, in some embodiments, the playback controls user interface is displayed at a second respective location (different than the first respective location) in the three-dimensional environment if the media user interface object is at a second location (different than the first location) in the three-dimensional environment. In some embodiments, the playback controls user interface is displayed at a location below the first media user interface, such that the playback controls user interface is not obscured by the media user interface object. In some embodiments, the playback controls user interface is displayed at a location in the three-dimensional environment such that playback controls user interface and the media user interface object partially overlap each other.

In some embodiments, the playback controls user interface has a Z-depth that is higher than the Z-depth of the media user interface object. In some embodiments, the playback controls user interface is displayed at a location that is at or within a threshold distance of the media user interface object (e.g., 0.5, 1, 3, 5, 7, 15 inches). In some embodiments, in addition to the first user interface element, the playback controls user interface includes user interface elements for modifying playback of the content including user interface elements for playing, pausing, fast forwarding, rewinding, displaying/managing subtitles, and/or for modifying playback audio associated with the first content item. In some embodiments, the playback controls user interface is displayed in the media user interface after the electronic device detects that the user of the electronic device performed a pinching gesture (e.g. such as with the thumb and index finger of a hand of a user) while a user's gaze was directed to the media user interface element. In some embodiments, the user interface elements are displayed in the media user interface when only a gaze of the user was directed towards the media user interface and/or when a gaze of the user is directed towards the media user interface while a hand of the user is performing a start of a pinching gesture (e.g. such as when the thumb and index finger of a hand of a user are more than a threshold distance apart (e.g., 0.5, 1, 1.5, 3, 6 cm) and have not yet converged to be within the above-mentioned threshold distance of each other).

Displaying the playback controls user interface at a location in three-dimensional environment based on a location of a media user interface object in the three-dimensional environment provides an efficient way of interacting with the playback controls user interface while the first content item is being presented in the first presentation mode, thereby reducing cognitive burden on the user when engaging with the first content item during the first presentation mode.

In some embodiments, during presentation of the first content item in the first presentation mode, the viewpoint of the user corresponds to a first viewpoint (1410a) (e.g., the user is viewing the three-dimensional environment from the first viewpoint). In some embodiments, the user is viewing the three-dimensional environment from the first viewpoint because the user is located at a first location in a physical environment of the electronic device (and optionally with a first pose/orientation. In some embodiments, while presenting the first content item in the first presentation mode and the three-dimensional environment from the first viewpoint, the electronic device detects (1410b) movement of the viewpoint of the user from the first viewpoint to a second viewpoint, such as the movement of the viewpoint of the user 1322 in FIGS. 13A and 13B. In some embodiments, detecting movement of the viewpoint of the user includes detecting movement of at least a portion of the user (e.g., the user's head, torso, hand, etc.). In some embodiments, detecting movement of the viewpoint of the user includes detecting movement of the electronic device or display generation component (e.g., optionally concurrently with the movement of at least a portion of the user). In some embodiments, the user's viewpoint of the three-dimensional environment changes to the second viewpoint because the user's orientation in the physical environment changed to a second pose/orientation and/or because the user's location in the physical environment changed to a second physical location.

In some embodiments, in response to detecting the movement of the viewpoint of the user to the second viewpoint (1410c), the electronic device displays (1410d) the three-dimensional environment from the second viewpoint of the user (e.g., the three-dimensional environment is displayed based on the user's new viewpoint of the three-dimensional environment (e.g., the orientation of the user's field of view into the three-dimensional environment has changed)). For example, in response to the electronic device 101 detecting that the user's 1322 viewpoint of the three-dimensional environment 1304 moved from the viewpoint indicated in overhead view 1327 in FIG. 13A to the viewpoint indicated in overhead view 1327 in FIG. 13B, the electronic device 101 displays the three-dimensional environment from the user's new viewpoint indicated in FIG. 13B. In some embodiments, while the three-dimensional environment is being displayed from the second viewpoint of the user, the user's field of view of the three-dimensional environment from the second viewpoint includes different portions of the three-dimensional environment that was not being presented when the three-dimensional environment was being displayed from the first viewpoint of the user.

In some embodiments, in response to detecting the movement of the viewpoint of the user to the second viewpoint (1410c), the electronic device maintains (1410e) display of the playback controls user interface at the first location in the three-dimensional environment. For example, even though the user's 1322 viewpoint of the three-dimensional environment 1304 moved between FIGS. 13A and 13B, the playback controls user interface 1323 remained at the same location in the three-dimensional environment 1304, as indicated in overhead view 1327 in FIGS. 13A and 13B. For example, if the user's viewpoint of the three-dimensional environment changes while the first content item is being presented in the first presentation mode, the location of the playback controls in the three-dimensional environment (and optionally the media user interface object) do not change. Thus, if the first location in the three-dimensional environment is within the user's field of view from the second viewpoint of the three-dimensional environment, the relative location of the playback controls user interface relative to the user's viewpoint is optionally different, but the actual location of the playback controls user interface in the three-dimensional environment did not change. Thus, in some embodiments, the playback controls user interface has one or more of the location characteristics of the media user interface during the first presentation mode described with reference to method 1000.

While the first content item is being presented in the first presentation mode, maintaining the location of the playback controls user interface in the three-dimensional environment as the user's viewpoint of the three-dimensional environment changes provides an efficient way of maintaining the location of certain user interfaces during the first presentation mode even as the user's viewpoint of the three-dimensional environment changes, thereby reducing cognitive burden on the user when engaging with the first content item during the first presentation mode.

In some embodiments, while displaying the media user interface object in the three-dimensional environment and the playback controls user interface at the first location, the electronic device receives (1412a), via the one or more input devices, a second input corresponding to a request to move the media user interface object to a different location in the three-dimensional environment. In some embodiments, the electronic device receives the second input when the user of the electronic device performs a pinching gesture (optionally using the index finger and thumb of a hand of the user) while the user's gaze is directed towards the media user interface, followed by movement of the hand of the user to a physical location corresponding to the different location in the three-dimensional environment. In some embodiments, the first input is received when the electronic device detects that a hand of the user is moving the first object via a dragging/movement gesture on a touch screen of the electronic device (e.g., if the display generation component associated with the electronic device is a touch screen). In some embodiments, the request to move the media user interface is not detected when a user's viewpoint of the three-dimensional environment changes (e.g., if media user interface object has not been previously selected for movement).

In some embodiments, in response to receiving the second input (1412b), the electronic device moves (1412c), the media user interface object to the different location in the three-dimensional environment (e.g., the media user interface is displayed at the different location in the three-dimensional environment in response to the second input). In some embodiments, in response to receiving the second input (1412b), the electronic device displays (1412d) the playback controls user interface at a second location, different from the first location, in the three-dimensional environment, wherein the second location in the three-dimensional environment is based on (e.g., a threshold distance from) the different location in the three-dimensional environment. For example, as the electronic device receives input for repositioning the media user interface 1306, the positions of the playback controls user interface 1312 is updated to a location based on the new location of the media user interface 1306 in the three-dimensional environment 1304. For example, the location of the playback controls in the three-dimensional environment is based on the different location that the media user interface is now being displayed at in the three-dimensional environment. In some embodiments, while the playback controls user interface is being displayed at the second location, the playback controls user interface is displayed under the media user interface object, such that the playback controls user interface is not obscured by the media user interface object. In some embodiments, while the playback controls user interface is being displayed at the second location, the playback controls user interface is displayed at a location in the three-dimensional environment such that playback controls user interface and the media user interface object partially overlap each other. In some embodiments, while the playback controls user interface is being displayed at the second location, the playback controls user interface has a Z-depth that is higher than the Z-depth of the media user interface object. In some embodiments, while the playback controls user interface is being displayed at the second location, the playback controls user interface is being displayed within a threshold distance of the media user interface object (e.g., 0.5, 1, 3, 5, 7, 15 inches).

Moving the playback controls user interface to a new location in the three-dimensional environment when an associated media user interface object is moved in the three-dimensional environment provides an efficient way of adjusting/modifying the location of the playback controls user interface in response to window movement inputs but not when the user's viewpoint of the three-dimensional environment changes.

In some embodiments, while displaying the first content item in the first presentation mode, the electronic device displays (1414a), at a first location in the three-dimensional environment, a playback controls user interface (e.g., similar to the playback controls user interface previously described above) that includes one or more user interface elements for modifying playback of the first content item, wherein the first location is a first distance from the viewpoint of the user. In some embodiments, during presentation of the first content item in the first presentation mode, the playback controls are displayed a first distance from the viewpoint of the user (e.g., from a position in the three-dimensional environment corresponding to the viewpoint of the user). In some embodiments, the distance that the playback controls user interface is from the viewpoint of the user in the three-dimensional environment is based on a location of the media user interface object in the three-dimensional environment. For example, if while the first content item is being presented in the first presentation mode, the media user interface object is at a first location in the three-dimensional environment, the playback controls user interface are optionally the first distance from the viewpoint of the user. If the media user interface object is at a location in in the three-dimensional environment that is closer from the viewpoint of the user, the playback controls user interface is optionally a closer distance from the viewpoint of the user.

In some embodiments, while presenting the first content item in the second presentation mode, the electronic device presents (1414b), at a second location in the three-dimensional environment, the playback controls user interface, wherein the second location in the three-dimensional environment is a second distance, closer than the first distance, from the viewpoint of the user in the three-dimensional environment. For example, as indicated in overhead view 1327 in FIGS. 13A and 13C, the playback controls user interface 1312 is displayed closer to the viewpoint of the user 1322 when the media item 1323 is being presented in the immersive presentation mode in FIG. 13C as compared to when the media item 1323 is being presented in the non-immersive presentation mode in FIG. 13A. For example, during presentation of the content item in the second presentation mode, the playback controls user interface is displayed closer to the viewpoint of the user as compared to the location of the playback controls when the first content item is being presented in the first presentation mode. In some embodiments, the electronic device displays an animation of the playback controls user interface moving closer to the viewpoint of the user in response to transitioning from the first to the second mode of presentation.

Displaying the playback controls closer to the user during the second presentation mode as compared to the first mode presentation mode provides an efficient way of accessing and interacting with such a user interface during the second mode of presentation, thereby reducing cognitive burden on the user when engaging with the playback controls user interface and modifying playback of the first content item.

In some embodiments, the second location in the three-dimensional environment is based on (e.g., within a threshold distance of) a location of the viewpoint of the user (1416a). For example, when first content item is being presented in the second presentation mode, the location of the playback controls user interface in the three-dimensional environment is based on a location in the three-dimensional environment that corresponds to viewpoint of the user. In some embodiments, the playback controls user interface is at a location in the three-dimensional environment that is a threshold distance (e.g., 0.1, 0.5, 0.9, 1, 1.5, 2, 3, or 5 feet) from the location of the viewpoint of the user. In some embodiments, if the user's viewpoint of the three-dimensional environment changes, the location of the playback controls user interface is updated based on the user's new viewpoint of the three-dimensional environment, such that the playback controls user interface is in the user's field of view from the updated viewpoint of the three-dimensional environment (and optionally at a location that is a threshold distance from a location corresponding to the user's updated viewpoint of the three-dimensional environment, and optionally that is occupying a predetermined portion of the user's field of view (e.g., lower right portion)). In some embodiments, the playback controls user interface is displayed in a bottom-center portion of the user's field of view from the viewpoint of the user. Displaying the playback controls a threshold distance from a user's viewpoint of the three-dimensional environment provides an efficient way of accessing and interacting with such a user interface during the second mode of presentation, thereby reducing cognitive burden on the user when engaging with the playback controls user interface and modifying playback of the first content item.

In some embodiments, while the viewpoint of the user is a first viewpoint and while displaying the media user interface object in the second presentation mode and the playback controls user interface at the second location in the three-dimensional environment, the electronic device detects (1418a) movement of the viewpoint of the user from the first viewpoint to a second viewpoint, different from the first viewpoint. In some embodiments, detecting movement of the viewpoint of the user includes detecting movement of at least a portion of the user (e.g., the user's head, torso, hand, etc.). In some embodiments, detecting movement of the viewpoint of the user includes detecting movement of the electronic device or display generation component (e.g., optionally concurrently with the movement of at least a portion of the user). In some embodiments, the viewpoint of the user is the first viewpoint because the user is physically located at a first location in the physical environment of the electronic (and is optionally oriented in a first manner). In some embodiments, the user's viewpoint of the three-dimensional environment changes to the second viewpoint because the user's orientation and/or physical location in the physical environment changed (e.g., moved to be oriented in a second manner and/or moved to a different location in the physical environment of the electronic device.

In some embodiments, in response to detecting the movement of the viewpoint of the user from the first viewpoint to the second viewpoint (1418b), the electronic device displays (1418c), via the display generation component, the three-dimensional environment from the second viewpoint of the user of the electronic device (e.g., the three-dimensional environment is displayed based on the user's new viewpoint of the three-dimensional environment (e.g., the orientation of the user's field of view into the three-dimensional environment has changed). In some embodiments, while the three-dimensional environment is being displayed from the second viewpoint, the user's field of view in the three-dimensional environment from the second viewpoint includes different portions of the three-dimensional environment that was not being presented when the three-dimensional environment was being displayed from the first viewpoint of the user).

In some embodiments, in response to detecting the movement of the viewpoint of the user from the first viewpoint to the second viewpoint (1418b), (e.g., in accordance with a determination that one or more second criteria are satisfied, such as when movement of the viewpoint has settled down such as described in method 1000), the electronic device displays (1418d) the playback controls user interface at a third location, different from the second location, in the three-dimensional environment, wherein the third location is based on a location of the second viewpoint of the user. For example, when the user's 1322 viewpoint of the three-dimensional environment 1304 changed from the viewpoint indicated in overhead view 1327 in FIG. 13C to the viewpoint indicated in overhead view 1327 in FIG. 13D, the location of the playback controls user interface 1312 is updated such that the playback controls user interface 1312 remain in the field of view of the user 1322 from the user's 1322 new viewpoint of the three-dimensional environment 1304. For example, when the user's viewpoint of the three-dimensional environment changes from the first viewpoint to the second viewpoint, the location of the playback controls user interface changes based on the user's new viewpoint of the three-dimensional environment—the second viewpoint. In some embodiments, when the viewpoint of the user is the second viewpoint, the location of the playback controls user interface in the three-dimensional environment is in a user's field of view from the second viewpoint of the user. In some embodiments, the playback controls user interface is displayed at a location in the three-dimensional environment that is a threshold distance (e.g., 0.1, 0.5, 0.9, 1, 1.5, 2, 3, or 5 feet) from the location in the three-dimensional environment corresponding to the second viewpoint of the user (and optionally at a predetermined portion of the user's field of view as previously described (e.g., bottom-center of the user's field of view). In some embodiments, the electronic device displays or delays the display of the playback controls user interface in a similar way as described in method 1000 with respect to the media user interface after movement of the viewpoint of the user.

Changing the location of the media user interface as the user's viewpoint in the three-dimensional environment changes provides an efficient way of providing continuous access to the playback controls user interface during presentation of the first content item in the second presentation mode, regardless of the user's current viewpoint of the three-dimensional environment, thereby reducing cognitive burden on the user when engaging with the media user interface and when engaging with other content or applications in the three-dimensional environment.

In some embodiments, while presenting the first content item in a respective presentation mode (e.g., the first presentation mode or the second presentation mode), the electronic device receives (1420a), via the one or more input devices, a second input including movement of a respective portion (e.g., hand) of the user, the second input corresponding to a request to scrub through the first content item. In some embodiments, the electronic device receives a request to start scrubbing the first content item when a user performs a pinching gesture with an index finger and thumb of a hand of the user (optionally while the user's gaze is directed towards the first content item and/or directed towards a scrubber bar displayed in a playback controls user interface, as described above). In some embodiments, a scrubbing position of the first content item changes as the user's hand moves in horizontal manner from the location where the request to start scrubbing was received (e.g., while the hand of the user remains in the pinched shape). In some embodiments, in response to receiving the second input, the electronic device scrubs (1420b) through the first content item in accordance with the movement of the respective portion of the user (e.g., scrub forward or backward from a current scrubbing position based on (e.g., motion/movement) input of a portion of a user). For example, in FIG. 13A, the electronic device 101 scrubs the scrubbing location indicated by visual indication 1312k in response to the hand 1331 of user 1322 moving to a corresponding location in the physical environment 1302. For example, if the user's hand moves in leftward direction relative to where the request to start scrubbing was received, a scrubbing position of the first content item is optionally moved backwards in time in accordance with the amount of (leftward) movement of the user's hand. Similarly, if the user's hand moves in rightward direction relative to the location where the (with the index finger and thumb of the hand of the user), a scrubbing position of the first content item is optionally moved forwards in time in accordance with the amount of (rightward) movement of the user's hand. In some embodiments, upon detecting the end of the pinch (e.g., index finger moving away from the thumb of the user, the first content item starts playback from the scrubbed-to scrubbing position in the first content item). As will be described in more detail below, in some embodiments, the presentation mode associated with the first content item determines the manner in which the first content item is scrubbed.

Scrubbing the first content item based on movement of a portion of the user (e.g., a user's hand) provides an efficient way of scrubbing the first content item in a uniform manner in both the first presentation mode and the second presentation mode, thereby reducing cognitive burden on the user when scrubbing the first content item in a respective presentation mode.

In some embodiments, scrubbing through the first content item includes (1422a), while detecting the second input and in accordance with a determination that one or more second criteria are satisfied (e.g., if the second input was received while the first content item was being presented in the first presentation mode and/or if the first content item is occupying less than a threshold portion of the user's field of view (e.g., less than 70%, 60%, 50%, 40%, 30, 20%, 10%, or 5%)), displaying (1422b), in the media user interface object, content corresponding to a current scrubbing position in the first content item that changes as the respective portion of the user moves. For example, the scrubbing position in FIG. 13A changed as the user's hand 1331 moved from a location in the physical environment 1302 corresponding to previous scrubbing position to a location in the physical environment 1302 corresponding to the current scrubbing position. For example, scrubbing during presentation of the first content item in the first presentation mode causes the first content item to be updated in (e.g., in real time) to correspond to a current scrubbing position associated with the movement of the portion (e.g., hand) of the user, without displaying a new element in the three-dimensional environment for indicating the content at the current scrubbing position. In some embodiments, the scrubbing position moves forward in time (e.g., fast forwards through the first content item) when the respective portion moves in a first direction (e.g., a rightward direction). In some embodiments, the scrubbing position moves backwards in time (e.g., rewinds through the first content item) when the respective portion moves in a second direction (e.g., a leftward direction).

Displaying content corresponding to the current scrubbing position defined by the movement of a portion of the user in the media user interface object, provides an efficient way of scrubbing the first content item while the content is being presented in the first presentation mode, thereby reducing cognitive burden on the user when scrubbing the first content item.

In some embodiments, while detecting the second input and in accordance with a determination that one or more second criteria are not satisfied and the content is displayed as immersive content (1424a) (e.g., the second input was received while the first content item was being presented in the second presentation mode, if the first content item is occupying more than a threshold portion of the user's field of view (e.g., more than 70%, 60%, 50%, 40%, 30, or 20%)), the electronic device pauses (1424b) playback of the first content item in the media user interface object. For example, in FIG. 13D, the media item 1323 is paused in response to the electronic device 101 detecting a request to scrub at the scrubber bar 1312j.

In some embodiments, while detecting the second input and in accordance with a determination that one or more second criteria are not satisfied and the content is displayed as immersive content (1424a), the electronic device displays (1424c), in the three-dimensional environment (e.g., at the media user interface object or at a playback controls user interface), a visual indication (e.g., preview representation 1346) of (e.g., a thumbnail representation of) respective content in the first content item that is separate from the immersive content (e.g., in some embodiments, the visual indication of the respective content in the first content item is displayed with a (e.g., angular or display) size smaller than the media user interface object), wherein the respective content corresponds to a current scrubbing position in the first content item that changes as the respective portion of the user moves, without changing an appearance of the immersive content as the respective portion of the user moves. For example, when a request to scrub the first content item is received while the first content item is being presented in the second mode of presentation, the scrubbing position of (e.g., associated with) the first content item changes (e.g., in real time) based on movement of the respective portion of the user, but the change in scrubbing position does not cause content being presented in the media user interface object to change. Instead, the preview of the content at the current scrubbing position is displayed in a thumbnail that pops up, and where it moves left/right along with the left/right hand movement. In some embodiments, the scrubbing position moves forward in time (e.g., fast forwards through the first content item) when the respective portion moves in a first direction (e.g., a rightward direction). In some embodiments, the scrubbing position moves backwards in time (e.g., rewinds through the first content item) when the respective portion moves in a second direction (e.g., a leftward direction). In some embodiments, the visual indication occupies less of a user's field of view compared to the amount of the media user interface occupies in the user's field of view (e.g., 70%, 60%, 50%, 40%, 30, or 20%, of the user's field of view).

In some embodiments, in response to detecting an end of the second input (e.g., in some embodiments, the end of the second input is detected if the respective portion of the user does not move for more than a threshold amount of time (e.g., 3, 5, 10, 15 seconds). In some embodiments, if the respective portion corresponds to a hand of the user and the hand of the user is moving while the thumb and index finger of the user's hand are a threshold distance from each other (e.g., within 0.1, 0.3, 0.5, 1, 2 inches from each other), the end of the second input is optionally detected when a third input is received that includes movement of the thumb and the index finger of the user a threshold distance apart from each other (e.g., moving (e.g., 0.1, 0.3, 0.5, 1, or 2 inches) away from each other), the electronic device ceases (1424d) display of the visual indication of the respective content and plays (1424d) the first content item in the media user interface object as immersive content starting from a respective scrubbing position at which the end of the second input was detected. For example, when the user is finished scrubbing the first content item (indicated by the end of the second input being detected), the visual indication stops being displayed in the three-dimensional environment and the first content item in the media user object resumes playback (e.g., starts playing) based on where the user last scrubbed to (e.g., the scrubbing position detected right before the end of the second input was detected).

Displaying a visual indication of the content in the first content item that corresponds to a current scrubbing position instead of directly modifying the media user interface object where the first content item is displayed provides an efficient way of scrubbing the first content item while the content is being presented in the second presentation mode, thereby reducing cognitive burden on the user when scrubbing the first content item.

In some embodiments, the one or more second criteria include a criterion that is satisfied when the second input was received while the first content item (e.g., media item 1323) was occupying less than a threshold portion of the field of view of the user (e.g., less than 70%, 60%, 50%, 40%, 30, or 20% of the user's field of view)), and not satisfied when the second input was received while the first content item (e.g., media item 1323) was occupying more than the threshold portion of the field of view of the user (1426a) (e.g., more than 70%, 60%, 50%, 40%, 30, or 20% of the user's field of view). For example, if the one or second criteria are satisfied, scrubbing the first content item based on the movement of the respective portion (e.g., hand) of the user causes the media user interface object to be updated (e.g., in real time) to correspond to the current scrubbing position defined by the movement of the respective portion of the user. Conversely, if the one or more second criteria are not satisfied, in some embodiments, scrubbing the first content item in accordance with the movement of the respective portion of the user does not cause the content in the media user interface object to be updated (e.g., in real time) to correspond to the current scrubbing position defined by the movement of the respective portion of the user. Scrubbing the first content item in different manners based on the one or more criteria satisfied provides an efficient way of scrubbing the first content item based on characteristics of the media user interface object, first content item, and/or three-dimensional environment, thereby reducing cognitive burden on the user when scrubbing the first content item.

In some embodiments, during presentation of the first content item in the first presentation mode, the first content item is displayed at a first size in the three-dimensional environment (e.g., the size of media item 1323 indicated in FIG. 13A), and during presentation of the first content item in the second presentation mode, the first content item is displayed at a second size, larger than the first size, (e.g., the size of media item 1323 indicated in FIG. 13C) in the three-dimensional environment (1428a). For example, the first size of the first content item during the first presentation mode occupies less than 75%, 60%, 50%, 40%, 30%, 20%, 10%, or 5% of the user's field of view, and the second size of the first content item during the second presentation mode occupies more than the 75%, 60%, 50%, 40%, 30%, 20%, 10%, or 5% of the user's field of view. In some embodiments, if the first content item is being displayed with the second size, not only does the size of the first content item increase but also does the size of the features/elements included in the first content item when compared the size of the first content item during the first presentation mode. Thus, in some embodiments, displaying the first content item with the second size includes increasing a size, depth, and/or dimensions of the features/elements in the first content item (and not just the size of the media user interface object). For example, in some embodiments, a three-dimensional feature/element in the first content item is displayed with a first length, width, and/or depth while the first content item is displayed with the first size, and when the first content item is displayed with the second size, the three-dimensional feature/element is displayed with a second (e.g., larger) length, width, and/or depth.

Increasing the size of the first content item when the first content item is being displayed in the second presentation mode provides an efficient way of displaying the first content item as if the user of the electronic device was located in the first content item during the second mode of presentation, thereby reducing cognitive burden on the user when engaging with the first content item during the second presentation mode.

In some embodiments, presenting the first content item in the first presentation mode includes presenting the first content, in the three-dimensional environment, while a representation of a first portion of a physical environment of the electronic device has a first level of visual emphasis (1430a). For example, while the first content item is being presented in the first mode of presentation, a portion of the physical environment where the electronic device is located is represented in the three-dimensional environment (e.g., a representation of a corner of a room, wall, object (e.g., furniture) in, etc. is presented in the three-dimensional environment). In some embodiments, the three-dimensional environment is displaying the representation of the first portion of the physical environment with a first level of (or amount of) opacity (e.g., is fully or partially opaque (80%, 85%, 90%, or 95% opaque) and/or a with a first amount of transparency).

In some embodiments, presenting the first content item in the second presentation mode includes, reducing a visual emphasis of the first portion of the physical environment to a second level of visual emphasis, less than the first level of visual emphasis (1430b). For example, a portion of the physical environment that is in the field of view of the user 1322 is visually emphasized less when media item 1323 is being presented in the immersive presentation mode than in the non-immersive presentation mode. For example, while the first content item is being presented in the second mode of presentation, the portion of the physical environment represented in the three-dimensional environment is displayed with a second (different) level of opacity or transparency (e.g., in some embodiments, more opacity or transparency). In some embodiments, the during the second presentation mode, the representation of the first portion of the physical environment is visually deemphasized compared to the first mode of presentation. Thus, in some embodiments, the representation of the first portion of the physical environment is more visually prominent in the first mode of presentation than in the second mode of presentation. In some embodiments, a brightness of the first content is brighter in the first mode of presentation and less bright in the second mode of presentation. In some embodiments, the portion of the three-dimensional environment is fully occluded by the first content item.

Visually de-emphasizing representations of portions of the physical environment of the electronic device during the second presentation mode provides an efficient way of de-emphasizing portions of the three-dimensional environment during the second presentation mode that are not associated with the first content item, thereby reducing cognitive burden on the user when engaging with the first content item in the second presentation mode.

In some embodiments, while presenting the first content item in the second presentation mode, displaying, in the three-dimensional environment, a second user interface element (e.g., user interface element 1312a in FIG. 13D) for transitioning presentation of the first content item from the second presentation mode (e.g., immersive mode) to the first presentation mode. In some embodiments, the second user interface is displayed in a similar playback controls user interface that was described above. In some embodiments, the second user interface element is selected/interacted in an analogous manner to the selection of the user interface elements in the playback controls user interface, as described above. In some embodiments, the electronic device detects a selection of the second user interface element when a user performs a pinching gesture using the index finger and thumb of a hand of the user while the user's gaze is directed towards the second user interface element. In some embodiments, the electronic device detects a selection of the second user interface element when a user taps on a location of a touch screen of the electronic device that corresponds to the location of the second user interface element. In some embodiments the second user interface element is selected when a click operation on a mouse or touchpad is performed while the second user interface element has focus.

Displaying an option for transitioning presentation of the first content item from an immersive presentation mode to a non-immersive presentation mode in response to a selection of a respective user interface element provides an efficient way of switching modes of presentation for the same content item, thereby reducing cognitive burden on the user when engaging with the media user interface object.

In some embodiments, while presenting the first content item in the first presentation mode and while the viewpoint of the user corresponds to a first viewpoint, wherein a first portion of the first content item but not a second portion of the first content item is displayed in the media user interface object (e.g., the second portion of the first content item is not in the user's field of view from the first viewpoint. In some embodiments, the second portion of the first content item is not in the user's field of view because that second portion of the first content item could not be displayed in the media user interface object at the same time as the first portion (e.g., the combined size, depth, dimension of the first portion and the second portion of the first content item could not be concurrently displayed in the media user interface object)), the electronic device detects (1434a) movement of the viewpoint of the user from the first viewpoint to a second viewpoint, different from the first viewpoint. In some embodiments, the electronic device detects movement of the user's viewpoint in a similar way as described above. In some embodiments, in response to detecting the movement of the viewpoint of the user from the first viewpoint to the second viewpoint, the electronic device displays (1434b) the first content item in the media user interface object from the second viewpoint of the user, wherein displaying the first content item in the media user interface object from the second viewpoint of the user includes displaying the second portion of the first content item in the media user interface object (e.g., as the user's viewpoint of the media user interface object changes, the electronic device displays different portions of the first content item). For example, additional/new portions of the media item 1323 is displayed at user interface 1306 as the user's 1322 viewpoint changes from the viewpoint indicated in overhead view 1327 in FIG. 13A to the viewpoint indicated in overhead view 1327 in FIG. 13E. For example, if the user's viewpoint of the media user interface is normal to the media user interface object, the second portion of the first content item is optionally not displayed. In some embodiments, if the user's viewpoint changes in a manner such that the user's viewpoint is no longer normal to the media user interface object but a different pose/orientation relative to the media user interface object, the electronic device optionally displays the second portion of the first content item (and optionally less or none of the first portion of the first content item). In some embodiments, as the user's viewpoint of the media user interface object changes, the size and/or location of the media user interface object and/or the first content item (and features/elements of the first content item) do not change, but rather different portions of the first content item are displayed in the media user interface object based on the user's viewpoint relative to the media user interface object.

Displaying portions of the first content item in the media user interface based on the user's viewpoint of the media user interface object provides an efficient way of viewing different portions of the first content in the first mode of presentation, thereby reducing cognitive burden on the user when engaging with the media user interface object.

In some embodiments, if the first content item is being presented in the second mode of presentation, the content located at or within a threshold distance (e.g., 1, 2, 5, 7, 10, 20, 40, or 80 cm) of the edges of the user's field of view and/or at or within the threshold distance of the edges of the first content item is displayed with a first amount of transparency (e.g., 80%, 70%, 60%, 50%, or 40%). In some embodiments, the transparency of the content at the edges of the user's field of view and/or content item is variable, such that the content closer to the edges of the user's field of view and/or content item is more transparent than the content that is farther from the edges of the user's field of the user's field of view and/or content item.

In some embodiments, aspects/operations of methods 800, 1000, 1200, and/or 1400 may be interchanged, substituted, and/or added between these methods. For example, the three-dimensional environments and content applications of methods 800, 1000, 1200, and/or 1400 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method comprising:
at an electronic device in communication with a display generation component and one or more input devices:
displaying, via the display generation component, a three-dimensional environment, including concurrently displaying:
a media user interface object that includes respective content of a first content item being presented in a first presentation mode and
a first user interface element for transitioning presentation of the first content item to a second presentation mode, wherein during presentation of the first content item in the first presentation mode, the first content item is displayed in a frame that occupies a first portion of a field of view from a viewpoint of a user of the electronic device while a second portion of the field of view from the viewpoint of the user is occupied by other elements of the three-dimensional environment that represents a physical environment surrounding the electronic device; and
while displaying the three-dimensional environment that includes the media user interface and the first user interface element, receiving, via the one or more input devices, a first input that corresponds to selection of the first user interface element; and
in response to receiving the first input, displaying, in the three-dimensional environment, the first content item in the second presentation mode, wherein during presentation of the first content item in the second presentation mode, the respective content of the first content item is concurrently displayed while replacing at least a portion of the other elements of the three-dimensional environment that represents the physical environment surrounding the electronic device with virtual three-dimensional content that extends to at least one edge of the field of view from the viewpoint of the user of the electronic device.

2. The method of claim 1, wherein during the presentation of the first content item in the second presentation mode, the first content item extends to at least multiple respective edges of the field of view from the viewpoint of the user of the electronic device.

3. The method of claim 1, wherein during presentation of the first content item in the second presentation mode, the first content item extends past at least one edge of the field of view from the viewpoint of the user of the electronic device.

4. The method of claim 1, further comprising:
while the media user interface object is presenting the first content item in the first presentation mode, displaying, in the three-dimensional environment, a playback controls user interface that includes one or more user interface elements, including the first user interface element, for modifying playback of the first content item, wherein the playback controls user interface is displayed at a first location in the three-dimensional environment based on a location of the media user interface object.

5. The method of claim 4, wherein during presentation of the first content item in the first presentation mode, the viewpoint of the user corresponds to a first viewpoint, the method further comprising:
while presenting the first content item in the first presentation mode and the three-dimensional environment from the first viewpoint, detecting movement of the viewpoint of the user from the first viewpoint to a second viewpoint; and
in response to detecting the movement of the viewpoint of the user to the second viewpoint:
displaying the three-dimensional environment from the second viewpoint of the user; and
maintaining display of the playback controls user interface at the first location in the three-dimensional environment.

6. The method of claim 4, further comprising:
while displaying the media user interface object in the three-dimensional environment and the playback controls user interface at the first location, receiving, via the one or more input devices, a second input corresponding to a request to move the media user interface object to a different location in the three-dimensional environment; and
in response to receiving the second input:
moving the media user interface object to the different location in the three-dimensional environment; and
displaying the playback controls user interface at a second location, different from the first location, in the three-dimensional environment, wherein the second location in the three-dimensional environment is based on the different location in the three-dimensional environment.

7. The method of claim 1, further comprising:
while displaying the first content item in the first presentation mode, displaying, at a first location in the three-dimensional environment, a playback controls user interface that includes one or more user interface elements for modifying playback of the first content item, wherein the first location is a first distance from the viewpoint of the user; and
while presenting the first content item in the second presentation mode, displaying, at a second location in the three-dimensional environment, the playback controls user interface, wherein the second location in the three-dimensional environment is a second distance, closer than the first distance, from the viewpoint of the user in the three-dimensional environment.

8. The method of claim 7, wherein the second location in the three-dimensional environment is based on a location of the viewpoint of the user.

9. The method of claim 7, the method further comprising:
while the viewpoint of the user is a first viewpoint and while displaying the media user interface object in the second presentation mode and the playback controls user interface at the second location in the three-dimensional environment, detecting movement of the viewpoint of the user from the first viewpoint to a second viewpoint, different from the first viewpoint; and
in response to detecting the movement of the viewpoint of the user from the first viewpoint to the second viewpoint:
displaying, via the display generation component, the three-dimensional environment from the second viewpoint of the user of the electronic device; and
displaying the playback controls user interface at a third location, different from the second location, in the three-dimensional environment, wherein the third location is based on a location of the second viewpoint of the user.

10. The method of claim 1, further comprising:
while presenting the first content item in a respective presentation mode, receiving, via the one or more input devices, a second input including movement of a respective portion of the user, the second input corresponding to a request to scrub through the first content item; and
in response to receiving the second input, scrubbing through the first content item in accordance with the movement of the respective portion of the user.

11. The method of claim 10, wherein scrubbing through the first content item includes:
while detecting the second input and in accordance with a determination that one or more second criteria are satisfied, displaying, in the media user interface object, content corresponding to a current scrubbing position in the first content item that changes as the respective portion of the user moves.

12. The method of claim 10, wherein scrubbing through the first content item includes:
while detecting the second input and in accordance with a determination that one or more second criteria are not satisfied and the content is displayed as immersive content:
pausing playback of the first content item in the media user interface object;
displaying, in the three-dimensional environment, a visual indication of respective content in the first content item that is separate from the immersive content, wherein the respective content corresponds to a current scrubbing position in the first content item that changes as the respective portion of the user moves, without changing an appearance of the immersive content as the respective portion of the user moves; and
in response to detecting an end of the second input, ceasing display of the visual indication of the respective content and playing the first content item in the media user interface object as immersive content starting from a respective scrubbing position at which the end of the second input was detected.

13. The method of claim 11, wherein the one or more second criteria include a criterion that is satisfied when the second input was received while the first content item was occupying less than a threshold portion of the field of view of the user, and not satisfied when the second input was received while the first content item was occupying more than the threshold portion of the field of view of the user.

14. The method of claim 1, wherein during presentation of the first content item in the first presentation mode, the first content item is displayed at a first size in the three-dimensional environment, and during presentation of the first content item in the second presentation mode, the first content item is displayed at a second size, larger than the first size, in the three-dimensional environment.

15. The method of claim 1, wherein:
presenting the first content item in the first presentation mode includes presenting the first content, in the three-dimensional environment, while a representation of a first portion of the physical environment surrounding the electronic device has a first level of visual emphasis, and
presenting the first content item in the second presentation mode includes, reducing a visual emphasis of the first portion of the physical environment to a second level of visual emphasis, less than the first level of visual emphasis.

16. The method of claim 1, further comprising:
while presenting the first content item in the second presentation mode, displaying, in the three-dimensional environment, a second user interface element for transitioning presentation of the first content item from the second presentation mode to the first presentation mode.

17. The method of claim 1, the method further comprising:
while presenting the first content item in the first presentation mode and while the viewpoint of the user corresponds to a first viewpoint, wherein a first portion of the first content item but not a second portion of the first content item is displayed in the media user interface object, detecting movement of the viewpoint of the user from the first viewpoint to a second viewpoint, different from the first viewpoint; and
in response to detecting the movement of the viewpoint of the user from the first viewpoint to the second viewpoint, displaying the first content item in the media user interface object from the second viewpoint of the user, wherein displaying the first content item in the media user interface object from the second viewpoint of the user includes displaying the second portion of the first content item in the media user interface object.

18. An electronic device, comprising:
one or more processors;
memory; and
one or more programs, wherein the one or more programs are stored in the memory and configured to be executed by the one or more processors, the one or more programs including instructions for:
displaying, via a display generation component, a three-dimensional environment, including:
concurrently displaying a media user interface object that includes respective content of a first content item being presented in a first presentation mode and a first user interface element for transitioning presentation of the first content item to a second presentation mode, wherein during presentation of the first content item in the first presentation mode, the first content item is displayed in a frame that occupies a first portion of a field of view from a viewpoint of a user of the electronic device while a second portion of the field of view from the viewpoint of the user is occupied by other elements of the three-dimensional environment that represents a physical environment surrounding the electronic device; and
while displaying the three-dimensional environment that includes the media user interface and the first user interface element, receiving, via one or more input devices, a first input that corresponds to selection of the first user interface element; and
in response to receiving the first input, displaying, in the three-dimensional environment, the first content item in the second presentation mode, wherein during presentation of the first content item in the second presentation mode, the respective content of the first content item is concurrently displayed while replacing at least a portion of the other elements of the three-dimensional environment that represents the physical environment surrounding the electronic device with virtual three-dimensional content that extends to at least one edge of the field of view from the viewpoint of the user of the electronic device.

19. A non-transitory computer readable storage medium storing one or more programs, the one or more programs comprising instructions, which when executed by one or more processors of an electronic device, cause the electronic device to perform a method comprising:
displaying, via a display generation component, a three-dimensional environment, including:
concurrently displaying a media user interface object that includes respective content of a first content item being presented in a first presentation mode and a first user interface element for transitioning presentation of the first content item to a second presentation mode, wherein during presentation of the first content item in the first presentation mode, the first content item is displayed in a frame that occupies a first portion of a field of view from a viewpoint of a user of the electronic device while a second portion of the field of view from the viewpoint of the user is occupied by other elements of the three-dimensional environment that represents a physical environment surrounding the electronic device; and
while displaying the three-dimensional environment that includes the media user interface and the first user interface element, receiving, via one or more input devices, a first input that corresponds to selection of the first user interface element; and
in response to receiving the first input, displaying, in the three-dimensional environment, the first content item in the second presentation mode, wherein during presentation of the first content item in the second presentation mode, the respective content of the first content item is concurrently displayed while replacing at least a portion of the other elements of the three-dimensional environment that represents the physical environment surrounding the electronic device with virtual three-dimensional content that extends to at least one edge of the field of view from the viewpoint of the user of the electronic device.
